(19) United States
(12) Patent Application Publication
(10) Pub. No.: US 2026/0105397 A1
(43) Pub. Date: Apr. 16, 2026

(54) Artificial Intelligence-Based System for Dynamic Fire Risk Management From Heterogeneous Multimodal Inputs

(71) Applicant: Opal NexAl Inc., Marina Del Rey, CA (US)

(72) Inventors: Ryan Shahrouz Alimo, Los Angeles, CA (US); Niloufar Abolfathian, Los Angeles, CA (US); Alison Ayumi Olmstead, Los Angeles, CA (US); Aniruddha Sanjay Kalkar, Los Angeles, CA (US); Nitish Borthakur, Los Angeles, CA (US); Ertugrul Taciroglu, Los Angeles, CA (US); Pooriya Beyhaghi, San Diego, CA (US); Riyaaz Uddien Shaik, Los Angeles, CA (US)

(21) Appl. No.: 19/358,330

(22) Filed: Oct. 14, 2025

Related U.S. Application Data
(60) Provisional application No. 63/707,008, filed on Oct. 14, 2024.
(60) Provisional application No. 63/811,213, filed on May 23, 2025.

(51) Int. Cl. G06Q 10/0635; G01W 1/00; G06T 7/00

(52) U.S. Cl. CPC G06Q 10/0635; G01W 1/00; G06T 7/0002; G06T 2207/10032

(57) ABSTRACT

An artificial intelligence (AI) based system for dynamic fire risk management is provided. Multimodal input data associated with a geographic region is received, the multimodal input data including at least one of fuel map data, meteorological data, topographical data, and historical fire data. An AI component determines a fire potential index associated with the geographic region based on the multimodal input data. Output data indicative of the fire potential index is then provided for display via a graphical user interface rendered by a computing device.

### CROSS-REFERENCE TO RELATED APPLICATION(S)

This application is a continuation of U.S. Provisional Application Ser. No. 63/707,008, filed Oct. 14, 2024, and U.S. Provisional Application Ser. No. 63/811,213, filed May 23, 2025, the entire disclosure of each of which is hereby incorporated by reference herein.

### FIELD

This disclosure generally relates to fire risk prediction and mitigation and, more specifically, to an artificial intelligence (AI) system for dynamic fire risk management from heterogeneous multimodal inputs.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an operating environment associated with artificial intelligence (AI) for dynamic fire risk management from heterogeneous multimodal inputs.

FIG. 2 is a block diagram of an example internal configuration of a computing device.

FIG. 3 is a block diagram of an example of an AI system for dynamic fire risk management from heterogeneous multimodal inputs.

FIG. 4 is a block diagram of another example of an AI system for dynamic fire risk management from heterogeneous multimodal inputs.

FIG. 5 is a block diagram of another example of an AI system for dynamic fire risk management from heterogeneous multimodal inputs.

FIG. 6 is a block diagram of another example of an AI system for dynamic fire risk management from heterogeneous multimodal inputs.

FIG. 7 is a data flow diagram of an example of a data layer of an AI system for dynamic fire risk management from heterogeneous multimodal inputs.

FIG. 8 is a data flow diagram of an example associated with generating fuel maps in an AI system for dynamic fire risk management from heterogeneous multimodal inputs.

FIG. 9 is a schematic diagram of an example associated with generating a fire prediction index.

FIG. 10 is a block diagram of an example of an AI chat agent-based system for dynamic fire risk management from heterogeneous multimodal inputs.

FIG. 11A is an example of a graphical user interface (GUI) provided by an AI system for dynamic fire risk management from heterogeneous multimodal inputs.

FIG. 11B and FIG. 11C are examples of a GUI configured to present a dynamic fire prediction index forecast.

FIG. 11D is an example of a GUI configured to present wind characteristic information for dynamic fire risk prediction and mitigation.

FIG. 11E is an example of a GUI configured to present vegetation characteristic information for dynamic fire risk prediction and mitigation.

FIG. 11F and FIG. 11G are examples of a GUI configured to facilitate selection of a region and presentation of a report associated with the selected region.

FIG. 11H is an example of a GUI configured to present a fire simulation visualization.

FIG. 12 is a flowchart of an example of a technique for dynamic fire risk management based on heterogeneous multimodal inputs.

FIG. 13 is a flowchart of another example of a technique for dynamic fire risk management based on heterogeneous multimodal inputs.

FIG. 14 is a flowchart of another example of a technique for dynamic fire risk management based on heterogeneous multimodal inputs.

FIG. 15 is a flowchart of another example of a technique for dynamic fire risk management based on heterogeneous multimodal inputs.

### DETAILED DESCRIPTION

Wildfires present challenges to communities and economies, particularly in wildland-urban interface (WUI) regions. Factors influencing fire behavior may include fuel, meteorological conditions, and topography. Some operational systems for wildfire planning and response may face technical limitations. For instance, some datasets may have a resolution that is not effective in some WUI contexts. Vegetation mapping may be updated infrequently or at resolutions that do not capture some fine-scale features related to fire propagation, such as ornamental plantings or infrastructure corridors.

These technological limitations may present challenges for predicting fire risk with high accuracy. Some computer models may treat built structures as non-combustible obstacles, and may not account for factors such as roofing materials, defensible space, or the vulnerability of nearby infrastructure, all of which may influence ignition and fire spread. Furthermore, integrating diverse streams of available data-such as remote sensing, satellite imagery, aerial sensor data, real-time weather feeds, mobile mapping, and historical records-into a cohesive and actionable framework may remain a technical hurdle for some systems. This data heterogeneity, with its varying formats, resolutions, and update frequencies, may complicate efforts to generate timely and precise fire risk assessments.

The challenge may be compounded by the difficulty in translating raw data and predictive outputs into actionable strategies for a variety of stakeholders, including fire agencies, utility companies, and emergency services. Thus, stakeholders may have incomplete or outdated information, which may hinder their ability to plan mitigation efforts, allocate resources efficiently before and during an active event, or implement preventative measures in a cost-effective manner.

Implementations of this disclosure address problems such as these by providing a comprehensive and customized, artificial intelligence (AI)-based system for dynamic fire risk management. The disclosed subject matter integrates heterogeneous multimodal inputs to deliver high-resolution, actionable insights for stakeholders. The system may receive multimodal input data associated with a geographic region, where the multimodal input data includes at least one of fuel map data, meteorological data, topographical data, and historical fire data. An AI component may then be used to determine a fire potential index associated with the geographic region based on the received data. Finally, output data indicative of the fire potential index may be provided for display via a graphical user interface rendered by a computing device.

To process the varied inputs, the system may employ a data integration pipeline. As used herein, the term “data integration pipeline” may refer to a sequence of computer-implemented operations configured to harmonize and integrate data from different sources. For example, the data integration pipeline may perform temporal interpolation for satellite imagery to account for irregular refresh rates. The data integration pipeline may perform spatiotemporal resolution adjustments for weather data to align its granularity with other inputs. In some implementations, the data fusion pipeline may ingest multimodal input data. The term “multimodal input data” may refer to heterogeneous data associated with a geographic area, comprising various formats and sources. The multimodal input data may be heterogeneous with respect to, for example, data sources, data schema, data formats, data types, data frequency ranges, or data sampling frequencies, among other examples. The multimodal input data may include, for example, geographical data, vegetation data, terrain data, population data, meteorological data, fire statistics data, structural data, or property data, among other examples.

In some implementations, the input data may include Earth observation data such as imagery from Landsat 8, Sentinel-1, Phased Array type L-band Synthetic Aperture Radar (PALSAR), National Aeronautics and Space Administration (NASA)-Indian Space Research Organisation (ISRO) Synthetic Aperture Radar (NISAR) satellites, FireSat and GEDI satellites; meteorological data from sources like the High-Resolution Rapid Refresh (HRRR) model; topographical data from the Shuttle Radar Topography Mission (SRTM); or historical fire records. In some implementations, the multimodal input data may include aerial imagery, Light Detection and Ranging (LiDAR) data, and ground-level data from mobile mapping operations, which may facilitate fuel and infrastructure mapping at a sub-5-meter resolution.

The system may generate fuel map data by pre-processing the remote sensing inputs through a data integration pipeline. As used herein, the term “pre-processing” may refer to a set of initial operations performed on raw data to prepare it for further processing. As used herein, “fuel map data” may refer to a data structure that characterizes the combustible materials within a geographic area. For instance, fuel map data may be data associated with a fuel map and may identify a plurality of vegetation types and their corresponding fuel loads and other fuel characteristics. The generation process may involve any number of processing operations, such as cloud removal from satellite imagery, computation of seasonal Normalized Difference Vegetation Index (NDVI) metrics and various Synthetic Aperture Radar (SAR)-based metrics. In some implementations, pre-processing input data may include extraction of elevation and slope data from any number of different types of imagery such as, for example, SRTM imagery or other spaceborne and airborne imagery. A training dataset may be created from this pre-processed data. In some implementations, the training data may be augmented through synthetic data generation and pseudo-labeling techniques to create an augmented training dataset. One or more machine-learning models, such as a Gluon model, may be trained on the augmented training dataset to produce fuel map data.

In some implementations, particularly those focused on WUI areas, the generation of fuel map data may involve a detailed urban fuel segmentation process. As used herein, “urban fuel segmentation” may refer to the use of computer vision and machine-learning models to identify and classify a variety of combustible and non-combustible features within a developed or semi-developed environment. This process goes beyond traditional vegetation mapping to create a comprehensive urban fuel layer. The “urban fuel layer” may refer to a dataset that characterizes various elements that contribute to fire risk in a WUI, including, but not limited to, building structures and their materials (e.g., roofs, siding, windows), and parcel-adjacent fuels (e.g., ornamental landscaping), fences, vehicles, ornamental landscaping, utility poles, and sidewalks. This segmentation may be performed on multimodal imagery, including high-resolution satellite imagery (such as Planet, Maxar etc) aerial imagery and street-level data captured via mobile mapping systems equipped with LiDAR and cameras.

In some implementations, street-level data may be obtained from vehicle-mounted street-view systems and/or pedestrian or sidewalk robotic mapping platforms instrumented with cameras and/or LiDAR, enabling near-field capture of facade-level features (e.g., vents, decks, windows) that may be under-resolved in overhead imagery. Outputs from the urban fuel segmentation (e.g., per-structure material labels and exterior-feature masks) may be consumed by the WUI integration engine to compute vulnerability indices and defensible-space metrics and by the simulation engine for WUI-specific initialization and exposure analysis.

In some WUI-focused implementations, the system computes a roof-material layer as part of the urban fuel layer. The roof-material layer is generated by an AI-and remote sensing-based pipeline (e.g., inspired by a RoofSense-style algorithm) that ingests multispectral satellite imagery (e.g., Planet SuperDove 8-band optical) aligned to authoritative ground-truth records (e.g., verified CAL FIRE Damage Inspection (DINS) observations). Spectral features may include normalized-difference indices such as NDVI (Normalized Difference Vegetation Index), NDCCI (e.g., a clay/concrete discriminant), and NDMCI (e.g., a moisture-content discriminant), among others. A supervised classifier (e.g., gradient-boosted decision trees such as XGBoost) may be used to map the features to dominant roof-material categories, including asphalt, metal, tile, wood, and concrete. The trained model outputs a per-structure roof-material label and confidence score, which are persisted as a roof-type layer. The WUI integration engine 512 and/or the FPI engine (e.g., 508/426) consume the roof-type layer as a structural vulnerability modifier so that weather-driven ignition intensity and spread potential are modulated by a roof-resistance class. In some embodiments, the roof-type layer is treated as static or is periodically refreshed based on the cadence of new imagery and quality-assured ground-truth updates provided through the data integration pipeline and data store.

From the urban fuel segmentation, the system may further analyze the spatial relationships between different fuel types to determine more granular risk metrics. For example, the system may calculate the vegetation hazard within defensible space around a particular structure. “Vegetation hazard within defensible space” may refer to a quantified risk based on the density and proximity of vegetation to a structure. This may be calculated by determining the percentage of vegetation coverage within predefined concentric zones or buffers around a building, such as within 5 feet, 30 feet, and 100 feet of the structure. In some implementations, these analyses may be used to generate additional risk indices, such as a House-to-House Ignition Potential Index, which may model the likelihood of fire spreading between adjacent structures, and a Structure Vulnerability Index, which may provide an overall risk score for a single building based on its materials and surrounding fuel loads. These indices may also incorporate factors such as direct flame contacts, radiant heat ignition thresholds, and models for ember generation and transport.

The meteorological data used by the system may include but not limited to updated values for parameters such as precipitation, vapor pressure deficit, wind speed, wind direction, temperature, or relative humidity. This data may be automatically ingested and aligned from various real-time and forecast sources. For example, the system may utilize data from the HRRR model, which can provide hourly forecasts at a 3-kilometer grid resolution for a forecast horizon of up to 48 hours. Other sources may include ground-based station data from Gridmet or remote sensing measurements such as evapotranspiration and surface temperature measurements from NASA's ECOSTRESS mission, which can help in refining estimates of weather parameters and moisture content in vegetation and soil.

Parameters such as 10-hour (FM10HR) and 100-hour (FM100HR) time-lag fuel moisture and relative humidity may be incorporated, as these are measures of moisture content in dead fuels and the air, respectively. Low values for these parameters can indicate that vegetation is dry and more susceptible to ignition and rapid fire spread. The system may also be configured to account for regional wind patterns, such as the strong, dry of Santa Ana winds, which can significantly increase fire spread and intensity. To facilitate compatibility with other data layers, a data integration pipeline may perform spatiotemporal resolution adjustments to the meteorological data, aligning it with satellite imagery and other inputs.

The data integration pipeline may perform a data fusion process to harmonize and synthesize the varied multimodal inputs into a cohesive dataset ready for analysis. As used herein, “data fusion” may refer to the computer-implemented process of combining data from multiple sources to generate more consistent, accurate, and useful information than that provided by any individual data source. For example, the data fusion process may involve specific techniques such as temporal interpolation for satellite imagery, which addresses the irregular refresh rates of different satellites, and spatiotemporal resolution adjustments for weather data, which standardizes the granularity of meteorological inputs to align with remote sensing data. In some implementations, a multi-agent AI component, which may include a vision-language model (VLM), may be used to perform the fusion, facilitating a semantic understanding and integration of the diverse data types, including satellite, aerial, ground-level, and meteorological inputs. This process results in a fused multimodal dataset that serves as a foundational input for generating the fuel maps and a fire potential index.

Based on the fused multimodal data, the system may determine the fire potential index (FPI). As used herein, “fire potential index” may refer to a determined metric indicating the likelihood and potential severity of a fire event in a specific geographic area. For example, the FPI may be represented as a numerical score or a categorized risk level, such as Low, Moderate, High, or Extreme, which may be displayed on a color-coded map. The determination may involve generating hourly predictions for a forecast horizon of at least 48 hours. The system may calculate an uncertainty value associated with the FPI. As used herein, an “uncertainty value” may refer to a metric indicating the confidence level or potential variability of a prediction. In some implementations, this may be achieved by generating a plurality of FPI forecasts at successive time intervals, creating overlapping predictions for future time points. The system may analyze the variance across these overlapping predictions, using techniques like a moving standard deviation or bootstrapped interval analysis, to calculate a confidence range for the FPI. Markov Chain Monte Carlo models may also be used in this calculation.

In some implementations, the system may compute a weather-only FPI that quantifies atmospheric drivers of fire potential independent of ignition or fuel variability. To do so, the FPI engine may obtain meteorological datasets (e.g., historical archives and forecast products such as HRRR) and generate an ensemble of fire-weather scenarios, each scenario including a temporally coherent sequence of parameters including temperature, relative humidity, wind speed, wind direction, and precipitation over the forecast or analysis window. For each scenario, the engine may evaluate scenario-specific fire-weather indices and produce a per-scenario FPI score for each location and time step. The scores may be normalized and aggregated (e.g., per hour and/or per period) to provide a weather-only FPI surface. The ensemble design may leverage the uncertainty framework described herein by generating overlapping or stochastic scenario paths and using variance-based statistics (e.g., moving standard deviation, bootstrap-style intervals) to provide confidence information alongside the weather-only FPI. Because fuels and ignition terms may be intentionally excluded from this variant, the resulting index may isolate atmospheric hazard and may be visualized separately or combined with other layers elsewhere in the system for decision support. This weather-only workflow may be modular and may be orchestrated within a processing layer and an uncertainty component (e.g., FPI engine and uncertainty engine), using a periodic prediction cadence (e.g., at least 48 hours).

The output data provided by the system may be configured to cause a computing device to render various visualizations, such as an animated visualization displaying a temporal sequence of predictions across a forecast horizon. To enhance the reliability of these predictions, the system may also be configured to generate output data comprising an uncertainty value associated with the fire potential index and/or an alert if the uncertainty value is greater than a threshold value. In some implementations, uncertainty may be conveyed by calculating a confidence range based on the variance across multiple overlapping predictions for a future time point.

To provide further predictive capabilities, the system may execute a fire behavior simulation. A “fire behavior simulation” may refer to a computer-implemented model that predicts the propagation characteristics of a fire. For example, a fire behavior simulation may predict a fire's spread speed, direction, or propagation path. In some implementations, different simulation engines may be used depending on the environment; for example, a QUIC-Fire, WRF-Fire, FlamMap simulation engine or another wildland fire simulator may be used for wildland areas, while a State-of-the-art Wildland-Urban Interface Fire Tracing (SWUIFT) engine or another WUI fire simulator may be used for WUI areas. The SWUIFT engine, in particular, may simulate thermal radiation to quantify heat transfer effects on structures and may also model fire spotting by simulating the generation, transport, and ignition of firebrands originating from both vegetation and built structures.

The system may also generate a prioritized mitigation plan. As used herein, a “prioritized mitigation plan” may refer to a set of recommended actions designed to reduce wildfire risk in a cost-effective manner. For instance, the system may apply an optimization model, such as a mixed-integer linear programming model, to select a subset of mitigation actions (e.g., vegetation cutting) that maximizes the total expected risk reduction for a given area without exceeding a total budget constraint. This optimization may be based on evaluating a risk-spend efficiency metric for each potential action. The system may be orchestrated by a multi-agent framework using a Multi-Modal Large Language Model (MLLM). This multi-agent framework may include a plurality of specialized AI agents, such as a fuel map agent for updating fuel data, a fire potential index alert agent for generating alerts when risk exceeds a threshold, and a simulator coordination agent for managing fire simulations. Other specialized agents may include a mitigation planning agent, a prioritization agent, or a return-on-investment agent.

To facilitate user interaction, the graphical user interface may include a conversational AI component configured to receive natural language queries and generate responsive textual briefings. The output data may be presented as a color-coded risk map indicating different levels of the fire potential index. To foster trust and transparency, an explainable AI mechanism, such as a traceable inference pathway or a user-interpretable decision layer, may be provided to expose information about how the fire potential index was determined. In some implementations, the AI component may be a multi-agent framework orchestrated by a multi-modal large language model. This multi-agent framework may include a plurality of specialized AI agents, such as a fuel map agent, a fire potential index alert agent, an uncertainty agent, or a simulator coordination agent, among other examples. The simulator coordination agent may facilitate a fire behavior simulation by modeling thermal radiation and fire spotting, incorporating evaluations of structural vulnerability for built structures.

Other specialized AI agents may include a mitigation planning agent, a prioritization agent, or a return on investment agent configured to generate recommendations for fire mitigation plans. To personalize the user experience, an agent may learn user preferences from past interactions and proactively generate personalized alerts. For example, at least one specialized AI agent may learn user preferences based on an analysis of past user interactions and proactively generate personalized alerts that flag relevant information. The multi-agent framework may also utilize at least one knowledge graph, which may be fine-tuned by updating a short-term memory or a long-term memory of the multi-agent framework based on received user feedback from a human expert. For user interaction, the GUI may include a conversational AI component. The term “conversational AI component” may refer to an interactive interface that provides a mechanism by which a user may communicate with the system using natural language. For example, a user may submit a natural language query via a chat interface and receive a responsive textual briefing. In some implementations, the system's machine-learning component may be a VLM configured to generate a semantic interpretation of the geographic region from the multimodal input data.

To describe some implementations in greater detail, reference is first made to examples of hardware and software structures used to implement a system for dynamic fire risk management based on heterogeneous multimodal inputs.

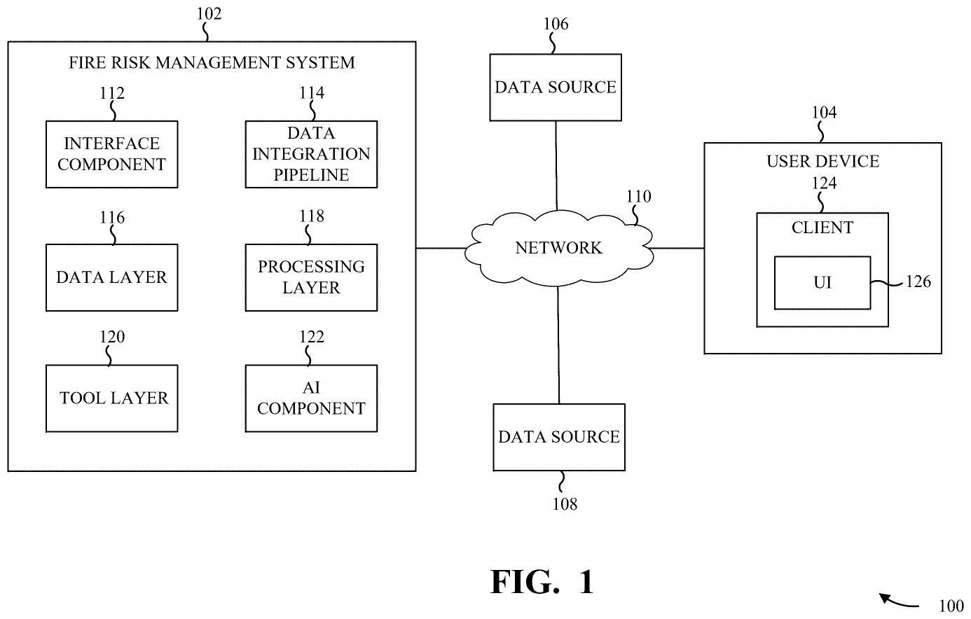

FIG. 1 is a block diagram of an example of an operating environment 100 associated with AI for dynamic fire risk management from heterogeneous multimodal inputs. The operating environment 100 includes a fire risk management system 102, a user device 104, a data source 106, a data source 108, and a network 110. The user device 104, the data source 106, and the data source 108 may be communicatively coupled to the fire risk management system 102 via the network 110.

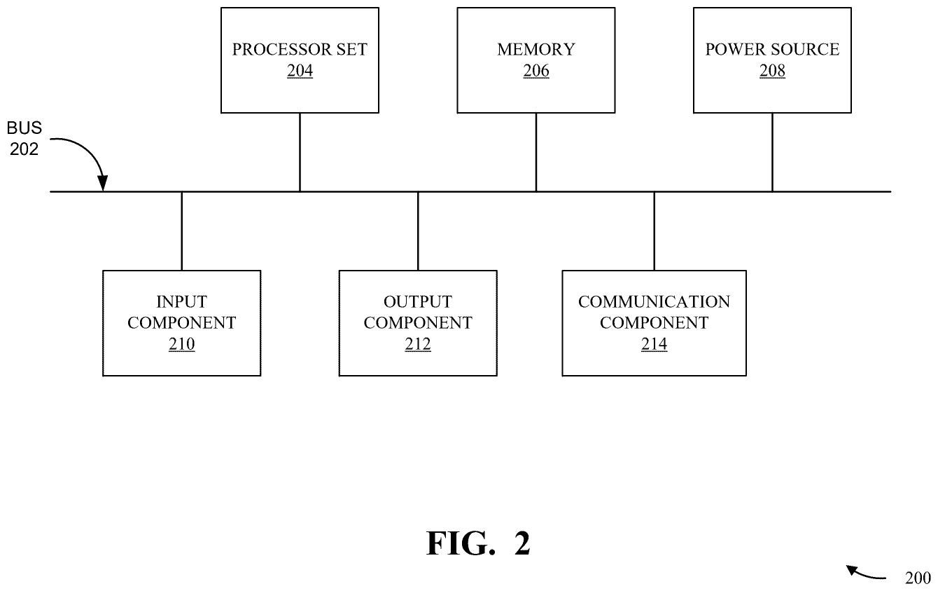

The fire risk management system 102 may be a computing system configured to receive multimodal input data, process the data using an AI component, and generate output data indicative of a fire potential index. The fire risk management system 102 may be implemented as a single server, a distributed system of servers, a cloud-based computing platform, or a combination of different computing architectures. In some implementations, the fire risk management system 102 may be configured to orchestrate a plurality of specialized AI agents to determine the fire potential index. For example, the fire risk management system 102 may use a multi-modal large language model to coordinate agents such as a fuel map agent, a fire potential index alert agent, and a simulator coordination agent. In some implementations, the fire risk management system 102 may be implemented using one or more computing devices such as, for example, the computing device 200 shown in FIG. 2.

In some implementations, the fire risk management system 102 also may be configured to output any number of various types of visualizations such as, for example, an animated heat map showing a temporal sequence of predictions across a forecast horizon, fuel maps, or risk indices, among others. The fire risk management system 102 may receive data from various sources, such as the data source 106 and the data source 108, via the network 110. This data may include, for example, satellite imagery, meteorological data, topographical data, and historical fire records. The fire risk management system 102 may process this heterogeneous data to generate actionable insights and visualizations for display on the user device 104. In some implementations, the fire risk management system 102 may be configured to generate a prioritized mitigation plan by applying an optimization model to select a subset of mitigation actions that maximizes risk reduction within a budget constraint.

The fire risk management system 102 may be configured to provide a web-based application with a natural language processing interface, providing a mechanism by which users may query and interact with AI-generated insights. The fire risk management system 102 may provide output data for display via a graphical user interface rendered by a computing device, such as the user device 104. For example, the fire risk management system 102 may generate a high-resolution map illustrating a regionally-adapted fire potential index, which may be displayed to a user.

The user device 104 may be any type of computing device configured to interact with the fire risk management system 102 via the network 110. For example, the user device 104 may be a desktop computer, a laptop computer, a tablet, a smartphone, or a specialized terminal used by emergency response personnel. In some implementations, the user device 104 may be, be similar to, include, or be included in the computing device 200 shown in FIG. 2. The user device 104 may be configured to render a graphical user interface to display information provided by the fire risk management system 102, such as fire potential index maps, alerts, and simulation results. In some implementations, the user device 104 may include a client application that facilitates communication with the fire risk management system 102 and manages the display of data.

The user device 104 may be configured to receive user input, such as natural language queries, and transmit these queries to the fire risk management system 102. For instance, a user may interact with a conversational AI component on the user device 104 to request a textual briefing about fire risk in a specific geographic region. The user device 104 may then receive and display the responsive briefing generated by the fire risk management system 102. The user device 104 may be configured to display various visualizations generated by the fire risk management system 102. These visualizations may include color-coded risk maps, animated sequences showing the temporal progression of a fire potential index, or interactive dashboards for scenario planning. In some implementations, the user device 104 may render an explainable AI mechanism, such as a traceable inference pathway or a user-interpretable decision layer, which exposes information about how a fire potential index was determined.

The data source 106 may be any source of data relevant to fire risk assessment that is accessible via the network 110. The data source 106 may represent a system that provides satellite-based Earth observation data, such as multispectral imagery from Landsat 8 or SAR data from Sentinel-1 or NISAR satellites. For example, the data source 106 may be a public data archive maintained by a government agency like NASA or the U.S. Geological Survey (USGS). In some implementations, the data source 106 may provide real-time or near-real-time data feeds. The data source 106 may be configured to provide data in various formats, resolutions, and update frequencies. For example, the data source 106 may stream high-resolution aerial imagery obtained from aircraft, satellite-based remote sensing data, or LiDAR data. In some implementations, the data source 106 may provide ground-level data from mobile mapping operations, infrastructure data from utility companies, or property data from real estate databases. The data source 106 may represent a public or private entity that curates and disseminates specialized datasets, such as vegetation inventories, soil moisture measurements, or socio-economic data relevant to community vulnerability.

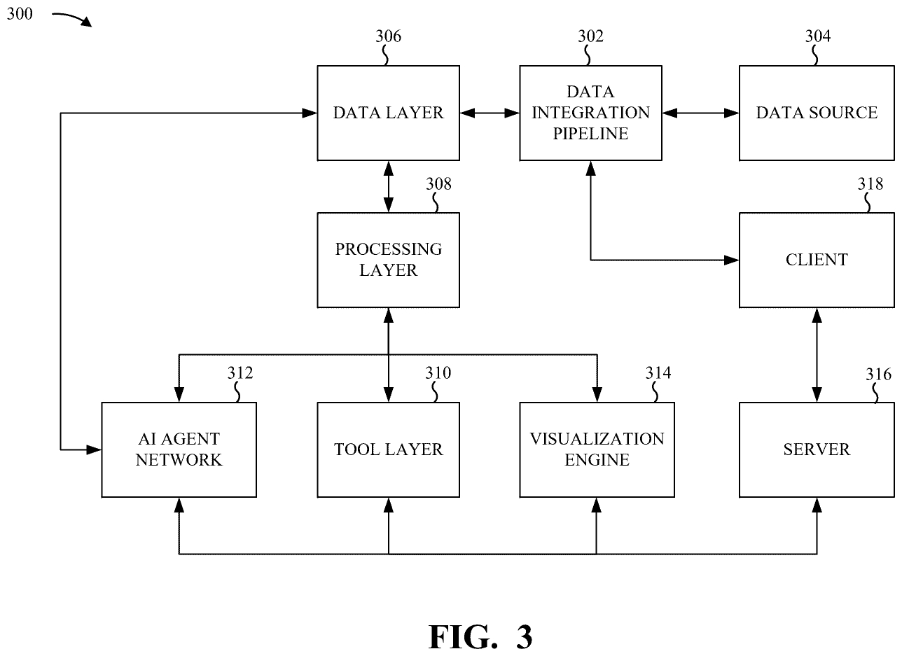

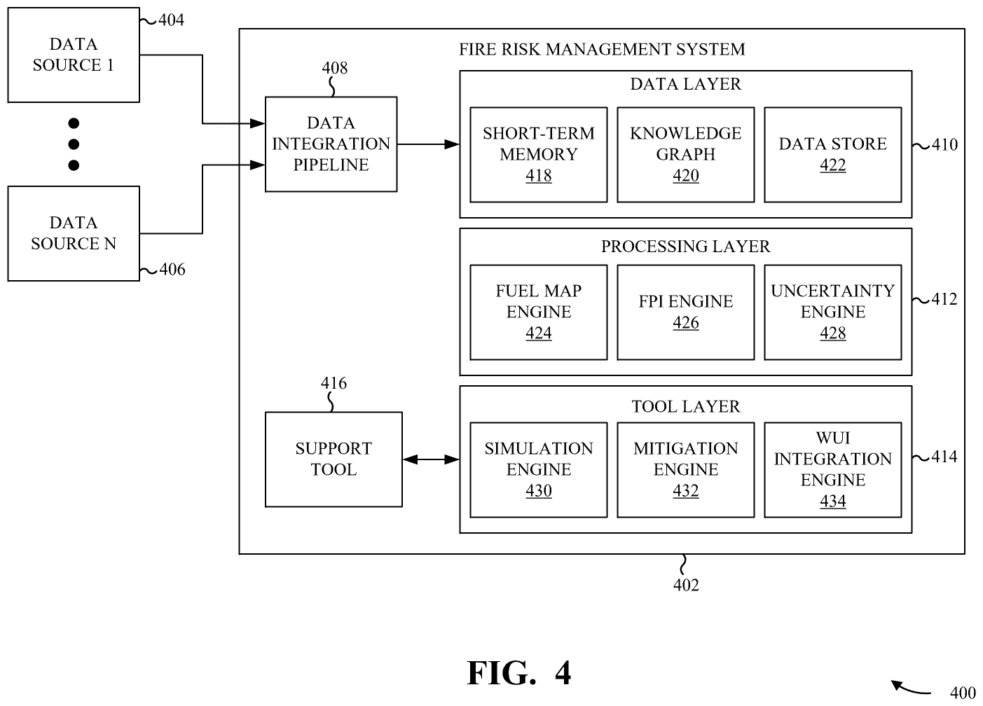

The fire risk management system 102 may be configured to ingest this heterogeneous data and process it through a data integration pipeline to harmonize it for analysis. In some implementations, the data source 106 may be, be similar to, include, or be included in the data source 304 shown in FIG. 3 or the data source 404 shown in FIG. 4. The data source 106 may provide data that is used by the fire risk management system 102 to generate fuel maps. For instance, the fire risk management system 102 may process remote sensing data from the data source 106 to create a fuel characterization map that identifies a plurality of fuel types and their corresponding fuel loads. In some implementations, the data provided by the data source 106 may be combined with data from other sources, such as the data source 108, to create a fused multimodal dataset.

The data source 108 may be another source of data accessible via the network 110. The data source 108 may be distinct from the data source 106 in the type of data it provides or its provider. For example, the data source 108 may be a meteorological data provider that offers real-time weather feeds and forecast models, such as the HRRR model. In this capacity, the data source 108 may provide updated values for parameters such as wind speed, wind direction, temperature, and relative humidity. The data source 108 may provide historical data, such as records of past fire events, including ignition points, burn perimeters, and spread characteristics. This historical fire data may be used by the AI component of the fire risk management system 102 to train machine-learning models or to fine-tune regional risk predictions. In some implementations, the data source 108 may provide topographical data, such as a digital elevation model from the SRTM.

In some implementations, the data source 108 may provide historical reanalysis records and/or synthetic meteorological sequences generated from those records and forecast models to support extended-horizon scenario analysis. In some implementations, the synthetic sequences preserve spatial and temporal dependencies among temperature, humidity, wind, and precipitation to facilitate realistic fire-weather evolution over week-to-season windows. The resulting sequences may be ingested via the data integration pipeline and supplied to the FPI engine for extended-horizon computations and uncertainty estimation.

The fire risk management system 102 may receive data from both the data source 106 and the data source 108 to perform its functions. For example, the fire risk management system 102 may combine satellite imagery from the data source 106 with weather forecasts from the data source 108 to determine a fire potential index for a geographic region. In some implementations, the data source 108 may be, be similar to, include, or be included in the data source 304 shown in FIG. 3 or the data source 406 shown in FIG. 4.

The network 110 may be any suitable network or combination of networks that facilitates communication between the components of the operating environment 100. The network 110 may include, for example, a local area network (LAN), a wide area network (WAN), the Internet, a cellular network, a satellite network, or any combination thereof. The network 110 may support various communication protocols to enable data exchange between the fire risk management system 102, the user device 104, the data source 106, and the data source 108.

The network 110 may facilitate the transmission of large volumes of data, such as high-resolution satellite imagery or streaming sensor data, from the data source 106 and the data source 108 to the fire risk management system 102. The network 110 may support secure communication channels to protect sensitive data. For example, the network 110 may use encryption protocols to secure communications between the user device 104 and the fire risk management system 102.

The network 110 facilitates the delivery of output data from the fire risk management system 102 to the user device 104. This may include transmitting data for rendering maps, visualizations, and alerts. In some implementations, the performance and reliability of the network 110 may be factors in the overall responsiveness of the fire risk management system 102, particularly for providing real-time alerts and decision support.

As shown in FIG. 1, the fire risk management system 102 includes an interface component 112, a data integration pipeline 114, a data layer 116, a processing layer 118, a tool layer 120, and an AI component 122. In some implementations, two or more of the interface component 112, the data integration pipeline 114, the data layer 116, the processing layer 118, the tool layer 120, and the AI component 122 may be integrated into a single component. In some implementations, one or more of the interface component 112, the data integration pipeline 114, the data layer 116, the processing layer 118, the tool layer 120, and the AI component 122 may be implemented using any number of computing devices such as the computing device 200 shown in FIG. 2. For example, one or more of the interface component 112, the data integration pipeline 114, the data layer 116, the processing layer 118, the tool layer 120, and the AI component 122 may be distributed among a number of computing devices, such as servers in a data center or nodes in a cloud computing environment.

The interface component 112 may be configured to manage communications between the fire risk management system 102 and external systems, such as the user device 104, via the network 110. The interface component 112 may include application programming interfaces (APIs), web servers, or other software components that handle incoming requests and outgoing data transmissions. For example, the interface component 112 may receive a natural language query from the client 124 on the user device 104 and forward it to the AI component 122 for processing.

The interface component 112 may be configured to format output data for delivery to the user device 104. For instance, the interface component 112 may package fire potential index data into a format suitable for rendering as a color-coded map on the UI 126. In some implementations, the interface component 112 may manage user authentication and access control, providing that only authorized users can access the features and data of the fire risk management system 102.

The interface component 112 may facilitate a web-based application, providing a user interface (UI) 126 as an interactive front-end for users. In some implementations, the interface component 112 may expose a set of RESTful application programming interfaces (APIs) or web APIs that provide a mechanism by which the client 124 may request data, submit queries, and receive updates. For example, when a user interacts with a map on the UI 126, the client 124 may send an API request to the interface component 112 to fetch the corresponding fire potential index data for the new map view. The interface component 112 then retrieves this data from the processing layer 118 or data layer 116 and transmits it back to the client 124 in a standardized format, such as GeoJSON, for rendering.

In some implementations, the interface component 112 may include a conversational AI component configured to manage natural language interactions. When a user submits a natural language query via the UI 126, the interface component 112 may receive the query and route it to the AI component 122. The interface component 112 may then receive a generated textual briefing from the AI component 122 and transmit it to the client 124 for display. This process may involve WebSocket connections to maintain a persistent, real-time communication channel between the client 124 and the fire risk management system 102, facilitating a responsive chat experience.

The interface component 112 may be configured to generate and transmit alerts. For example, if the AI component 122 determines that a fire potential index exceeds a predetermined threshold, a fire potential index alert agent may send an alert notification to the interface component 112. The interface component 112 may then push this alert to authorized user devices, such as the user device 104, using a push notification service. The interface component 112 may be configured to handle different alert types, such as alerts for high uncertainty values or personalized alerts based on learned user preferences, providing a mechanism by which stakeholders may receive timely and relevant information.

The data integration pipeline 114 may be configured to ingest, process, and harmonize multimodal input data from the data source 106 and the data source 108. The data integration pipeline 114 may perform a sequence of computer-implemented operations to prepare heterogeneous data for analysis. For example, the data integration pipeline 114 may perform temporal interpolation for satellite imagery data to account for irregular refresh rates or spatiotemporal resolution adjustments for weather data to align its granularity with other inputs.

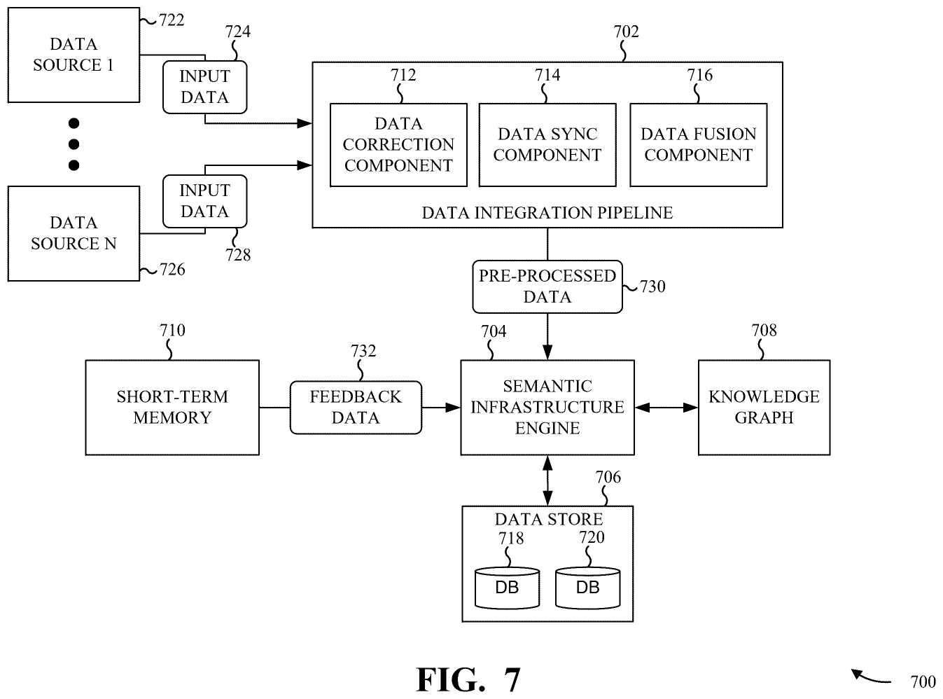

The data integration pipeline 114 may perform a data fusion process to combine data from multiple sources to generate more consistent, accurate, and useful information. In some implementations, the data integration pipeline 114 may be, be similar to, include, or be included in the data integration pipeline 302 shown in FIG. 3, the data integration pipeline 408 shown in FIG. 4, or the data integration pipeline 702 shown in FIG. 7. The data integration pipeline 114 provides a processed, fused multimodal dataset to the data layer 116 for storage and further use.

The data integration pipeline 114 may execute a series of orchestrated tasks to transform raw, heterogeneous data into a clean, unified format suitable for the AI component 122. For instance, upon ingesting satellite imagery, a data correction component within the data integration pipeline 114 may perform atmospheric and geometric corrections to remove distortions and artifacts. Following correction, a data synchronization component may align the temporal resolution of different datasets. For example, if multispectral imagery is updated daily and SAR imagery every 12 days, the data integration pipeline 114 may apply temporal interpolation techniques, such as linear or spline interpolation, to generate consistent, time-aligned data layers. This may provide a mechanism by which remote sensing inputs may represent a synchronized snapshot of the geographic region.

In addition to processing remote sensing data, the data integration pipeline 114 may handle the harmonization of meteorological inputs. Weather data, such as that from the HRRR model, may be provided on a grid with a different spatial resolution (e.g., 3-kilometer grid) than the satellite imagery (e.g., 30-meter resolution). To reconcile this, the data integration pipeline 114 may perform spatiotemporal resolution adjustments, using methods like bilinear or bicubic interpolation to downscale the weather parameters onto the higher-resolution grid of the fuel map and topographical data. This alignment may provide a mechanism by which weather variables such as wind speed and relative humidity are mapped to each fuel parcel, facilitating more accurate fire potential index calculations.

A stage of the data integration pipeline 114 may involve a data fusion process, where the corrected, synchronized, and resolution-adjusted datasets are combined into a single, fused multimodal dataset. In some implementations, this fusion may be facilitated by a VLM or another specialized AI agent within the AI component 122, which can generate a semantic interpretation of the combined data. The resulting dataset synthesizes information from all sources into a cohesive data structure. This fused multimodal dataset may be passed to the data layer 116, where it serves as the foundational input for the processing layer 118 to generate fuel maps and determine the fire potential index.

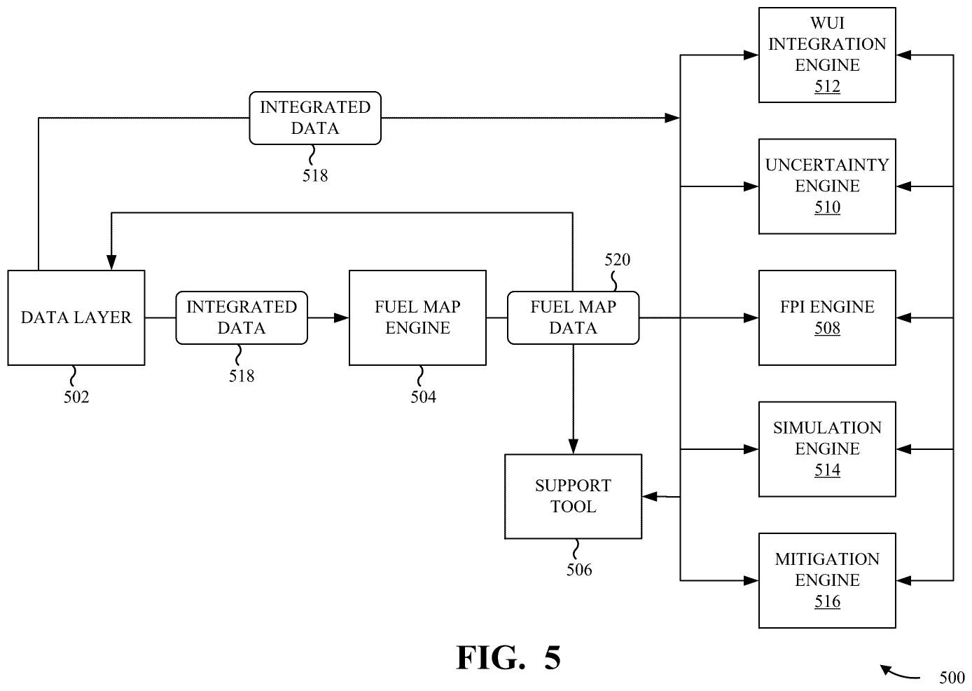

The data layer 116 may be configured to store and manage the data used by the fire risk management system 102. The data layer 116 may include various storage technologies, such as databases, data lakes, or file systems, to handle the volume and variety of the multimodal data. For example, the data layer 116 may store raw input data, processed data from the data integration pipeline 114, generated fuel maps, and historical fire potential index values. The data layer 116 may be, be similar to, include, or be included in the data layer 306 shown in FIG. 3, the data layer 410 shown in FIG. 4, or the data layer 502 shown in FIG. 5. In some implementations, the data layer 116 may include specialized data structures such as a knowledge graph or components for managing short-term and long-term memory for the AI component 122. The data layer 116 provides data as input to the processing layer 118 and the AI component 122.

The data layer 116 serves as the central repository and data management hub for the fire risk management system 102, architected to handle large volumes of heterogeneous, multimodal data. In some implementations, the data layer 116 may be built upon a scalable data lakehouse architecture, which combines the flexibility of a data lake for storing raw, unstructured data (e.g., satellite imagery, LiDAR point clouds) with the structured data management capabilities of a data warehouse for processed data (e.g., fuel maps, FPI time-series). This architecture may utilize distributed file systems like Apache Hadoop Distributed File System (HDFS) or cloud-based object storage services for raw data, and columnar databases or Parquet files for structured, query-optimized data.

A component of the data layer 116 may be a knowledge graph. As used herein, a “knowledge graph” may refer to a structured representation of knowledge where entities (e.g., fuel parcels, structures, infrastructure components) are represented as nodes and their relationships are represented as edges. For example, a knowledge graph may link a specific utility pole (an entity) to its geographic coordinates, material type, and proximity to different vegetation types (relationships). This structure facilitates complex queries and semantic reasoning, providing a mechanism by which the AI component 122 may infer relationships that may not be explicit in the raw data, such as identifying all structures within a high-risk FPI zone that are adjacent to a specific type of flammable vegetation.

In some implementations, the data layer 116 may include specialized memory components for the AI component 122, such as a short-term memory and a long-term memory. The short-term memory may be implemented as a high-speed in-memory database or cache, designed to store recent user interactions, query results, and feedback from human experts. This provides a mechanism by which the multi-agent framework of the AI component 122 may maintain context during a user session and quickly adapt its responses. The long-term memory, which may be integrated with the knowledge graph, stores historical data, learned patterns, and validated insights, facilitating persistent model fine-tuning and the gradual improvement of the system's predictive accuracy over time.

In some implementations, the data layer 116 may be configured to provide a semantic layer that abstracts the underlying physical data storage and exposes the data in a business-friendly, context-rich format. This semantic layer may map complex, raw data entities into well-defined business concepts, such as “fuel parcel,” “infrastructure asset,” or “risk zone,” which are more intuitive for the AI component 122 and human users. For example, by integrating the knowledge graph with the data stores, the semantic layer provides a mechanism by which queries may be framed in terms of these concepts, such as retrieving “all high-vulnerability structures within a 50-meter radius of a specific vegetation type,” without needing to specify the underlying database schemas or file locations. This abstraction facilitates more agile development and querying, as the processing layer 118 and tool layer 120 can interact with a consistent, conceptual view of the data, even if the underlying physical data sources change.

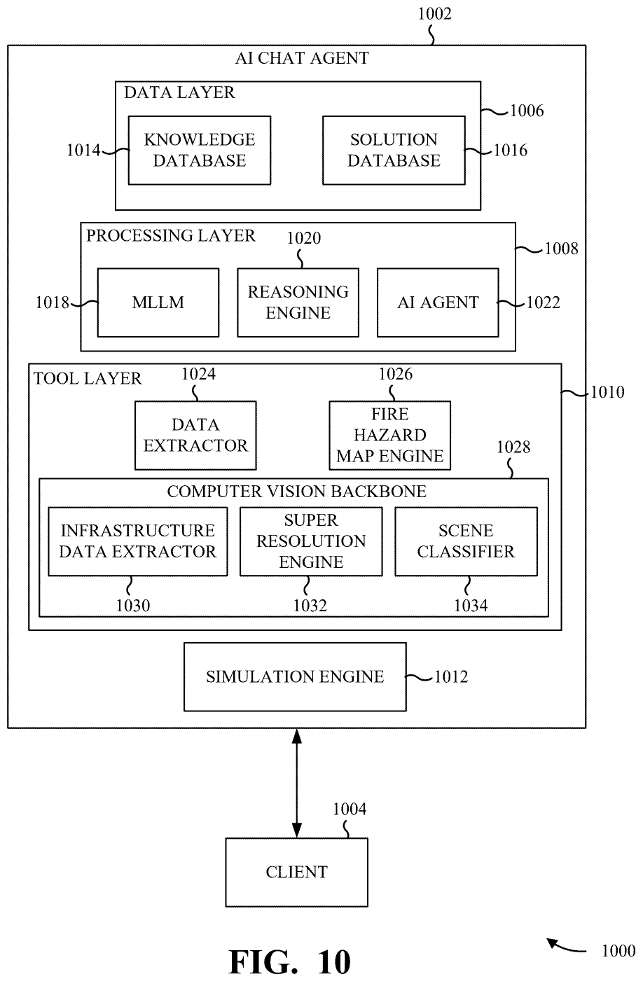

The processing layer 118 may be configured to perform analytical and computational tasks based on the data from the data layer 116. The processing layer 118 may include a plurality of engines or modules for specific functions. For example, the processing layer 118 may include an engine for generating fuel map data, an engine for determining the fire potential index, and an engine for calculating uncertainty values. The processing layer 118 may be, be similar to, include, or be included in the processing layer 308 shown in FIG. 3, the processing layer 412 shown in FIG. 4, or the processing layer 1008 shown in FIG. 10. The processing layer 118 may interact closely with the AI component 122, leveraging machine-learning models to perform its tasks. For example, an engine within the processing layer 118 may use a machine-learning model from the AI component 122 to process remote sensing data and generate a fuel characterization map.

The processing layer 118 may be configured to execute a suite of computational engines that transform the fused multimodal data from the data layer 116 into actionable wildfire intelligence. For instance, a fuel map engine within the processing layer 118 may leverage a machine-learning model, such as the Gluon model from the AI component 122, to generate high-resolution fuel characterization maps. This fuel map engine may process remote sensing inputs to identify a plurality of fuel types, such as vegetation classifications and their corresponding fuel loads, at a sub-5-meter resolution. The processing layer 118 may include an FPI engine configured to determine the fire potential index by synthesizing fuel map data with real-time meteorological data and topographical information. This determination may involve generating hourly predictions for a forecast horizon of at least 48 hours, providing stakeholders with a forward-looking view of potential fire risk.

A function of the processing layer 118 is the dynamic calculation and updating of the fire potential index. The FPI engine may be configured to perform this calculation by integrating multiple variables, including but not limited to, dead fuel extinction moisture, NDVI, wind speed, relative humidity, and terrain slope. In some implementations, the processing layer 118 may be configured to adapt the FPI determination for specific environments, such as WUI regions, by incorporating additional parameters like structural vulnerability and defensible space characteristics. An uncertainty engine within the processing layer 118 may be configured to calculate an uncertainty value associated with the fire potential index, for example, by analyzing the variance across a plurality of overlapping predictions generated at successive time intervals. This provides a confidence range for the FPI, enhancing the reliability of the predictions for decision-makers.

The outputs generated by the processing layer 118 serve as foundational inputs for the tool layer 120 and are formatted for visualization via the interface component 112. For example, the processing layer 118 may provide time-series FPI data that the interface component 112 can use to render an animated visualization displaying a temporal sequence of predictions. The processing layer 118 may provide detailed fuel map data and meteorological parameters to the tool layer 120 to initialize a fire behavior simulation. In some implementations, the processing layer 118 may interact with a multi-agent framework within the AI component 122, where specialized agents, such as a fuel map agent or a fire potential index alert agent, perform specific computational tasks. This modular architecture provides a mechanism by which the processing layer 118 may handle complex, concurrent analytical operations in a scalable and efficient manner.

Some implementations provide an AI-based regional and scalable fire risk framework in which the fire potential index (FPI), related risk models (e.g., WUI risk model), and mitigation plans are computed in a region-tailored manner that adapts to local environmental, climatic, geographic, and user-specific conditions. The modular layers (data, processing, and tool layers) may remain common across deployments, while the AI component may select and fine-tune models and parameters using regional data to generate regionally-adapted outputs. This design may facilitate straightforward scaling from a single region to national or global deployments without major architectural changes. In this way, regionalization may be achieved via configuration, data-connector selection, and model fine-tuning rather than code rewrites. For example, the multi-agent AI component may include one or more models fine-tuned with regional data, and the data layer may employ a scalable data lakehouse and knowledge-graph abstractions to support region-specific partitions and concepts (e.g., “fuel parcel,” “infrastructure asset,”“risk zone”).

The tool layer 120 may be configured to provide specialized tools and functionalities that build upon the outputs of the processing layer 118. The tool layer 120 may include, for example, a simulation engine for executing fire behavior simulations or a mitigation engine for generating prioritized mitigation plans. In some implementations, a simulator coordination agent may facilitate a fire behavior simulation by modeling thermal radiation and fire spotting. The tool layer 120 may be, be similar to, include, or be included in the tool layer 310 shown in FIG. 3, the tool layer 414 shown in FIG. 4, or the tool layer 1010 shown in FIG. 10. For example, the simulation engine within the tool layer 120 may use fuel map data and meteorological data from the processing layer 118 to predict the spread speed and direction of a fire. The outputs from the tool layer 120 may be provided to the interface component 112 for visualization on the user device 104.

The tool layer 120 serves as an operational hub, translating the analytical outputs from the processing layer 118 into decision-support functionalities for end-users. A component of the tool layer 120 is a simulation engine, which may be configured to execute a fire behavior simulation. For example, using the high-resolution fuel map data and time-series meteorological data from the processing layer 118, the simulation engine may predict the propagation path, spread speed, and direction of a potential fire. In some implementations, the tool layer 120 may include different simulation engines for different contexts, such as a QUIC-Fire engine for wildland areas and a SWUIFT engine for WUI areas. The SWUIFT engine, in particular, may model thermal radiation to quantify heat transfer effects on structures and may simulate fire spotting by modeling the generation, transport, and ignition of firebrands. The simulation outputs are then formatted for visualization, providing a mechanism by which stakeholders may view potential fire scenarios via the UI 126.

Another specialized component within the tool layer 120 is the mitigation engine, which is configured to generate a prioritized mitigation plan. This mitigation engine may receive risk data from the processing layer 118, including the fire potential index and vulnerability assessments, and combine it with a library of mitigation actions and their associated costs. For example, the mitigation engine may apply an optimization model, such as a mixed-integer linear programming model, to select a subset of actions (e.g., vegetation cutting, infrastructure hardening) that maximizes the total expected risk reduction without exceeding a user-defined budget constraint. The mitigation engine may calculate a risk-spend efficiency metric for each potential action to inform its recommendations. The resulting prioritized mitigation plan may be provided to the interface component 112 for display as a ranked list or an interactive map on the user device 104.

In some implementations, the functionalities of the tool layer 120 may be orchestrated by a multi-agent framework within the AI component 122. For example, a simulator coordination agent may be configured to manage the execution of the fire behavior simulation, initializing the simulation engine with the necessary data and managing the output. Similarly, a mitigation planning agent, a prioritization agent, or a return-on-investment agent may interact with the mitigation engine to generate and refine mitigation plans based on specific user queries or evolving risk conditions. This tight integration with the AI component 122 provides a mechanism by which the tool layer 120 may provide dynamic, context-aware decision support that adapts to both the data and the needs of the user.

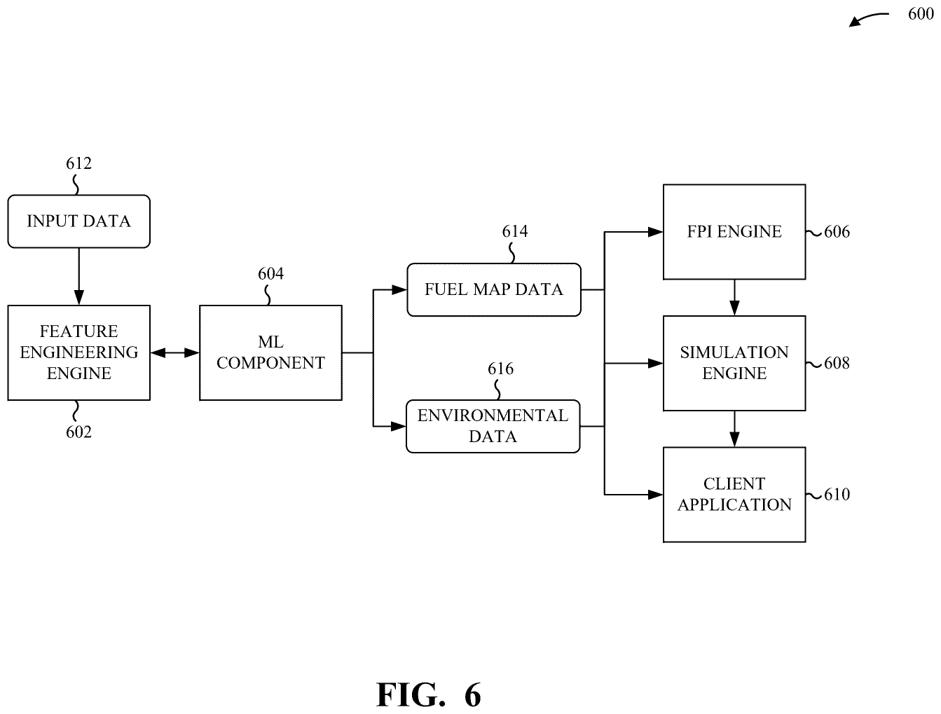

The AI component 122 may be configured to provide the machine-learning and artificial intelligence capabilities for the fire risk management system 102. The AI component 122 may include one or more machine-learning models, such as vision-language models (VLMs), neural networks, or ensemble models like Gluon. For example, the AI component 122 may be used to determine a fire potential index associated with a geographic region based on the multimodal input data. The AI component 122 may comprise a multi-agent framework orchestrated by a multi-modal large language model. In such implementations, the AI component 122 may include a plurality of specialized AI agents, such as a fuel map agent, a fire potential index alert agent, an uncertainty agent, or a simulator coordination agent. In some implementations, the AI component 122 may be, be similar to, include, or be included in the AI agent network 312 shown in FIG. 3, the ML component 604 shown in FIG. 6, or the AI chat agent 1002 shown in FIG. 10.

The AI component 122 serves as the core intelligence layer of the fire risk management system 102, housing the machine-learning models and orchestration logic that drive the system's predictive and analytical capabilities. In some implementations, the AI component 122 is architected as a multi-agent framework orchestrated by an MLLM. This multi-agent framework may include a plurality of specialized AI agents, each configured to perform a distinct function. For example, a fuel map agent may be configured to generate and continually update the fuel map data, a fire potential index alert agent may be configured to generate an alert when the determined fire potential index exceeds a predetermined threshold, and an uncertainty agent may be configured to calculate an uncertainty value associated with the fire potential index. A simulator coordination agent may be configured to facilitate a fire behavior simulation, managing the inputs and outputs for simulation engines in the tool layer 120.

Within this multi-agent framework, the AI component 122 may leverage a VLM to perform a semantic interpretation of the geographic region from the fused multimodal input data. The VLM may process a combination of satellite imagery, aerial photos, street-level imagery, and textual data (such as field reports or historical records) to generate a rich, contextual understanding of the environment. For example, the VLM may identify not only vegetation types but their proximity to structures, the materials of those structures, and the presence of defensible space, generating a detailed urban fuel layer. This semantic interpretation provides a mechanism by which the AI component 122 can reason about complex risk factors that are not explicit in any single data modality, thereby enhancing the accuracy of both the fuel maps and the fire potential index.

In some implementations, the AI component 122 is configured to learn and adapt based on user interactions and feedback. For example, at least one specialized AI agent may learn user preferences based on an analysis of past user interactions and proactively generate personalized alerts that flag information relevant to a user's specific area of responsibility or interest. The AI component 122 may utilize the short-term and long-term memory components within the data layer 116 to store these learnings. When a human expert provides feedback, for instance by validating or correcting a prediction via the UI 126, this feedback may be used to update the memory and fine-tune the knowledge graph, providing a mechanism by which the AI component 122 may improve its performance and predictive accuracy over time.

As shown in FIG. 1, the user device 104 includes a client 124. The client 124 may be a software application, such as a web browser or a dedicated desktop or mobile application, that runs on the user device 104. The client 124 is configured to communicate with the fire risk management system 102 and to render the graphical user interface for the user. For example, the client 124 may receive data from the interface component 112 and use it to display an interactive map showing fire risk levels.

The client 124 may be configured to handle user interactions, such as panning and zooming on a map, selecting data layers to display, or submitting queries to the fire risk management system 102. In some implementations, the client 124 may be, be similar to, include, or be included in the client 318 shown in FIG. 3 or the client 1004 shown in FIG. 10. For example, the client 124 may provide a chat interface for a user to interact with a conversational AI component of the fire risk management system 102.

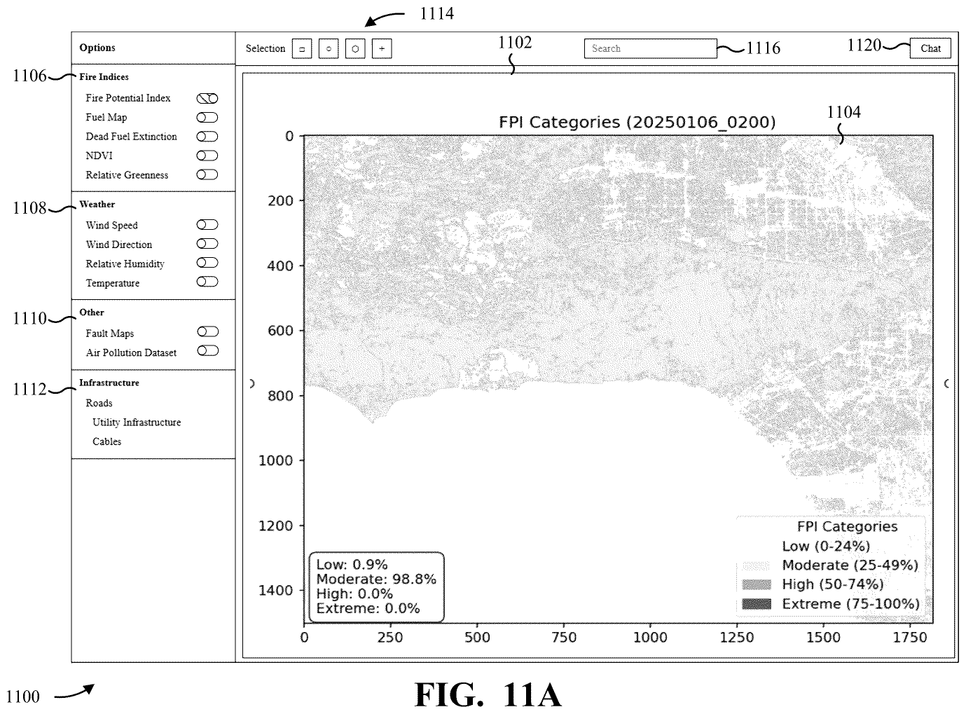

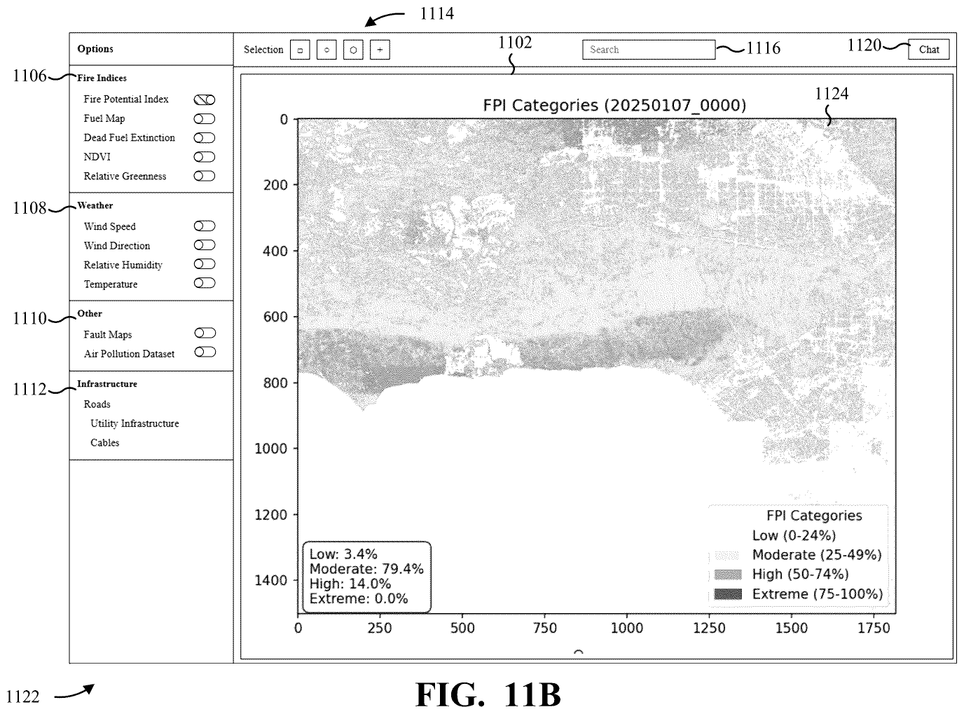

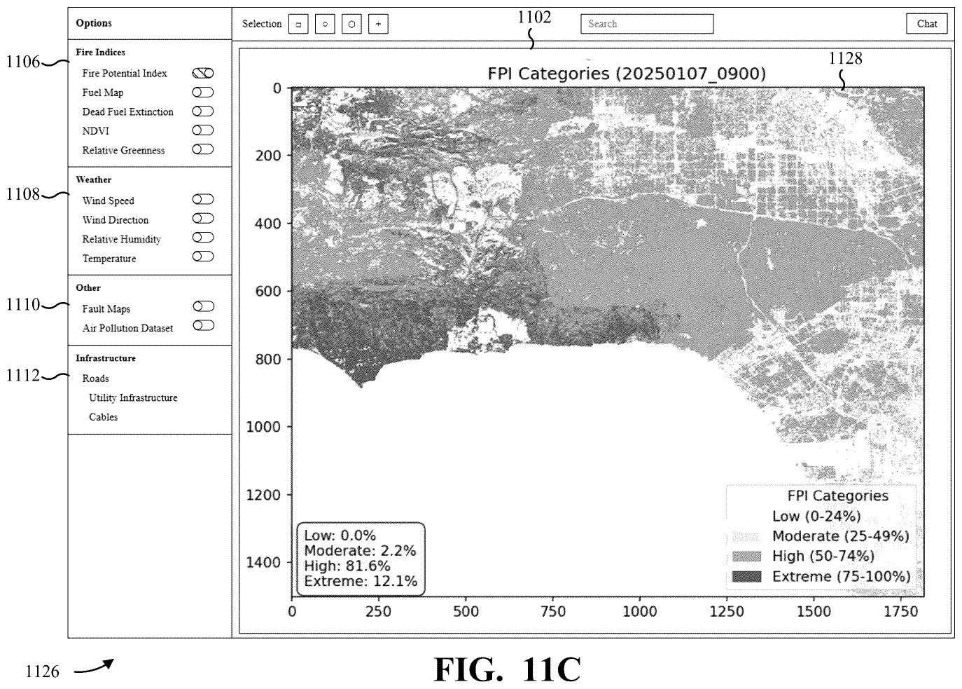

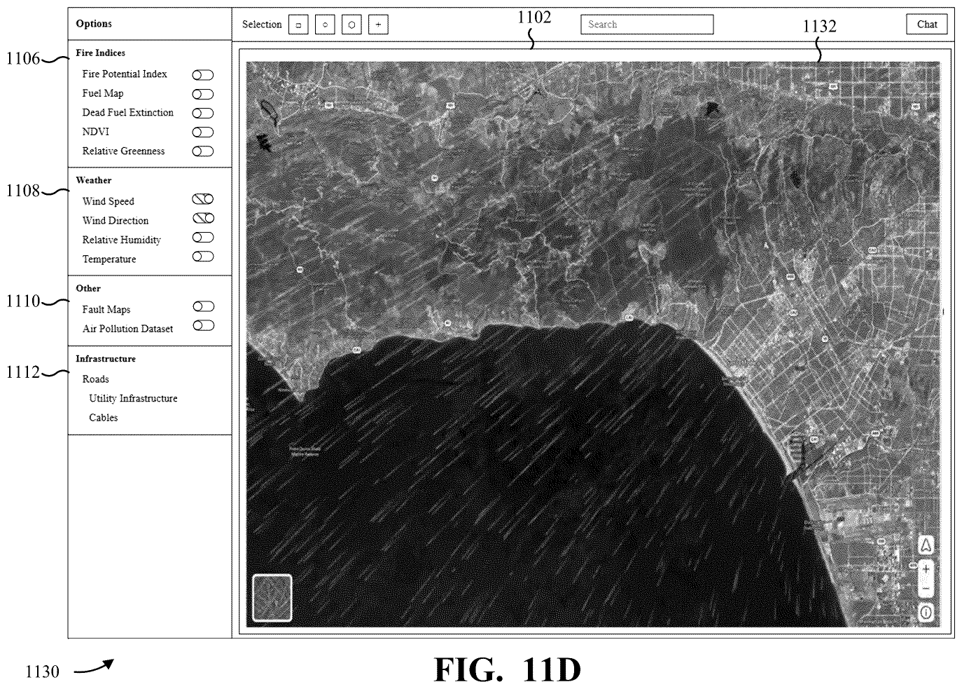

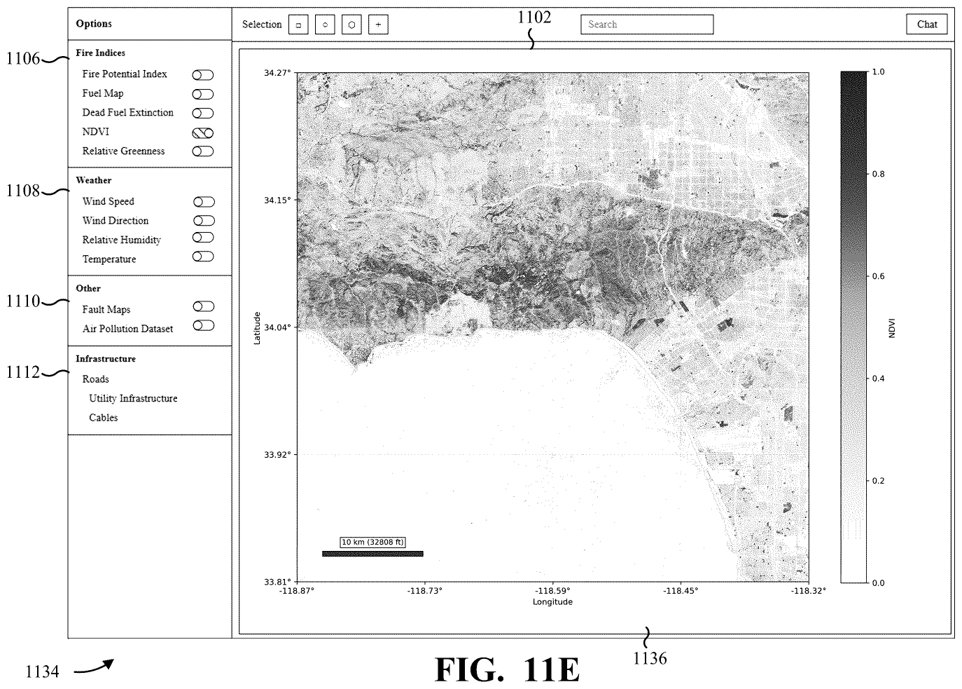

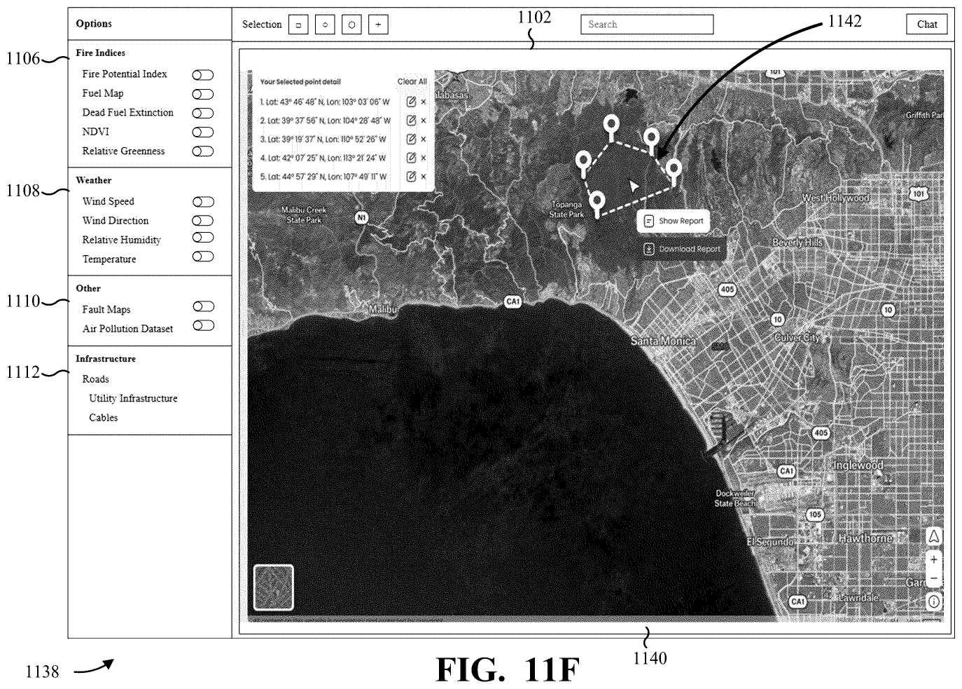

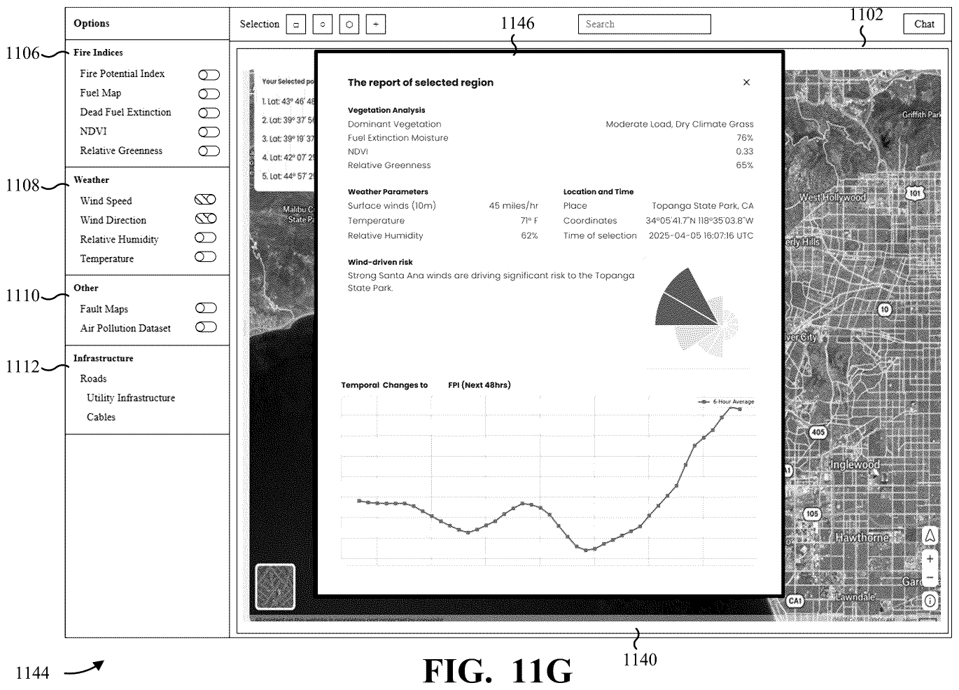

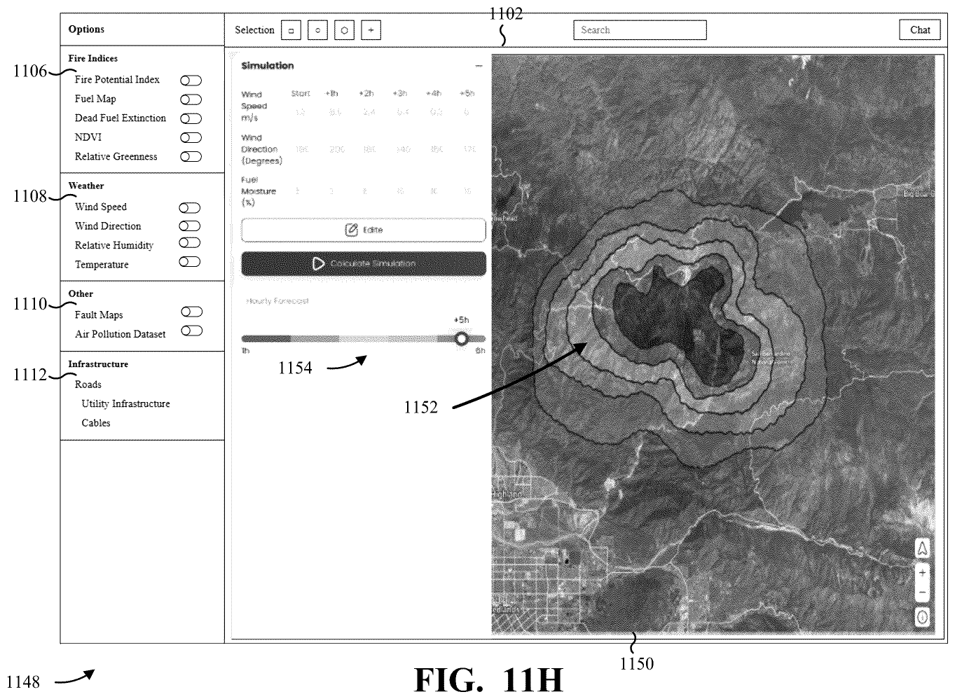

As shown in FIG. 1, the client 124 includes a UI 126. The UI 126, or graphical user interface, is the visual front-end presented to the user by the client 124. The UI 126 provides the interactive elements, such as maps, charts, buttons, and text fields, that provide a mechanism by which a user may view data and interact with the fire risk management system 102. Examples of the UI 126 are shown in FIG. 11A through FIG. 11H. For instance, the UI 126 may display a color-coded risk map indicating a plurality of different levels associated with the fire potential index.

FIG. 2 is a block diagram of an example internal configuration of a computing device 200 configured to perform functions described herein. The computing device 200 may be, be similar to, include, or be included in an apparatus for performing one or more methods, processes, algorithms, operations, tasks, and/or techniques, as described herein. The computing device 200 may be, be similar to, include, or be included in, the operating environment 100 shown in FIG. 1, among other examples. The computing device 200 includes a bus 202 that interconnects various components or units, such as a processor set 204, a memory 206, a power source 208, an input component 210, an output component 212, and a communication component 214, among other examples. One or more of the memory 206, the power source 208, the input component 210, the output component 212, or the communication component 214 can communicate with the processor set 204 via the bus 202.

The processor set 204 may be a central processing unit, such as a microprocessor, and may include single or multiple processors having single or multiple processing cores. The processor set 204 may include another type of device, or multiple devices, configured for manipulating or processing information. For example, the processor set 204 may include multiple processors interconnected in one or more manners, including hardwired or networked. The operations of the processor set 204 may be distributed across multiple devices or units that can be coupled directly or across a local area or other suitable type of network. The processor set 204 may include a cache, or cache memory, for local storage of operating data or instructions. The processor set 204 is implemented in hardware, firmware, or a combination of hardware and software. In some implementations, the processor set 204 includes one or more processors capable of being programmed to perform a function.

The processor set 204 may include one or more chiplets, chips, system-on-chips (SoCs), network-on-chips (NoCs), chipsets, packages, or devices that individually or collectively constitute or include the processor set. The processor set may include a processor (or “processing”) circuitry in the form of one or multiple processors, microprocessors, processing units (such as CPUs), GPUs, neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor set”).

One or more of the processors of the processor set 204 may be individually or collectively configurable or configured to perform various operations described herein. In some implementations, a single processor may perform all of the operations described as being performed by the one or more processors. In some implementations, a group of processors collectively configurable or configured to perform a set of operations may include a first set of (one or more) processors configurable or configured to perform a first operation of the set and a second processor configurable or configured to perform a second operation of the set, or may include the group of processors all being configured or configurable to perform the set of operations. The first set of processors and the second set of processors may be the same set of processors or may be different sets of processors.

The memory 206 includes one or more memory components, which may each be volatile memory or non-volatile memory, that individually or collectively constitute a memory system. The memory system may include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory,” “the memory system,” or “the memory circuitry”). The memory 206 may include non-transitory memory, transitory memory, or a combination thereof. Volatile memory may include RAM (e.g., a dynamic RAM (DRAM) module, such as a double data rate (DDR) synchronous DRAM (SDRAM)). Non-volatile memory may include a disk drive, a solid state drive, flash memory, or phase-change memory. In some implementations, the memory 206 may be distributed across multiple devices. For example, the memory 206 may include network-based memory or memory in multiple clients or servers performing the operations of those multiple devices. The memory 206 may be referred to as one or more computer-readable media. A computer-readable medium may include any storage unit (or multiple storage units) that store data or instructions that are readable by a processing system. A computer-readable medium may include, for example, at least one of a data repository, a data storage unit, a computer memory, a hard drive, a disk, or a random access memory.

One or more of the memories may be coupled (for example, operatively coupled, communicatively coupled, electronically coupled, or electrically coupled) with one or more of the processors of the processor set 204 and may individually or collectively store processor-executable instructions (e.g., code such as software) that, when executed by one or more of the processors, may configure or otherwise cause one or more of the processors to perform various functions or operations described herein. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise.

In some implementations, the executable instructions may include application data or an operating system, among other examples. The executable instructions may include one or more application programs, which may be loaded or copied, in whole or in part, from non-volatile memory to volatile memory to be executed by the processor set 204. For example, the executable instructions may include instructions for performing techniques described in this disclosure. In some implementations, the application data may include functional programs, such as computational programs, analytical programs, or database programs, among other examples. The operating system may be, for example, Microsoft Windows®, Mac OS X®, or Linux®; an operating system for a mobile device, such as a smartphone or tablet device; or an operating system for a non-mobile device, such as a mainframe computer.

Reference to “one or more memories” should be understood to refer to any one or more memories of a corresponding device, such as the memory described in connection with FIG. 2. For example, operation described as being performed by, or data described as being stored on, one or more memories can be performed by, or stored on, respectively, the same subset of the one or more memories or different subsets of the one or more memories. Additionally or alternatively, in some examples, one or more of the processors may be preconfigured to perform various functions or operations described herein without requiring configuration by software. For example, the memory 206 may include data or instructions that are hard-wired into the processing system.

In the description herein, language describing a system, an apparatus, or a device as taking an action (such as performing, determining, initiating, receiving, calculating, deciding, computing, processing, etc.) is to be understood as describing that some appropriate component of the system, apparatus, or device is taking the action. As used herein, the term “component” is intended to be broadly construed as hardware and/or a combination of hardware and software.

An “engine” refers to a component constructed, programmed, configured, or otherwise adapted to perform a specific function or set of functions. The term engine as used herein means a tangible device, component, or arrangement of components implemented using hardware, such as by an ASIC or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, interpreted, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines include a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out. As used herein, the term “model” encompasses its plain and ordinary meaning. A model may include, among other things, one or more engines which receive an input and compute an output based on the input.

The power source 208 provides power to the computing device 200. For example, the power source 208 may be an interface to an external power distribution system. In an example, the power source 208 may be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The input component 210 and/or the output component 212 may include one or more input interfaces and/or output interfaces configured for facilitating communication between the computing device 200 and one or more peripheral devices such as, for example, one or more sensors, detectors, displays, input devices, or other devices configured for facilitating interaction with the computing device 200 or the environment around the computing device 200. An input device may, for example, include a positional input device, such as a mouse, touchpad, touchscreen, or the like; a keyboard; or another suitable human or machine interface device. An output device may, for example, include a display, such as a liquid crystal display, a cathode-ray tube, a light emitting diode display, or other suitable display. In some implementations, the peripherals devices may include a geolocation component, such as a GPS location unit. In some examples, the peripheral devices may include a temperature sensor for measuring temperatures of components of the computing device 200, such as the processor set 204.

The communication component 214 may include an interface for facilitating a connection or link to a network. The communication component 214 may include a wired network interface or a wireless network interface. The computing device 200 may communicate with other devices via the communication component 214 using one or more network protocols, such as using Ethernet, TCP, IP, power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, a cellular communication protocol, another protocol, or a combination thereof. For example, the computing device 200 can communicate with a database server.

The communication component 214 may include a transceiver, which may include a transmitter or a receiver. In some configurations, one or a combination of antenna(s), modem(s), multiple input multiple output (MIMO) detectors, receive processors, transmit processors, and/or the transmit MIMO processors may be included in the transceiver. The transceiver may be under control of or used by one or more processors, and in some aspects in conjunction with processor-readable code stored in the memory, to perform aspects of the methods, processes, techniques, and/or operations described herein.

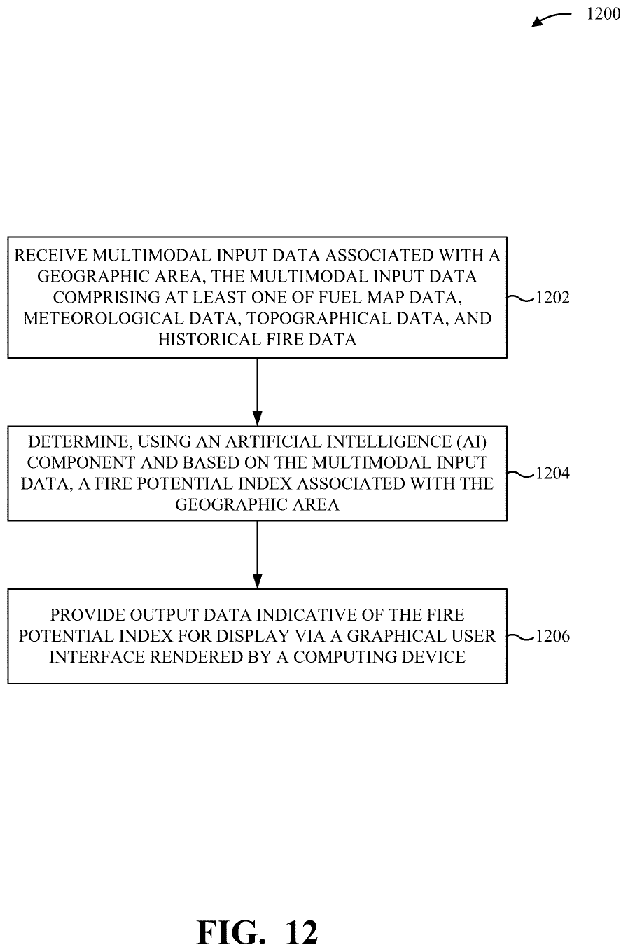

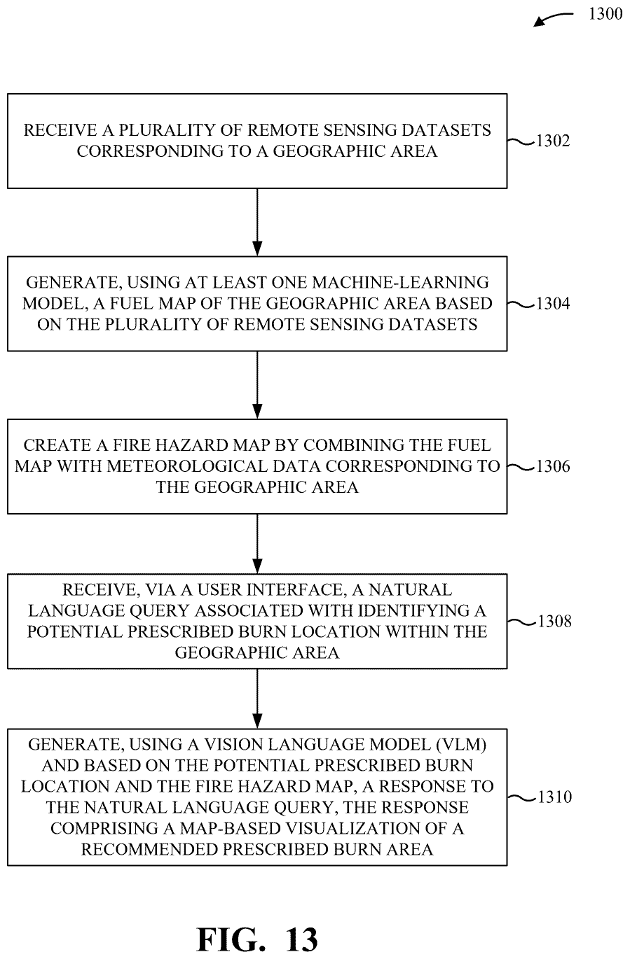

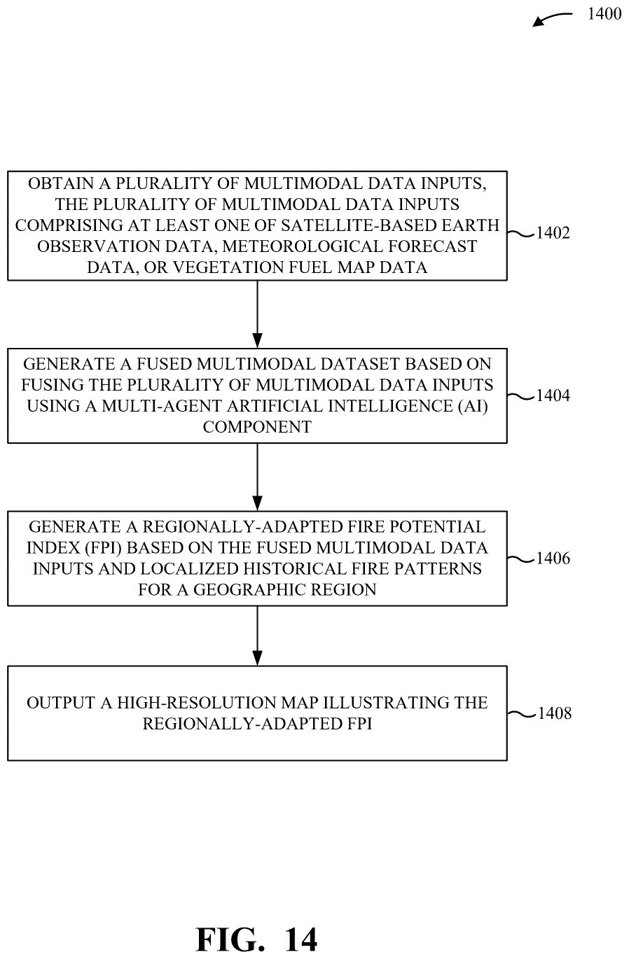

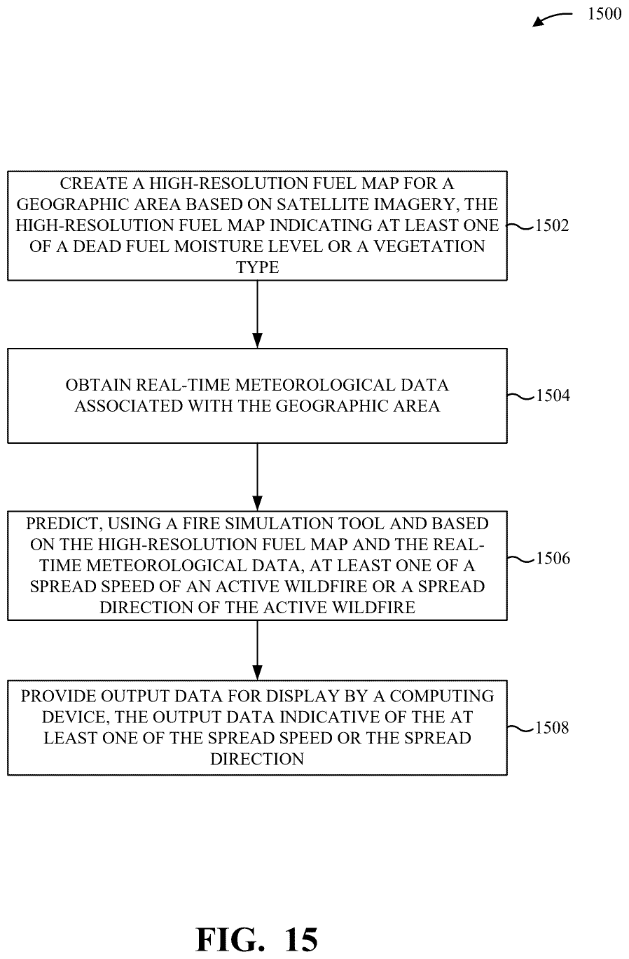

The processor set 204 may implement one or more techniques or perform one or more operations associated with dynamic fire risk management based on heterogeneous multimodal inputs, as described in more detail elsewhere herein. For example, the processor set 204 may perform or direct operations of, for example, technique 1200 of FIG. 12, technique 1300 of FIG. 13, technique 1400 of FIG. 14, technique 1500 of FIG. 15, or other techniques as described herein (alone or in conjunction with one or more other processors). The memory 206 may store data and program codes for the computing device 200. In some examples, the memory 206 may include a non-transitory computer-readable medium storing a set of instructions (for example, code or program code). The memory 206 may include one or more memories, such as a single memory or multiple different memories (of the same type or of different types). For example, the set of instructions, when executed (for example, directly, or after compiling, converting, or interpreting) by the processor set 204, may cause the processor to cause the computing device 200 to perform technique 1200 of FIG. 12, technique 1300 of FIG. 13, technique 1400 of FIG. 14, technique 1500 of FIG. 15, or other techniques as described herein. In some examples, executing instructions may include running the instructions, converting the instructions, compiling the instructions, and/or interpreting the instructions, among other examples.

The number and arrangement of components shown in FIG. 2 are provided as an example. The computing device 200 may include additional components, fewer components, different components, or differently arranged components than those shown in FIG. 2. Additionally, or alternatively, a set of components (e.g., one or more components) of the computing device 200 may perform one or more functions described as being performed by another set of components of the computing device 200.

FIG. 3 is a block diagram of an example of an AI system 300 for dynamic fire risk management from heterogeneous multimodal inputs. The AI system 300 includes a data integration pipeline 302, a data layer 306, a processing layer 308, a tool layer 310, an AI agent network 312, a visualization engine 314, a server 316, and a client 318. Data may flow from a data source 304 to the data integration pipeline 302.

The data integration pipeline 302 may be configured to receive and process multimodal input data from the data source 304. The data integration pipeline 302 may be a sequence of computer-implemented operations that harmonize and integrate data from various sources. For example, the data integration pipeline 302 may be configured to perform temporal interpolation for satellite imagery or spatiotemporal resolution adjustments for weather data to align its granularity with other inputs. In some implementations, the data integration pipeline 302 may be configured to perform a data fusion process, combining data from multiple sources to generate more consistent, accurate, and useful information. The data integration pipeline 302 may be, be similar to, include, or be included in the data integration pipeline 114 shown in FIG. 1, the data integration pipeline 408 shown in FIG. 4, or the data integration pipeline 702 shown in FIG. 7. The processed output from the data integration pipeline 302 may be provided to the data layer 306 and the client 318.

The data integration pipeline 302 may be configured to manage the ingestion of heterogeneous data streams, such as multispectral satellite imagery, SAR data, and real-time meteorological feeds from the data source 304. For example, the data integration pipeline 302 may apply atmospheric and geometric corrections to raw satellite data to remove distortions. In some implementations, the data integration pipeline 302 may align the temporal resolutions of different datasets, such as daily updated multispectral imagery and less frequently updated SAR imagery, by applying temporal interpolation techniques to generate synchronized data layers.

The data source 304 may be any source of data relevant to fire risk assessment. The data source 304 may represent one or more systems that provide data such as satellite-based Earth observation data, meteorological data, topographical data, or historical fire records. For example, the data source 304 may be a public data archive maintained by a government agency or a private data provider offering real-time data feeds. In some implementations, the data source 304 may provide multispectral imagery from Landsat 8, SAR data from Sentinel-1 or NISAR satellites, or meteorological data from the HRRR model. The data source 304 may provide data in various formats, resolutions, and update frequencies. The data source 304 may be, be similar to, include, or be included in the data source 106 and the data source 108 shown in FIG. 1 or the data source 404 and the data source 406 shown in FIG. 4.

The data source 304 may represent a distributed network of data providers, each contributing a different modality of information. For example, one component of the data source 304 may be a real-time sensor network providing ground-level data on soil moisture and air quality, while another component provides high-resolution aerial imagery captured by aircraft. In some implementations, the data source 304 may include crowd-sourced data, such as textual reports or images submitted by individuals, which can provide valuable on-the-ground context for fire risk assessment.

The data layer 306 may be configured to store and manage the data used by the AI system 300. The data layer 306 may include various storage technologies, such as databases, data lakes, or file systems, designed to handle the volume and variety of the multimodal data. For example, the data layer 306 may store raw input data, processed data from the data integration pipeline 302, generated fuel maps, and historical fire potential index values. The data layer 306 may be, be similar to, include, or be included in the data layer 116 shown in FIG. 1, the data layer 410 shown in FIG. 4, or the data layer 502 shown in FIG. 5. In some implementations, the data layer 306 may include specialized data structures such as a knowledge graph or components for managing short-term and long-term memory for the AI agent network 312. The data layer 306 provides data to and receives data from the processing layer 308 and the AI agent network 312. In some implementations, the data layer 306 may be architected as a data lakehouse, combining the flexibility of a data lake for storing raw, unstructured data with the structured management capabilities of a data warehouse for processed data. This architecture may facilitate efficient querying and analysis by the processing layer 308 and the AI agent network 312. For example, the data layer 306 may store time-series data of fire potential index values, which can be used for trend analysis and model validation.

The processing layer 308 may be configured to perform analytical and computational tasks based on the data from the data layer 306. The processing layer 308 may include a plurality of engines or modules for specific functions, such as an engine for generating fuel maps or an engine for determining a fire potential index. The processing layer 308 may be, be similar to, include, or be included in the processing layer 118 shown in FIG. 1, the processing layer 412 shown in FIG. 4, or the processing layer 1008 shown in FIG. 10. The processing layer 308 may interact closely with the AI agent network 312, leveraging machine-learning models to perform its tasks. For example, an engine within the processing layer 308 may use a machine-learning model from the AI agent network 312 to process remote sensing data and generate a fuel characterization map. The processing layer 308 provides data to the data layer 306, the tool layer 310, the AI agent network 312, and the visualization engine 314. In some implementations, the processing layer 308 may include a specialized engine for calculating uncertainty values associated with the fire potential index. This uncertainty engine may analyze the variance across a plurality of overlapping predictions to generate a confidence range for the forecasts. The processing layer 308 may be configured to adapt its calculations for specific environments, such as WUI regions, by incorporating additional parameters like structural vulnerability.

The tool layer 310 may be configured to provide specialized tools and functionalities that build upon the outputs of the processing layer 308. The tool layer 310 may include, for example, a simulation engine for executing fire behavior simulations or a mitigation engine for generating prioritized mitigation plans. The tool layer 310 may be, be similar to, include, or be included in the tool layer 120 shown in FIG. 1, the tool layer 414 shown in FIG. 4, or the tool layer 1010 shown in FIG. 10. For example, a simulation engine within the tool layer 310 may use fuel map data and meteorological data from the processing layer 308 to predict the spread speed and direction of a fire. The tool layer 310 receives input from the processing layer 308 and the server 316. In some implementations, the tool layer 310 may include a suite of optimization tools for resource allocation, providing a mechanism by which fire agencies can plan mitigation efforts based on budget constraints and risk reduction goals. The tool layer 310 may include different simulation engines tailored for different environments. For example, a QUIC-Fire engine may be used for wildland areas, while a SWUIFT engine may be used for WUI areas. The SWUIFT engine, in particular, may model thermal radiation to quantify heat transfer effects on structures and may simulate fire spotting by modeling the generation and transport of firebrands.

The AI agent network 312 may be configured to provide the machine-learning and artificial intelligence capabilities for the AI system 300. The AI agent network 312 may be a multi-agent framework orchestrated by a multi-modal large language model, including a plurality of specialized AI agents. For example, the AI agent network 312 may include a fuel map agent, a fire potential index alert agent, an uncertainty agent, or a simulator coordination agent. In some implementations, the AI agent network 312 may be, be similar to, include, or be included in the AI component 122 shown in FIG. 1, the ML component 604 shown in FIG. 6, or the AI chat agent 1002 shown in FIG. 10. The AI agent network 312 receives input from the processing layer 308 and the server 316 and provides output to the data layer 306. For example, a simulator coordination agent within the AI agent network 312 may facilitate a fire behavior simulation by modeling thermal radiation and fire spotting. The AI agent network 312 may leverage a VLM to perform a semantic interpretation of geographic regions from fused multimodal input data. This VLM may process a combination of imagery and textual data to generate a contextual understanding of the environment, identifying features such as vegetation types, their proximity to structures, and the presence of defensible space. This semantic interpretation enhances the accuracy of fuel maps and the fire potential index.

The visualization engine 314 may be configured to generate visualizations based on the data provided by the processing layer 308. The visualization engine 314 may produce various types of output, such as color-coded risk maps, animated sequences showing temporal predictions, or interactive dashboards. The output from the visualization engine 314 may be provided to the client 318 for display to a user. In some implementations, the visualization engine 314 may be configured to render an animated visualization that displays a temporal sequence of a series of predictions across a forecast horizon. The visualization engine 314 may receive input from the server 316 to customize the visualizations based on user requests. For example, a user may request a visualization that highlights areas where the uncertainty value of the fire potential index is above a certain threshold. The visualization engine 314 may generate output data for an explainable AI mechanism, such as a traceable inference pathway or a user-interpretable decision layer, which exposes information about how a fire potential index was determined. This may provide a mechanism by which stakeholders can understand the reasoning behind the system's predictions, fostering trust and transparency.

The server 316 may be a computing device or a system of computing devices configured to manage communications and orchestrate the components of the AI system 300. The server 316 may host the various layers and engines of the AI system 300 and manage interactions with the client 318. For example, the server 316 may receive a request from the client 318 and route it to the appropriate component, such as the tool layer 310 or the AI agent network 312. The server 316 may be, be similar to, include, or be included in the fire risk management system 102 shown in FIG. 1. In some implementations, the server 316 may be implemented as a distributed system of servers in a cloud computing environment. The server 316 may include an interface component, such as the interface component 112 shown in FIG. 1, to manage communications with external systems. The server 316 may include a conversational AI component configured to receive natural language queries from the client 318 and generate responsive textual briefings. This may involve routing the query to the AI agent network 312 for processing and then formatting the response for delivery back to the client 318. The server 316 may manage user authentication and access control, providing a mechanism by which only authorized users can access the system.

The client 318 may be a software application, such as a web browser or a dedicated mobile application, that runs on a user device. The client 318 may be configured to communicate with the server 316 and to render a graphical user interface for the user. For example, the client 318 may receive data from the data integration pipeline 302 and the visualization engine 314 to display an interactive map showing fire risk levels. The client 318 may be configured to handle user interactions, such as panning and zooming on a map, selecting data layers to display, or submitting queries to the server 316. In some implementations, the client 318 may be, be similar to, include, or be included in the client 124 shown in FIG. 1 or the client 1004 shown in FIG. 10. For example, the client 318 may provide a chat interface for a user to interact with a conversational AI component managed by the server 316. The client 318 may be configured to render various visualizations generated by the visualization engine 314, such as color-coded risk maps indicating different levels of the fire potential index, animated sequences showing the temporal progression of risk, or interactive dashboards for scenario planning. In some implementations, the client 318 may display alerts generated by the AI system 300, such as an alert indicating that a fire potential index has exceeded a predetermined threshold.

FIG. 4 is a block diagram of another example of an AI system 400 for dynamic fire risk management from heterogeneous multimodal inputs. The AI system 400 includes a fire risk management system 402, a data source 404, a data source 406, a data integration pipeline 408, and a support tool 416. Data may flow from the data source 404 and the data source 406 to the data integration pipeline 408.

The fire risk management system 402 may be a computing system configured to receive multimodal input data, process the data using an AI component, and generate output data indicative of a fire potential index. The fire risk management system 402 may be implemented as a single server, a distributed system of servers, a cloud-based computing platform, or a combination of different computing architectures. In some implementations, the fire risk management system 402 may be, be similar to, include, or be included in the fire risk management system 102 shown in FIG. 1.

In some implementations, the fire risk management system 402 may be configured to orchestrate a plurality of specialized AI agents to determine a fire potential index. For example, the fire risk management system 402 may use a multi-modal large language model to coordinate agents such as a fuel map agent, a fire potential index alert agent, and a simulator coordination agent. In some implementations, the fire risk management system 402 may be implemented using one or more computing devices such as, for example, the computing device 200 shown in FIG. 2.

The fire risk management system 402 may be configured to output any number of various types of visualizations such as, for example, an animated heat map showing a temporal sequence of predictions across a forecast horizon, fuel maps, or risk indices, among others. The fire risk management system 402 may receive data from various sources, such as the data source 404 and the data source 406, via the data integration pipeline 408. This data may include, for example, satellite imagery, meteorological data, topographical data, and historical fire records.

The data source 404 may be any source of data relevant to fire risk assessment. The data source 404 may represent a system that provides satellite-based Earth observation data, such as multispectral imagery from Landsat 8 or SAR data from Sentinel-1 or NISAR satellites. For example, the data source 404 may be a public data archive maintained by a government agency like NASA or the USGS. In some implementations, the data source 404 may provide real-time or near-real-time data feeds.

The data source 404 may be configured to provide data in various formats, resolutions, and update frequencies. For example, the data source 404 may stream high-resolution aerial imagery obtained from aircraft, satellite-based remote sensing data, or LiDAR data. In some implementations, the data source 404 may provide ground-level data from mobile mapping operations, infrastructure data from utility companies, or property data from real estate databases. The data source 404 may represent a public or private entity that curates and disseminates specialized datasets, such as vegetation inventories, soil moisture measurements, or socio-economic data relevant to community vulnerability.

In some implementations, the data source 404 may be, be similar to, include, or be included in the data source 106 shown in FIG. 1 or the data source 304 shown in FIG. 3. The data source 404 may provide data that is used by the fire risk management system 402 to generate fuel maps. For instance, the fire risk management system 402 may process remote sensing data from the data source 404 to create a fuel characterization map that identifies a plurality of fuel types and their corresponding fuel loads.

The data source 406 may be another source of data. The data source 406 may be distinct from the data source 404 in the type of data it provides or its provider. For example, the data source 406 may be a meteorological data provider that offers real-time weather feeds and forecast models, such as the HRRR model. In this capacity, the data source 406 may provide updated values for parameters such as wind speed, wind direction, temperature, and relative humidity.

The data source 406 may provide historical data, such as records of past fire events, including ignition points, burn perimeters, and spread characteristics. This historical fire data may be used by the AI component of the fire risk management system 402 to train machine-learning models or to fine-tune regional risk predictions. In some implementations, the data source 406 may provide topographical data, such as a digital elevation model from the SRTM.

In some implementations, the data source 406 may be, be similar to, include, or be included in the data source 108 shown in FIG. 1 or the data source 304 shown in FIG. 3. The fire risk management system 402 may receive data from both the data source 404 and the data source 406 to perform its functions. For example, the fire risk management system 402 may combine satellite imagery from the data source 404 with weather forecasts from the data source 406 to determine a fire potential index for a geographic region.

The data integration pipeline 408 may be configured to ingest, process, and harmonize multimodal input data from the data source 404 and the data source 406. The data integration pipeline 408 may perform a sequence of computer-implemented operations to prepare heterogeneous data for analysis. For example, the data integration pipeline 408 may perform temporal interpolation for satellite imagery data to account for irregular refresh rates or spatiotemporal resolution adjustments for weather data to align its granularity with other inputs.

The data integration pipeline 408 may perform a data fusion process to combine data from multiple sources to generate more consistent, accurate, and useful information. The data integration pipeline 408 provides a processed, fused multimodal dataset to the data layer 410 of the fire risk management system 402 for storage and further use. In some implementations, the data integration pipeline 408 may be configured to manage the ingestion of heterogeneous data streams, such as multispectral satellite imagery, SAR data, and real-time meteorological feeds.

In some implementations, the data integration pipeline 408 may be, be similar to, include, or be included in the data integration pipeline 114 shown in FIG. 1, the data integration pipeline 302 shown in FIG. 3, or the data integration pipeline 702 shown in FIG. 7. For example, the data integration pipeline 408 may apply atmospheric and geometric corrections to raw satellite data to remove distortions. In some implementations, the data integration pipeline 408 may align the temporal resolutions of different datasets by applying temporal interpolation techniques to generate synchronized data layers.

As shown in FIG. 4, the fire risk management system 402 includes a data layer 410, a processing layer 412, and a tool layer 414. In some implementations, two or more of the data layer 410, the processing layer 412, and the tool layer 414 may be integrated into a single component. In some implementations, one or more of the data layer 410, the processing layer 412, and the tool layer 414 may be implemented using any number of computing devices such as the computing device 200 shown in FIG. 2. For example, one or more of the data layer 410, the processing layer 412, and the tool layer 414 may be distributed among a number of computing devices, such as servers in a data center or nodes in a cloud computing environment.

The data layer 410 may be configured to store and manage the data used by the fire risk management system 402. The data layer 410 may include various storage technologies, such as databases, data lakes, or file systems, to handle the volume and variety of the multimodal data. For example, the data layer 410 may store raw input data, processed data from the data integration pipeline 408, generated fuel maps, and historical fire potential index values. The data layer 410 provides data as input to the processing layer 412.

In some implementations, the data layer 410 may be, be similar to, include, or be included in the data layer 116 shown in FIG. 1, the data layer 306 shown in FIG. 3, or the data layer 502 shown in FIG. 5. The data layer 410 may be architected as a data lakehouse, combining the flexibility of a data lake for storing raw, unstructured data with the structured management capabilities of a data warehouse for processed data. This architecture may facilitate efficient querying and analysis by the processing layer 412.

In some implementations, the data layer 410 may be configured to provide a semantic layer that abstracts the underlying physical data storage and exposes the data in a business-friendly, context-rich format. This semantic layer may map complex, raw data entities into well-defined business concepts, such as “fuel parcel,” “infrastructure asset,” or “risk zone,” which are more intuitive for an AI component and human users. For example, by integrating a knowledge graph with data stores, the semantic layer provides a mechanism by which queries may be framed in terms of these concepts.

The processing layer 412 may be configured to perform analytical and computational tasks based on the data from the data layer 410. The processing layer 412 may include a plurality of engines or modules for specific functions. For example, the processing layer 412 may include an engine for generating fuel map data, an engine for determining the fire potential index, and an engine for calculating uncertainty values. The processing layer 412 provides data as input to the tool layer 414.

In some implementations, the processing layer 412 may be, be similar to, include, or be included in the processing layer 118 shown in FIG. 1, the processing layer 308 shown in FIG. 3, or the processing layer 1008 shown in FIG. 10. The processing layer 412 may interact closely with an AI component, leveraging machine-learning models to perform its tasks. For example, an engine within the processing layer 412 may use a machine-learning model from an AI component to process remote sensing data and generate a fuel characterization map.

The processing layer 412 may be configured to execute a suite of computational engines that transform fused multimodal data from the data layer 410 into actionable intelligence. For instance, a fuel map engine within the processing layer 412 may leverage a machine-learning model, such as a Gluon model, to generate high-resolution fuel characterization maps. The processing layer 412 may include an FPI engine configured to determine the fire potential index by synthesizing fuel map data with real-time meteorological data and topographical information.

The tool layer 414 may be configured to provide specialized tools and functionalities that build upon the outputs of the processing layer 412. The tool layer 414 may include, for example, a simulation engine for executing fire behavior simulations or a mitigation engine for generating prioritized mitigation plans. In some implementations, a simulator coordination agent may facilitate a fire behavior simulation by modeling thermal radiation and fire spotting. The tool layer 414 receives input from the processing layer 412 and interacts with the support tool 416. In some implementations, the tool layer 414 may be, be similar to, include, or be included in the tool layer 120 shown in FIG. 1, the tool layer 310 shown in FIG. 3, or the tool layer 1010 shown in FIG. 10.

For example, a simulation engine within the tool layer 414 may use fuel map data and meteorological data from the processing layer 412 to predict the spread speed and direction of a fire. The outputs from the tool layer 414 may be provided to an interface component for visualization on a user device. The tool layer 414 serves as an operational hub, translating the analytical outputs from the processing layer 412 into decision-support functionalities for end-users. A component of the tool layer 414 is a simulation engine, which may be configured to execute a fire behavior simulation. For example, using high-resolution fuel map data and time-series meteorological data from the processing layer 412, the simulation engine may predict the propagation path, spread speed, and direction of a potential fire.

The fire risk management system 402 may include a support tool 416. The support tool 416 may be a component configured to interact with the tool layer 414 of the fire risk management system 402. The support tool 416 may provide functionalities that assist or enhance the operations of the engines within the tool layer 414. For example, the support tool 416 may provide a mechanism by which users may input parameters for a simulation, define constraints for a mitigation plan, or select a specific area for WUI analysis.

In some implementations, the support tool 416 may be a software application or a module within a larger system that facilitates user interaction with the advanced analytical capabilities of the fire risk management system 402. The support tool 416 may receive data from the tool layer 414 and format it for presentation to a user, or it may receive user input and transmit it to the appropriate engine within the tool layer 414. In some implementations, the support tool 416 may be, be similar to, include, or be included in the client 124 shown in FIG. 1 or the client 318 shown in FIG. 3.

The support tool 416 may be configured to provide a graphical user interface for scenario planning, providing a mechanism by which stakeholders may explore the potential outcomes of different mitigation strategies or fire response actions. For example, a user may interact with the support tool 416 to adjust the budget for a mitigation plan and see how the prioritized actions change in response. In some implementations, the support tool 416 may be configured to display the outputs of a fire behavior simulation, such as an animated map showing the predicted spread of a fire over time.

As shown in FIG. 4, the data layer 410 includes a short-term memory 418, a knowledge graph 420, and a data store 422. In some implementations, two or more of the short-term memory 418, the knowledge graph 420, and the data store 422 may be integrated into a single component. For example, the short-term memory 418 and the knowledge graph 420 may be part of a unified semantic data management system. The short-term memory 418 may be configured to store recent user interactions, query results, and feedback from human experts. The short-term memory 418 may be implemented as a high-speed in-memory database or cache, designed to provide a mechanism by which a multi-agent framework may maintain context during a user session and quickly adapt its responses. The short-term memory 418 may receive feedback data from an interface component and use this data to update its contents.

In some implementations, the short-term memory 418 may be configured to store temporary data generated during the execution of analytical tasks by the processing layer 412. For example, the short-term memory 418 may hold intermediate calculations for a fire potential index determination. The contents of the short-term memory 418 may be used to fine-tune the knowledge graph 420 or update the long-term memory of a multi-agent AI framework. In some implementations, the short-term memory 418 may be configured to facilitate personalized user experiences. For example, at least one specialized AI agent may learn user preferences based on an analysis of past user interactions stored in the short-term memory 418 and proactively generate personalized alerts that flag relevant information. This provides a mechanism by which the system may adapt to the specific needs and interests of different users over time.

The knowledge graph 420 may be a structured representation of knowledge where entities and their relationships are represented as nodes and edges. For example, the knowledge graph 420 may link a specific utility pole (an entity) to its geographic coordinates, material type, and proximity to different vegetation types (relationships). This structure facilitates complex queries and semantic reasoning, providing a mechanism by which an AI component may infer relationships that may not be explicit in the raw data. In some implementations, the knowledge graph 420 may be fine-tuned by updating a short-term memory, such as the short-term memory 418, or a long-term memory of a multi-agent framework based on received user feedback from a human expert. For example, if a user corrects a fuel type classification via a graphical user interface, this feedback may be used to update the corresponding entities and relationships in the knowledge graph 420.

The knowledge graph 420 may be integrated with the data store 422 to provide a semantic layer that abstracts the underlying physical data storage. This provides a mechanism by which queries may be framed in terms of business concepts, such as retrieving “all high-vulnerability structures within a 50-meter radius of a specific vegetation type,” without needing to specify the underlying database schemas or file locations. This abstraction facilitates more agile development and querying for the processing layer 412 and the tool layer 414.

The data store 422 may be configured to store the various datasets managed by the data layer 410. The data store 422 may include a variety of storage technologies, such as databases, data lakes, or distributed file systems, to accommodate the volume and heterogeneity of the multimodal data. For example, the data store 422 may store raw satellite imagery, processed fuel maps, meteorological time-series data, and historical fire records.

In some implementations, the data store 422 may be built upon a scalable data lakehouse architecture, which combines the flexibility of a data lake for storing raw, unstructured data with the structured data management capabilities of a data warehouse for processed data. This architecture may utilize distributed file systems like Apache Hadoop Distributed File System (HDFS) or cloud-based object storage services for raw data, and columnar databases or Parquet files for structured, query-optimized data.

The data store 422 provides data to the processing layer 412 for analysis. For example, the fuel map engine 424 may retrieve remote sensing data and topographical data from the data store 422 to generate a new fuel map. The data store 422 may receive and store new data ingested through the data integration pipeline 408, providing a mechanism by which the fire risk management system 402 stays current with the latest available information.

As shown in FIG. 4, the processing layer 412 includes a fuel map engine 424, an FPI engine 426, and an uncertainty engine 428. In some implementations, two or more of the fuel map engine 424, the FPI engine 426, and the uncertainty engine 428 may be integrated into a single component. For example, the FPI engine 426 and the uncertainty engine 428 may be combined into a single risk assessment module.

The fuel map engine 424 may be configured to generate fuel map data based on the multimodal input data. The fuel map engine 424 may process remote sensing data, such as satellite imagery and SAR data, to generate a fuel characterization map associated with a geographic region. The fuel characterization map may identify a plurality of fuel types and their corresponding fuel loads. In some implementations, a fuel map agent may be configured to use the fuel map engine 424 to generate and update the fuel map data. In some implementations, the fuel map data may be refreshed based on a specified periodicity (e.g., on a biweekly cadence) and, as operational needs or observed fuel changes warrant, may be updated more frequently or less frequently. The data integration pipeline and data store support ingesting such periodic updates so that the system remains current with evolving vegetation and fuel conditions.

The fuel map engine 424 may leverage machine-learning models to perform its functions. For example, the fuel map engine 424 may use a trained machine-learning model, such as a Gluon model, to classify vegetation types and estimate fuel loads from pre-processed remote sensing inputs. The output of the fuel map engine 424, the fuel map data, may be provided as input to other engines in the processing layer 412, such as the FPI engine 426, and to the tool layer 414.

In some implementations, particularly for WUI areas, the fuel map engine 424 may perform a detailed urban fuel segmentation process. This may involve using computer vision and machine-learning models to identify and classify a variety of combustible and non-combustible features within a developed environment, such as building structures, fences, vehicles, and utility poles. This process may generate a comprehensive urban fuel layer that characterizes the various elements contributing to fire risk in a WUI.

The FPI engine 426 may be configured to determine a fire potential index associated with a geographic region. The FPI engine 426 may synthesize fuel map data from the fuel map engine 424 with meteorological data and topographical data to calculate the fire potential index. This determination may involve generating hourly predictions for a forecast horizon of at least 48 hours. In some implementations, the FPI engine 426 may support extended-horizon analysis by consuming synthetic weather data to generate scenario ensembles beyond the native forecast window (e.g., week-to-season horizons). Synthetic weather data, as used herein, may include temporally coherent meteorological sequences (e.g., temperature, relative humidity, wind speed/direction, precipitation) produced by statistically resampling and/or blending historical archives with forecast model outputs to preserve spatial/temporal correlations. Each synthetic scenario may be evaluated to produce a per-scenario FPI for each location and time step. The per-scenario FPIs may be normalized and aggregated (e.g., daily/weekly/monthly) to yield extended-horizon FPI summaries suitable for risk reporting. The uncertainty engine (e.g., 428) may quantify confidence by analyzing variance across scenarios (e.g., moving standard deviation or bootstrapped intervals) and by providing confidence ranges for the extended-horizon indices. These extended-horizon FPI outputs may be rendered in the GUI and/or exported as tabular aggregates for stakeholders, including insurance underwriting and portfolio-risk analysis, where longer-horizon hazard signals are useful.

The FPI engine 426 may be configured to adapt the fire potential index determination for specific environments. For example, in WUI regions, the FPI engine 426 may incorporate additional parameters such as structural vulnerability and defensible space characteristics, which may be derived from an urban fuel layer. The output of the FPI engine 426, the fire potential index, may be provided to the tool layer 414 and to an interface component for visualization.

In some implementations, the determination of the fire potential index by the FPI engine 426 may be orchestrated by a multi-agent framework. For example, a fire potential index alert agent may interact with the FPI engine 426 to monitor the fire potential index and generate an alert when it exceeds a predetermined threshold. The FPI engine 426 may leverage machine-learning models to identify complex patterns and correlations between the various input variables.

The uncertainty engine 428 may be configured to calculate an uncertainty value associated with the fire potential index determined by the FPI engine 426. The uncertainty engine 428 may provide a metric indicating the confidence level or potential variability of a prediction. For example, the uncertainty engine 428 may generate a confidence range for the fire potential index. In some implementations, the uncertainty engine 428 may calculate the uncertainty value by generating a plurality of fire potential index forecasts at successive time intervals, creating overlapping predictions for future time points. The uncertainty engine 428 may then analyze the variance across these overlapping predictions, using techniques like a moving standard deviation or bootstrapped interval analysis, to calculate the confidence range. In some implementations, an uncertainty agent may be configured to use the uncertainty engine 428 to perform these calculations.

The output of the uncertainty engine 428 may be provided to an interface component to be displayed to the user. For example, an alert may be generated if the uncertainty value is greater than a threshold value. In some implementations, the uncertainty engine 428 may apply one or more Markov Chain Monte Carlo models developed based on historical fire data associated with the geographic region to calculate the uncertainty value.

As shown in FIG. 4, the tool layer 414 includes a simulation engine 430, a mitigation engine 432, and a WUI integration engine 434. In some implementations, two or more of the simulation engine 430, the mitigation engine 432, and the WUI integration engine 434 may be integrated into a single component. For example, the WUI integration engine 434 may be a module within the simulation engine 430 that provides specialized functionalities for WUI environments.

The simulation engine 430 may be configured to execute a fire behavior simulation. The simulation engine 430 may use fuel map data and meteorological data from the processing layer 412 to predict the propagation characteristics of a fire, such as its spread speed, direction, or propagation path. In some implementations, a simulator coordination agent may be configured to facilitate the fire behavior simulation by managing the inputs and outputs for the simulation engine 430. In some implementations, the simulation engine 430 may include different simulation engines for different contexts. For example, the simulation engine 430 may use a QUIC-Fire engine for wildland areas and a SWUIFT engine for WUI areas. The simulation outputs from the simulation engine 430 may be provided to an interface component for visualization, providing a mechanism by which stakeholders may view potential fire scenarios.

The SWUIFT engine, in particular, may model thermal radiation to quantify heat transfer effects on structures and may simulate fire spotting by modeling the generation, transport, and ignition of firebrands originating from both vegetation and built structures. The simulation engine 430 may evaluate a structural vulnerability for built structures based on factors such as roofing type, siding material, or window configuration, and incorporate uncertainties related to fire behavior into the fire behavior simulation.

The mitigation engine 432 may be configured to generate a prioritized mitigation plan. The mitigation engine 432 may receive risk data from the processing layer 412, including the fire potential index and vulnerability assessments, and combine it with a library of mitigation actions and their associated costs. For example, the mitigation engine 432 may apply a planning optimization tool to select a subset of mitigation actions that maximizes the total expected risk reduction without exceeding a budget constraint. In some implementations, the mitigation engine 432 may apply a mixed-integer linear programming model to perform the optimization. The mitigation engine 432 may calculate a risk-spend efficiency metric for each potential action to inform its recommendations.

In some implementations, the planning optimization tool evaluates and prioritizes treatments such as asset-hardening, vegetation thinning, prescribed burns, defensible-space buffers, or related measures, subject to ecological (e.g., habitat windows, smoke impact), budgetary (e.g., total and per-period budgets), or operational (e.g., crew availability, access) constraints. For utility infrastructure use cases, the tool further supports Public Safety Power Shutoff (PSPS) and Enhanced Powerline Safety Settings (EPSS) planning by assessing risk reduction and customer-impact tradeoffs for candidate operational settings in WUI regions. The optimization may be scenario-aware, evaluating alternative mitigation portfolios across forecast and historic risk conditions to identify robust plans. Outputs may include a ranked, costed list of recommended interventions with expected risk-reduction values and risk-spend efficiency, a proposed schedule, or map overlays highlighting treatment locations. Recommendations may encompass vegetation removal, strategic barrier placement, or use of fire-resistant building materials. The resulting prioritized mitigation plan may be provided to the support tool or interface components for display as a ranked list and/or interactive map for scenario comparison and reporting.

In some implementations, the planning optimization tool fuses multi-source layers including, but not limited to, structural and WUI fuel layers (e.g., urban fuel segmentation, structural vulnerability indices), infrastructure layers (e.g., roads, utility infrastructure, cables), and vegetation/fuel map data, with scenario modeling outputs from the simulation engine (e.g., QUIC-Fire for wildland, SWUIFT for WUI) to evaluate candidate mitigation strategies across multiple potential fire-risk conditions (e.g., historic and forecast weather patterns). Infrastructure layers may be sourced from utility companies, government agencies, or an infrastructure data extractor (e.g., the infrastructure data extractor 1030 shown in FIG. 10), while fuel/vegetation layers are produced by the fuel map engine and WUI integration engine. For each scenario, the tool may compute expected risk reduction for a proposed portfolio (e.g., vegetation thinning, defensible-space buffers, asset-hardening) by propagating the scenario's fire spread/impact predictions over the fused layers to quantify exposure to structures and infrastructure assets. The support tool may provide scenario-planning controls (e.g., selection of scenarios, budgets, and constraints) and may display comparative results as ranked, costed lists and map overlays. This scenario-aware, layer-fused evaluation may facilitate comprehensive assessment of mitigation effectiveness prior to optimization and may inform PSPS/EPSS planning for utility use cases.

In some implementations, the functionalities of the mitigation engine 432 may be orchestrated by specialized AI agents within a multi-agent framework. For example, a mitigation planning agent, a prioritization agent, or a return on investment agent may interact with the mitigation engine 432 to generate and refine mitigation plans based on specific user queries or evolving risk conditions. The return on investment agent may be configured to generate recommendations associated with fire mitigation plans based on return on investment modeling associated with at least one of an economic dimension, a social dimension, or an environmental dimension.

The WUI integration engine 434 may be configured to provide specialized functionalities for WUI environments. The WUI integration engine 434 may process data specific to WUI areas, such as detailed urban fuel layers, structural vulnerability data, and defensible space characteristics. For example, the WUI integration engine 434 may analyze the spatial relationships between different fuel types to determine more granular risk metrics. In some implementations, the WUI integration engine 434 may calculate the vegetation hazard within defensible space around a particular structure. This may be calculated by determining the percentage of vegetation coverage within predefined concentric zones or buffers around a building. These analyses may be used to generate additional risk indices, such as a House-to-House Ignition Potential Index or a Structure Vulnerability Index.

The WUI integration engine 434 may provide its outputs to other engines within the tool layer 414. For example, the WUI integration engine 434 may provide detailed fuel and structural data to the simulation engine 430 to initialize a SWUIFT simulation. In some implementations, the WUI integration engine 434 may provide vulnerability assessments to the mitigation engine 432 to inform the generation of prioritized mitigation plans for WUI areas.

FIG. 5 is a block diagram of another example of an AI system 500 for dynamic fire risk management from heterogeneous multimodal inputs. The AI system 500 includes a data layer 502, a fuel map engine 504, a support tool 506, an FPI engine 508, an uncertainty engine 510, a WUI integration engine 512, a simulation engine 514, and a mitigation engine 516. The data layer 502 may provide integrated data 518 to the fuel map engine 504 and the WUI integration engine 512. The fuel map engine 504 may provide fuel map data 520 to the support tool 506, the FPI engine 508, the uncertainty engine 510, the simulation engine 514, and the mitigation engine 516. A processing and interaction flow may facilitate data exchange between the FPI engine 508, the uncertainty engine 510, the WUI integration engine 512, the simulation engine 514, and the mitigation engine 516.

The data layer 502 may be configured to store and manage the data used by the AI system 500. The data layer 502 may include various storage technologies, such as databases, data lakes, or file systems, to handle the volume and variety of multimodal data. For example, the data layer 502 may store raw input data, processed data from a data integration pipeline, and generated fuel maps. In some implementations, the data layer 502 may be, be similar to, include, or be included in the data layer 116 shown in FIG. 1, the data layer 306 shown in FIG. 3, or the data layer 410 shown in FIG. 4. The data layer 502 provides integrated data 518 as input to the fuel map engine 504 and the WUI integration engine 512.

The data layer 502 serves as the central repository and data management hub for the AI system 500. In some implementations, the data layer 502 may be built upon a scalable data lakehouse architecture, which combines the flexibility of a data lake for storing raw, unstructured data with the structured data management capabilities of a data warehouse for processed, query-optimized data. This architecture may facilitate efficient data retrieval and analysis by the various engines of the AI system 500.

In some implementations, the data layer 502 may include specialized data structures such as a knowledge graph or components for managing short-term and long-term memory for an AI component. A knowledge graph may provide a structured representation of entities and their relationships, facilitating complex queries and semantic reasoning. The memory components may provide a mechanism by which a multi-agent AI framework may maintain context during user sessions and adapt its responses based on historical data and user feedback.

The fuel map engine 504 may be configured to generate fuel map data 520 based on the integrated data 518 from the data layer 502. The fuel map engine 504 may process remote sensing data, such as satellite imagery and SAR data, to generate a fuel characterization map associated with a geographic region. The fuel characterization map may identify a plurality of fuel types and their corresponding fuel loads. In some implementations, the fuel map engine 504 may be, be similar to, include, or be included in the fuel map engine 424 shown in FIG. 4.

The fuel map engine 504 may leverage machine-learning models to perform its functions. For example, the fuel map engine 504 may use a trained machine-learning model to classify vegetation types and estimate fuel loads from pre-processed remote sensing inputs. The output of the fuel map engine 504, the fuel map data 520, may be provided as input to the support tool 506 and other engines in the AI system 500, such as the FPI engine 508, the uncertainty engine 510, the simulation engine 514, and the mitigation engine 516.

In some implementations, particularly for WUI areas, the fuel map engine 504 may perform a detailed urban fuel segmentation process. This may involve using computer vision and machine-learning models to identify and classify a variety of combustible and non-combustible features within a developed environment, such as building structures, fences, vehicles, and utility poles. This process may generate a comprehensive urban fuel layer that characterizes the various elements contributing to fire risk in a WUI.

The support tool 506 may be a component configured to interact with the engines of the AI system 500. The support tool 506 may provide functionalities that assist or enhance the operations of engines such as the simulation engine 514 and the mitigation engine 516. For example, the support tool 506 may provide a mechanism by which users may input parameters for a simulation, define constraints for a mitigation plan, or select a specific area for analysis. The support tool 506 receives fuel map data 520 from the fuel map engine 504.

In some implementations, the support tool 506 may be a software application or a module within a larger system that facilitates user interaction with the advanced analytical capabilities of the AI system 500. The support tool 506 may receive data from the simulation engine 514 and the mitigation engine 516 and format it for presentation to a user, or it may receive user input and transmit it to the appropriate engine. In some implementations, the support tool 506 may be, be similar to, include, or be included in the support tool 416 shown in FIG. 4.

The support tool 506 may be configured to provide a graphical user interface for scenario planning, providing a mechanism by which stakeholders may explore the potential outcomes of different mitigation strategies or fire response actions. For example, a user may interact with the support tool 506 to adjust the budget for a mitigation plan and see how prioritized actions change in response. In some implementations, the support tool 506 may be configured to display the outputs of a fire behavior simulation.

The FPI engine 508 may be configured to determine a fire potential index associated with a geographic region. The FPI engine 508 may synthesize fuel map data 520 from the fuel map engine 504 with meteorological data and topographical data to calculate the fire potential index. This determination may involve generating hourly predictions for a forecast horizon of at least 48 hours. In some implementations, the FPI engine 508 may be, be similar to, include, or be included in the FPI engine 426 shown in FIG. 4.

The FPI engine 508 may be configured to adapt the fire potential index determination for specific environments. For example, in WUI regions, the FPI engine 508 may incorporate additional parameters such as structural vulnerability and defensible space characteristics, which may be derived from an urban fuel layer. The output of the FPI engine 508, the fire potential index, may be provided to an interface component for visualization and used in the processing and interaction flow.

In some implementations, the determination of the fire potential index by the FPI engine 508 may be orchestrated by a multi-agent framework. For example, a fire potential index alert agent may interact with the FPI engine 508 to monitor the fire potential index and generate an alert when it exceeds a predetermined threshold. The FPI engine 508 may leverage machine-learning models to identify complex patterns and correlations between the various input variables.

The uncertainty engine 510 may be configured to calculate an uncertainty value associated with the fire potential index determined by the FPI engine 508. The uncertainty engine 510 may provide a metric indicating the confidence level or potential variability of a prediction. For example, the uncertainty engine 510 may generate a confidence range for the fire potential index based on fuel map data 520. In some implementations, the uncertainty engine 510 may be, be similar to, include, or be included in the uncertainty engine 428 shown in FIG. 4.

In some implementations, the uncertainty engine 510 may calculate the uncertainty value by generating a plurality of fire potential index forecasts at successive time intervals, creating overlapping predictions for future time points. The uncertainty engine 510 may then analyze the variance across these overlapping predictions, using techniques like a moving standard deviation or bootstrapped interval analysis, to calculate the confidence range. In some implementations, an uncertainty agent may be configured to use the uncertainty engine 510 to perform these calculations.

The output of the uncertainty engine 510 may be provided to an interface component to be displayed to a user. For example, an alert may be generated if the uncertainty value is greater than a threshold value. In some implementations, the uncertainty engine 510 may apply one or more Markov Chain Monte Carlo models developed based on historical fire data associated with the geographic region to calculate the uncertainty value.

The WUI integration engine 512 may be configured to provide specialized functionalities for WUI environments. In some implementations, the WUI integration engine 512 implements a regionally specific WUI risk model that combines: (i) high-resolution WUI fuel metrics derived from an urban fuel layer (e.g., a structure vulnerability index accounting for structure components such as roofing, siding, windows, vents, fences, or decks, among other examples; a house-to-house ignition potential index; and vegetation-hazard measurements within defensible-space zones), (ii) meteorological inputs (e.g., wind speed/direction, humidity, precipitation), (iii) topographical features (elevation, slope), and (iv) historical burn records associated with the geographic region. The WUI risk model may include an ignition-probability sub-model that estimates the likelihood of structure or parcel ignition under current or forecast fire-weather conditions and a spread/impact sub-model that estimates potential fire behavior across WUI terrain (e.g., expected direction, rate of spread, and structure-to-structure exposure). Outputs of the WUI risk model may include a WUI risk surface and per-structure (or per-parcel) risk scores, which can be rendered in the GUI and/or supplied to the simulation engine 514 for initializing WUI-specific simulations (e.g., SWUIFT), as well as to the mitigation engine 516 for prioritizing risk-reduction actions. Fuel-related inputs to the WUI risk model may be obtained from the urban fuel segmentation and indices described herein, while weather, topography, and historical fire data may be ingested via the processing layer and data layer as previously described.

The WUI integration engine 512 may process integrated data 518 specific to WUI areas, such as detailed urban fuel layers, structural vulnerability data, and defensible space characteristics. For example, the WUI integration engine 512 may analyze the spatial relationships between different fuel types to determine more granular risk metrics. In some implementations, the WUI integration engine 512 may be, be similar to, include, or be included in the WUI integration engine 434 shown in FIG. 4.

In some implementations, the WUI integration engine 512 may calculate the vegetation hazard within defensible space around a particular structure. This may be calculated by determining the percentage of vegetation coverage within predefined concentric zones or buffers around a building. These analyses may be used to generate additional risk indices, such as a House-to-House Ignition Potential Index or a Structure Vulnerability Index.

The WUI integration engine 512 may provide its outputs to other engines within the AI system 500 via the processing and interaction flow. For example, the WUI integration engine 512 may provide detailed fuel and structural data to the simulation engine 514 to initialize a SWUIFT simulation. In some implementations, the WUI integration engine 512 may provide vulnerability assessments to the mitigation engine 516 to inform the generation of prioritized mitigation plans for WUI areas.

The simulation engine 514 may be configured to execute a fire behavior simulation. The simulation engine 514 may use fuel map data 520 and meteorological data to predict the propagation characteristics of a fire, such as its spread speed, direction, or propagation path. In some implementations, a simulator coordination agent may be configured to facilitate the fire behavior simulation by managing the inputs and outputs for the simulation engine 514. In some implementations, the simulation engine 514 may be, be similar to, include, or be included in the simulation engine 430 shown in FIG. 4.

In some implementations, the simulation engine 514 may include different simulation engines for different contexts. For example, the simulation engine 514 may use a QUIC-Fire engine for wildland areas and a SWUIFT engine for WUI areas. The simulation outputs from the simulation engine 514 may be provided to the support tool 506 and to an interface component for visualization, providing a mechanism by which stakeholders may view potential fire scenarios.

The SWUIFT engine, in particular, may model thermal radiation to quantify heat transfer effects on structures and may simulate fire spotting by modeling the generation, transport, and ignition of firebrands originating from both vegetation and built structures. The simulation engine 514 may evaluate a structural vulnerability for built structures based on factors such as roofing type, siding material, or window configuration, and incorporate uncertainties related to fire behavior into the fire behavior simulation.

The mitigation engine 516 may be configured to generate a prioritized mitigation plan. The mitigation engine 516 may receive risk data, including the fire potential index and vulnerability assessments, and combine it with fuel map data 520 and a library of mitigation actions and their associated costs. For example, the mitigation engine 516 may apply an optimization model to select a subset of mitigation actions that maximizes the total expected risk reduction without exceeding a budget constraint. In some implementations, the mitigation engine 516 may be, be similar to, include, or be included in the mitigation engine 432 shown in FIG. 4.

In some implementations, the mitigation engine 516 may apply a mixed-integer linear programming model to perform the optimization. The mitigation engine 516 may calculate a risk-spend efficiency metric for each potential action to inform its recommendations. The resulting prioritized mitigation plan may be provided to the support tool 506 and to an interface component for display as a ranked list or an interactive map.

In some implementations, the functionalities of the mitigation engine 516 may be orchestrated by specialized AI agents within a multi-agent framework. For example, a mitigation planning agent, a prioritization agent, or a return on investment agent may interact with the mitigation engine 516 to generate and refine mitigation plans based on specific user queries or evolving risk conditions. The return on investment agent may be configured to generate recommendations associated with fire mitigation plans based on return on investment modeling associated with at least one of an economic dimension, a social dimension, or an environmental dimension.

FIG. 6 is a block diagram of another example of an AI system 600 for dynamic fire risk management from heterogeneous multimodal inputs. The AI system 600 includes a feature engineering engine 602, an ML component 604, an FPI engine 606, a simulation engine 608, and a client application 610. Input data 612 may be provided to the feature engineering engine 602. The ML component 604 may generate fuel map data 614 and environmental data 616, which may be provided to the FPI engine 606 and the simulation engine 608. The FPI engine 606 and the simulation engine 608 may provide data to the client application 610.

The feature engineering engine 602 may be configured to process the input data 612 to extract and prepare features for use by the ML component 604. As used herein, “feature engineering” may refer to the process of using domain knowledge to create features that make machine-learning algorithms work. The feature engineering engine 602 may perform operations such as data cleaning, transformation, and normalization. For example, the feature engineering engine 602 may compute NDVI metrics from satellite data or SAR-based metrics from SAR data. The output of the feature engineering engine 602 may be provided to the ML component 604.

In some implementations, the feature engineering engine 602 may be configured to perform a series of orchestrated tasks to transform raw, heterogeneous input data 612 into a clean, unified format suitable for the ML component 604. For instance, upon ingesting satellite imagery as part of the input data 612, a data correction component within the feature engineering engine 602 may perform atmospheric and geometric corrections to remove distortions and artifacts. Following correction, a data synchronization component may align the temporal resolution of different datasets. For example, if multispectral imagery is updated daily and SAR imagery every 12 days, the feature engineering engine 602 may apply temporal interpolation techniques to generate consistent, time-aligned data layers.

In addition to processing remote sensing data, the feature engineering engine 602 may handle the harmonization of meteorological inputs from the input data 612. Weather data may be provided on a grid with a different spatial resolution than satellite imagery. To reconcile this, the feature engineering engine 602 may perform spatiotemporal resolution adjustments, using methods like bilinear or bicubic interpolation to downscale weather parameters onto a higher-resolution grid. This alignment may provide a mechanism by which weather variables are mapped to each fuel parcel, facilitating more accurate calculations by the FPI engine 606.

The ML component 604 may be configured to provide the machine-learning and artificial intelligence capabilities for the AI system 600. The ML component 604 may include one or more machine-learning models, such as vision-language models (VLMs), neural networks, or ensemble models. For example, the ML component 604 may be used to determine a fire potential index based on processed input data from the feature engineering engine 602. In some implementations, the ML component 604 may be, be similar to, include, or be included in the AI component 122 shown in FIG. 1 or the AI agent network 312 shown in FIG. 3. The ML component 604 provides fuel map data 614 and environmental data 616 to the FPI engine 606 and the simulation engine 608.

In some implementations, the ML component 604 is architected as a multi-agent framework orchestrated by a multi-modal large language model. This multi-agent framework may include a plurality of specialized AI agents, each configured to perform a distinct function. For example, a fuel map agent may be configured to generate and continually update the fuel map data 614. Within this multi-agent framework, the ML component 604 may leverage a VLM to perform a semantic interpretation of a geographic region from fused multimodal input data 612. The VLM may process a combination of satellite imagery, aerial photos, street-level imagery, and textual data to generate a rich, contextual understanding of the environment.

In some implementations, the ML component 604 is configured to learn and adapt based on user interactions and feedback. For example, at least one specialized AI agent may learn user preferences based on an analysis of past user interactions and proactively generate personalized alerts that flag information relevant to a user's specific area of responsibility or interest. The ML component 604 may utilize short-term and long-term memory components to store these learnings. When a human expert provides feedback, this feedback may be used to update the memory and fine-tune a knowledge graph, providing a mechanism by which the ML component 604 may improve its performance and predictive accuracy over time.

The FPI engine 606 may be configured to determine a fire potential index associated with a geographic region. The FPI engine 606 may synthesize fuel map data 614 and environmental data 616 from the ML component 604 to calculate the fire potential index. This determination may involve generating hourly predictions for a forecast horizon of at least 48 hours. In some implementations, the FPI engine 606 may be, be similar to, include, or be included in the FPI engine 426 shown in FIG. 4 or the FPI engine 508 shown in FIG. 5. The output of the FPI engine 606 may be provided to the client application 610.

The FPI engine 606 may be configured to adapt the fire potential index determination for specific environments. For example, in WUI regions, the FPI engine 606 may incorporate additional parameters such as structural vulnerability and defensible space characteristics, which may be derived from an urban fuel layer. The output of the FPI engine 606, the fire potential index, may be provided to an interface component for visualization via the client application 610.

In some implementations, the determination of the fire potential index by the FPI engine 606 may be orchestrated by a multi-agent framework within the ML component 604. For example, a fire potential index alert agent may interact with the FPI engine 606 to monitor the fire potential index and generate an alert when it exceeds a predetermined threshold. The FPI engine 606 may leverage machine-learning models from the ML component 604 to identify complex patterns and correlations between the various input variables.

The simulation engine 608 may be configured to execute a fire behavior simulation. The simulation engine 608 may use fuel map data 614 and environmental data 616 from the ML component 604 to predict the propagation characteristics of a fire, such as its spread speed, direction, or propagation path. In some implementations, the simulation engine 608 may be, be similar to, include, or be included in the simulation engine 430 shown in FIG. 4 or the simulation engine 514 shown in FIG. 5. The output of the simulation engine 608 may be provided to the client application 610.

In some implementations, the simulation engine 608 may include different simulation engines for different contexts. For example, the simulation engine 608 may use a QUIC-Fire engine for wildland areas and a SWUIFT engine for WUI areas. The simulation outputs from the simulation engine 608 may be provided to an interface component for visualization via the client application 610, providing a mechanism by which stakeholders may view potential fire scenarios.

The SWUIFT engine, in particular, may model thermal radiation to quantify heat transfer effects on structures and may simulate fire spotting by modeling the generation, transport, and ignition of firebrands originating from both vegetation and built structures. The simulation engine 608 may evaluate a structural vulnerability for built structures based on factors such as roofing type, siding material, or window configuration, and incorporate uncertainties related to fire behavior into the fire behavior simulation.

The client application 610 may be a software application, such as a web browser or a dedicated mobile application, that runs on a user device. The client application 610 may be configured to communicate with the AI system 600 and to render a graphical user interface for the user. For example, the client application 610 may receive data from the FPI engine 606 and the simulation engine 608 to display an interactive map showing fire risk levels and simulation results. In some implementations, the client application 610 may be, be similar to, include, or be included in the client 124 shown in FIG. 1 or the client 318 shown in FIG. 3.

The client application 610 may be configured to handle user interactions, such as panning and zooming on a map, selecting data layers to display, or submitting queries to the AI system 600. For example, the client application 610 may provide a chat interface for a user to interact with a conversational AI component of the AI system 600.

The client application 610 may be configured to render various visualizations generated by the AI system 600, such as color-coded risk maps indicating different levels of a fire potential index, animated sequences showing the temporal progression of risk, or interactive dashboards for scenario planning. In some implementations, the client application 610 may display alerts generated by the AI system 600, such as an alert indicating that a fire potential index has exceeded a predetermined threshold.

FIG. 7 is a data flow diagram of an example of a data layer 700 of an AI system for dynamic fire risk management from heterogeneous multimodal inputs. The data layer 700 includes a data integration pipeline 702 and a semantic infrastructure engine 704. The data layer 700 may be, be similar to, include, or be included in the data layer 116 shown in FIG. 1, the data layer 306 shown in FIG. 3, or the data layer 410 shown in FIG. 4. Data may flow from a data source 722 and a data source 726 to the data integration pipeline 702. The data integration pipeline 702 may provide pre-processed data 730 to the semantic infrastructure engine 704. The semantic infrastructure engine 704 may interact with a data store 706, a knowledge graph 708, and a short-term memory 710.

The data integration pipeline 702 may be configured to ingest, process, and harmonize multimodal input data, such as input data 724 from the data source 722 and input data 728 from the data source 726. The data integration pipeline 702 may perform a sequence of computer-implemented operations to prepare heterogeneous data for analysis. For example, the data integration pipeline 702 may perform temporal interpolation for satellite imagery data to account for irregular refresh rates or spatiotemporal resolution adjustments for weather data to align its granularity with other inputs. In some implementations, the data integration pipeline 702 may be, be similar to, include, or be included in the data integration pipeline 114 shown in FIG. 1, the data integration pipeline 302 shown in FIG. 3, or the data integration pipeline 408 shown in FIG. 4.

The data integration pipeline 702 may perform a data fusion process to combine data from multiple sources to generate more consistent, accurate, and useful information. The data integration pipeline 702 provides the pre-processed data 730 to the semantic infrastructure engine 704 for storage and further use. In some implementations, the data integration pipeline 702 may be configured to manage the ingestion of heterogeneous data streams, such as multispectral satellite imagery, SAR data, and real-time meteorological feeds. For example, the data integration pipeline 702 may apply atmospheric and geometric corrections to raw satellite data to remove distortions.

In some implementations, the data integration pipeline 702 may align the temporal resolutions of different datasets by applying temporal interpolation techniques to generate synchronized data layers. For instance, if multispectral imagery is updated daily and SAR imagery every 12 days, the data integration pipeline 702 may apply temporal interpolation techniques to generate consistent, time-aligned data layers. This provides a mechanism by which remote sensing inputs may represent a synchronized snapshot of a geographic region.

The semantic infrastructure engine 704 may be configured to manage the storage, organization, and retrieval of data within the data layer 700. The semantic infrastructure engine 704 may receive the pre-processed data 730 from the data integration pipeline 702 and interact with the data store 706, the knowledge graph 708, and the short-term memory 710 to process and structure this data. For example, the semantic infrastructure engine 704 may store the pre-processed data 730 in the data store 706 and use information from the knowledge graph 708 to add semantic context to the data.

In some implementations, the semantic infrastructure engine 704 may be configured to provide a semantic layer that abstracts the underlying physical data storage and exposes the data in a business-friendly, context-rich format. This semantic layer may map complex, raw data entities into well-defined business concepts, such as “fuel parcel,” “infrastructure asset,” or “risk zone,” which are more intuitive for an AI component and human users. For example, by integrating the knowledge graph 708 with the data store 706, the semantic layer provides a mechanism by which queries may be framed in terms of these concepts.

The semantic infrastructure engine 704 may receive feedback data 732 from the short-term memory 710. This feedback data 732 may include recent user interactions, query results, or feedback from human experts. The semantic infrastructure engine 704 may use this feedback data 732 to update the knowledge graph 708 or fine-tune the data stored in the data store 706. In some implementations, the semantic infrastructure engine 704 may be part of a larger AI component, such as the AI component 122 shown in FIG. 1.

The data store 706 may be configured to store the various datasets managed by the data layer 700. The data store 706 may include a variety of storage technologies, such as databases, data lakes, or distributed file systems, to accommodate the volume and heterogeneity of the multimodal data. As shown in FIG. 7, the data store 706 may include a DB 718 and a DB 720. For example, the data store 706 may store raw satellite imagery, processed fuel maps, meteorological time-series data, and historical fire records. In some implementations, the data store 706 may be, be similar to, include, or be included in the data store 422 shown in FIG. 4.

In some implementations, the data store 706 may be built upon a scalable data lakehouse architecture, which combines the flexibility of a data lake for storing raw, unstructured data with the structured data management capabilities of a data warehouse for processed data. This architecture may utilize distributed file systems like Apache Hadoop Distributed File System (HDFS) or cloud-based object storage services for raw data, and columnar databases or Parquet files for structured, query-optimized data.

The data store 706 provides data to and receives data from the semantic infrastructure engine 704. For example, a fuel map engine may retrieve remote sensing data and topographical data from the data store 706 via the semantic infrastructure engine 704 to generate a new fuel map. The data store 706 may receive and store new pre-processed data 730, providing a mechanism by which a fire risk management system stays current with the latest available information.

The knowledge graph 708 may be a structured representation of knowledge where entities and their relationships are represented as nodes and edges. For example, the knowledge graph 708 may link a specific utility pole (an entity) to its geographic coordinates, material type, and proximity to different vegetation types (relationships). This structure facilitates complex queries and semantic reasoning, providing a mechanism by which an AI component may infer relationships that may not be explicit in the raw data. In some implementations, the knowledge graph 708 may be, be similar to, include, or be included in the knowledge graph 420 shown in FIG. 4.

In some implementations, the knowledge graph 708 may be fine-tuned based on received user feedback from a human expert. For example, if a user corrects a fuel type classification via a graphical user interface, this feedback may be stored in the short-term memory 710 and provided as feedback data 732 to the semantic infrastructure engine 704, which may then update the corresponding entities and relationships in the knowledge graph 708.

The knowledge graph 708 may be integrated with the data store 706 via the semantic infrastructure engine 704 to provide a semantic layer that abstracts the underlying physical data storage. This provides a mechanism by which queries may be framed in terms of business concepts, such as retrieving “all high-vulnerability structures within a 50-meter radius of a specific vegetation type,” without needing to specify the underlying database schemas or file locations.

The short-term memory 710 may be configured to store recent user interactions, query results, and feedback from human experts. The short-term memory 710 may be implemented as a high-speed in-memory database or cache, designed to provide a mechanism by which a multi-agent framework may maintain context during a user session and quickly adapt its responses. The short-term memory 710 may provide feedback data 732 to the semantic infrastructure engine 704. In some implementations, the short-term memory 710 may be, be similar to, include, or be included in the short-term memory 418 shown in FIG. 4.

In some implementations, the short-term memory 710 may be configured to store temporary data generated during the execution of analytical tasks by a processing layer. For example, the short-term memory 710 may hold intermediate calculations for a fire potential index determination. The contents of the short-term memory 710 may be used to fine-tune the knowledge graph 708 or update a long-term memory of a multi-agent AI framework.

In some implementations, the short-term memory 710 may be configured to facilitate personalized user experiences. For example, at least one specialized AI agent may learn user preferences based on an analysis of past user interactions stored in the short-term memory 710 and proactively generate personalized alerts that flag relevant information. This provides a mechanism by which the system may adapt to the specific needs and interests of different users over time.

As shown in FIG. 7, the data integration pipeline 702 includes a data correction component 712, a data sync component 714, and a data fusion component 716. In some implementations, two or more of the data correction component 712, the data sync component 714, and the data fusion component 716 may be integrated into a single component. For example, the data sync component 714 and the data fusion component 716 may be combined into a single data harmonization module.

The data correction component 712 may be configured to perform initial processing operations on raw input data to remove distortions, artifacts, and inconsistencies. For example, upon ingesting satellite imagery, the data correction component 712 may perform atmospheric and geometric corrections to improve the quality and accuracy of the imagery data. The data correction component 712 may receive input data from various sources and provide corrected data to the data sync component 714.

In some implementations, the data correction component 712 may be configured to handle different types of data and apply specific correction algorithms based on the data modality. For instance, for SAR data, the data correction component 712 may perform radiometric calibration and speckle filtering. For meteorological data, the data correction component 712 may perform quality control checks to identify and remove erroneous sensor readings.

The data sync component 714 may be configured to align the temporal and spatial resolutions of different datasets. The data sync component 714 may receive corrected data from the data correction component 712 and perform operations such as temporal interpolation or spatiotemporal resolution adjustments. For example, if multispectral imagery is updated daily and SAR imagery every 12 days, the data sync component 714 may apply temporal interpolation techniques to generate consistent, time-aligned data layers.

In some implementations, the data sync component 714 may handle the harmonization of meteorological inputs. Weather data may be provided on a grid with a different spatial resolution than satellite imagery. To reconcile this, the data sync component 714 may perform spatiotemporal resolution adjustments, using methods like bilinear or bicubic interpolation to downscale weather parameters onto a higher-resolution grid. This alignment provides a mechanism by which weather variables such as wind speed and relative humidity are mapped to each fuel parcel, facilitating more accurate fire potential index calculations. The output of the data sync component 714 may be provided to the data fusion component 716.

The data fusion component 716 may be configured to combine the corrected and synchronized datasets from multiple sources into a single, fused multimodal dataset. The data fusion component 716 may receive synchronized data from the data sync component 714 and perform a data fusion process to generate more consistent, accurate, and useful information than that provided by any individual data source. The resulting fused multimodal dataset may be provided as pre-processed data 730 to the semantic infrastructure engine 704.

In some implementations, the data fusion process performed by the data fusion component 716 may be facilitated by a VLM or another specialized AI agent, which can generate a semantic interpretation of the combined data. The resulting dataset synthesizes information from all sources into a cohesive data structure. This fused multimodal dataset may serve as the foundational input for generating fuel maps and determining a fire potential index.

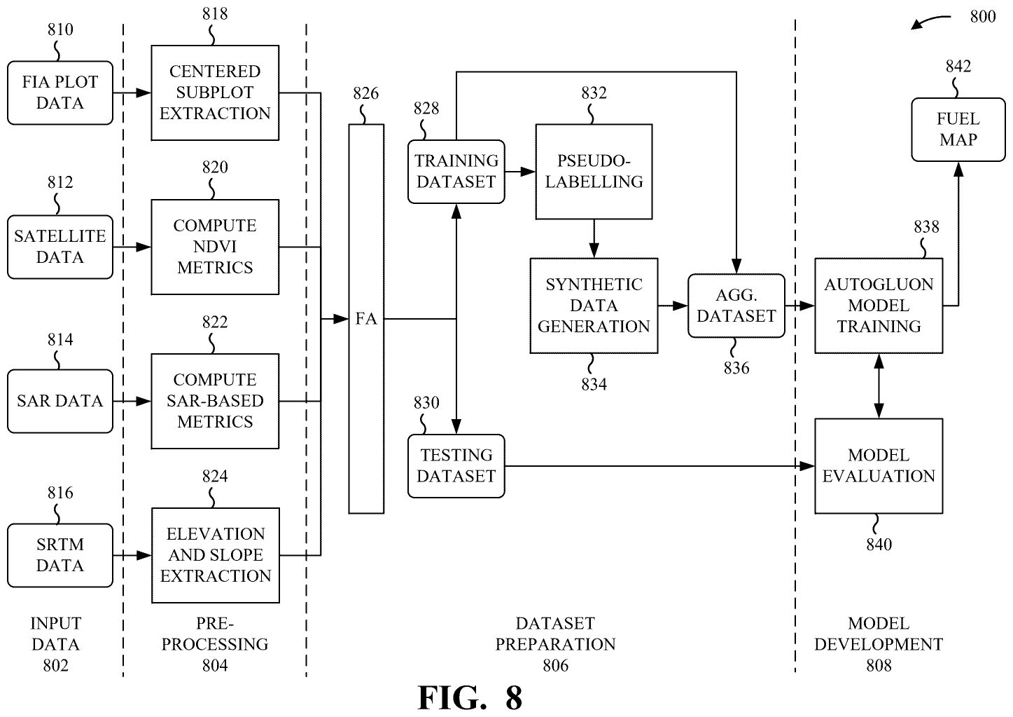

FIG. 8 is a data flow diagram of an example associated with generating fuel maps in an AI system for dynamic fire risk management from heterogeneous multimodal inputs. The process flow 800 includes an input data stage 802, a pre-processing stage 804, a dataset preparation stage 806, and a model development stage 808. The process flow 800 illustrates a comprehensive methodology for creating a fuel map 842, which is a critical component for predicting wildfire risk.

The input data stage 802 represents the ingestion of various raw data sources that serve as the foundational inputs for the fuel map generation process. This stage may include acquiring FIA plot data 810, which may provide ground-truth information about forest and vegetation characteristics. The input data stage 802 may also include acquiring satellite data 812, which may comprise multispectral imagery from sources like Landsat 8. Additionally, SAR data 814, such as from Sentinel-1 or NISAR, may be acquired to provide information about fuel moisture and surface structure. SRTM data 816 may be acquired to provide a digital elevation model for topographical analysis.

The pre-processing stage 804 involves a series of operations to clean, transform, and prepare the raw data from the input data stage 802 into a structured format suitable for machine-learning analysis. The pre-processing stage 804 may include a centered subplot extraction operation 818, which may process the FIA plot data 810 to isolate specific areas of interest for analysis. This operation may be configured to align ground-truth vegetation data, derived from the FIA plot data 810, with corresponding pixels from remote sensing inputs such as the satellite data 812. The FIA plot data 810 provides detailed, field-verified measurements of forest characteristics, such as species, diameter, and height, collected within a plot of a specific radius. The centered subplot extraction operation 818 may identify geographic coordinates of a center of each FIA plot and extract a subplot of pixels from the raster-based satellite and SAR datasets that is centered on the coordinate.

The dimensions of the extracted subplot may be selected to correspond to the spatial resolution of the remote sensing data and a size of the FIA plot. For example, if the remote sensing data has a 30-meter resolution and the FIA plot has a certain radius, the operation may extract a 3×3 or 5×5 pixel window centered on the plot's location. This spatial alignment may create a link between field-verified vegetation characteristics and spectral or radar backscatter values captured by the remote sensing instruments. The output of the centered subplot extraction operation 818 may be a set of spatially correlated data pairs, where each pair links a specific ground-truth label from an FIA plot to a corresponding set of pixel values from remote sensing imagery. This paired data may become a component of the training dataset 828, providing the machine-learning model with labeled examples of how different vegetation and fuel types appear in the satellite and SAR data. By isolating these specific, verified data points, the operation may provide a ground-truthed foundation for training a model configured to classify fuel types across a broader geographic region.

As shown, the pre-processing stage 804 may include computing an NDVI or a plurality of NDVI metrics at an operation 820. NDVI is a metric that quantifies the normalized difference in the health and density of vegetation. It is calculated from multispectral satellite imagery, which captures light reflectance in various spectral bands. The formula for NDVI is (NIR−Red)/(NIR+Red), where NIR represents the reflectance in the near-infrared band and Red represents the reflectance in the red band of the electromagnetic spectrum. Healthy, photosynthetically active vegetation strongly absorbs red light and reflects near-infrared light, resulting in high NDVI values, typically ranging from 0.2 to 1.0. Conversely, sparse vegetation, stressed or unhealthy plants, or non-vegetated surfaces like soil and water exhibit lower NDVI values, often close to zero or negative.

In wildfire risk assessment, computing seasonal NDVI metrics may be useful for characterizing fuel conditions over time. By analyzing satellite imagery captured at different times of the year, a system may track changes in vegetation greenness and moisture content. For instance, a decrease in NDVI values from one season to a subsequent season may indicate that vegetation is drying out, a process which increases its flammability. This temporal analysis provides a dynamic view of fuel moisture, which may be used to identify areas where vegetation is becoming more susceptible to ignition and fire spread.

A system may calculate a plurality of NDVI-derived metrics to create a more comprehensive view of vegetation status. This may include generating a time-series of NDVI for specific regions to identify long-term trends or anomalies. Other related indices, such as the Enhanced Vegetation Index (EVI), which may be more sensitive in areas with high biomass, or moisture-related indices like the Normalized Difference Water Index (NDWI), may be computed. These metrics, when combined, may furnish a detailed and quantitative assessment of vegetation health, density, and moisture, which are foundational inputs for both fuel map generation and subsequent determination of the FPI.

In the pre-processing stage 804, a compute SAR-based metrics operation 822 may be performed on the SAR data 814 to extract features related to fuel moisture and vegetation structure. SAR is a remote sensing technology that transmits microwave signals towards a surface and measures a backscattered signal to create imagery. SAR may operate under various weather conditions, for monitoring of vegetation and surface characteristics. In the context of wildfire risk assessment, SAR data provides insights into fuel moisture content and the physical structure of vegetation, both of which are factors in fire ignition and propagation. The computation of SAR-based metrics may involve processing the SAR data 814 to extract quantitative values that correlate with biophysical properties.

The process for computing SAR-based metrics may begin with a series of pre-processing steps applied to the SAR data 814. These steps may include radiometric calibration to convert digital number values into a standardized backscatter coefficient, speckle filtering to reduce granular noise in SAR imagery, and geometric correction to align the SAR data 814 with a map projection. A backscatter intensity metric may be derived, which is sensitive to surface roughness, dielectric properties related to moisture, and a geometric structure of vegetation. A decrease in a backscatter signal over a vegetated area may indicate a reduction in moisture content, as drier vegetation has a lower dielectric constant, causing less of a radar signal to be reflected back to a sensor.

Metrics may be calculated by analyzing a polarization of a SAR signal. SAR systems may transmit and receive signals in different polarizations, such as horizontal or vertical, resulting in co-polarized and cross-polarized channels. A ratio of cross-polarized to co-polarized backscatter may be used for characterizing vegetation structure, as it is sensitive to volume scattering from complex canopies. Changes in this ratio over time may indicate shifts in vegetation density or biomass. By computing these metrics, the system may generate features that furnish a quantitative characterization of fuel conditions, complementing information derived from optical sensors.

An elevation and slope extraction operation 824 may be performed on the SRTM data 816 to derive topographical features. The extraction operation may be configured to extract topographical features from the SRTM data 816, which is a Digital Elevation Model (DEM). The extraction process may involve computer-implemented analysis of the DEM to derive two metrics: elevation and slope. Elevation data provides the altitude for each point on the map, which influences local weather patterns and vegetation types. Slope, which is a measure of the steepness or gradient of the terrain, is calculated from the elevation data by determining the rate of change in elevation between adjacent cells in the DEM.

Slope is a factor in fire spread dynamics. A fire may travel more rapidly uphill because flames may preheat fuel above them through convection and radiation, which may facilitate fuel ignition. A steeper slope may result in more efficient preheating and a faster rate of fire spread. The extracted slope data provides a quantitative measure of this topographical influence, which may be used as a feature in the machine-learning model to predict fire risk. For instance, areas with steep, upward-facing slopes in a direction of prevailing winds may be identified as having a higher fire potential.

The extracted elevation and slope data may be formatted as numerical features and integrated with other pre-processed metrics from operations 820 and 822. This process may create a feature set that characterizes fuel conditions and the terrain on which fuels are located. By incorporating these topographical features, the system may improve an accuracy of the fuel map and a subsequent fire potential index, as the model may account for how landscape geometry influences fire behavior. This integrated approach provides a mechanism by which the model may be sensitive to combined effects of fuel, moisture, and terrain, which together govern a potential for fire ignition and propagation.

The outputs from these various pre-processing operations may be processed by a feature aggregation operation 826, which may transform the features into a standardized format that is agnostic to the data source and compatible with the feature vector format required by the ML-based models used in the model development stage 808.

The dataset preparation stage 806 involves structuring the aggregated features into datasets for training and evaluating a machine-learning model. The features are partitioned into a training dataset 828 and a testing dataset 830. The training dataset 828 is used to train the machine-learning model, while the testing dataset 830 is reserved for evaluating the model's performance on unseen data. The partitioning may be a practice in machine learning configured to facilitate an unbiased evaluation of the model's performance. The training dataset 828 is a subset of the aggregated features used to fit or train the parameters of the machine-learning model. During the training process, the model may identify patterns, correlations, and relationships between the input features (e.g., NDVI metrics, SAR metrics, elevation, and slope) and the corresponding ground-truth labels, which may be derived from the FIA plot data 810. The model may generalize from these examples to make predictions on new, unseen data.

In some implementations, the testing dataset 830 is a separate, held-out subset of the aggregated features that the model does not access during the training phase. The purpose of the testing dataset 830 may be to provide an objective assessment of the trained model's predictive capabilities. After the model has been trained on the training dataset 828, the model's performance may be evaluated by making predictions on the testing dataset 830 and comparing these predictions to known ground-truth labels. This process may yield performance metrics such as accuracy, precision, and recall, which may indicate how well the model is likely to perform in an operational setting.

The separation of data into training and testing sets may be a step in preventing overfitting. Overfitting may occur when a model learns the training data too well, including its noise and random fluctuations, to an extent that it fails to generalize to new data. By evaluating the model on the distinct testing dataset 830, a reliable estimate of its generalization performance may be obtained. A split ratio for this partitioning may be 80% of the data for the training dataset 828 and 20% for the testing dataset 830, although other ratios may be used depending on the size of the overall dataset and the specifics of the modeling task.

To enhance the robustness and accuracy of the model, the training dataset 828 may undergo augmentation. In some implementations, a pseudo-labeling operation 832 may be applied to the training dataset 828 to generate additional labeled examples. The pseudo-labeling operation 832 is a semi-supervised learning technique configured to augment the training dataset 828 with high-confidence, model-generated labels. The process may begin by training an initial machine-learning model, such as a preliminary version of the Gluon model, exclusively on the human-labeled training dataset 828. This initial model is then used to make predictions on a separate pool of unlabeled data, which may consist of remote sensing imagery that has been pre-processed but lacks corresponding ground-truth FIA plot data.

From these predictions, the pseudo-labeling operation 832 may identify a subset of the unlabeled data for which the model's predictions exceed a predetermined confidence threshold. For example, if the model predicts a specific fuel type for a given pixel with a confidence score of 95% or higher, that prediction is treated as a “pseudo-label.” This high-confidence data point, now consisting of the input features and the machine-generated label, is then added to the original training dataset 828. This process expands the labeled dataset without requiring additional manual annotation.

The newly augmented training dataset, now including both the original human-verified labels and the high-confidence pseudo-labels, is then used to retrain the machine-learning model from scratch or to continue its training. This iterative process may be repeated multiple times, with the model becoming progressively more accurate as it is exposed to a larger and more diverse set of labeled examples. By leveraging the model's own predictions to create new training samples, the pseudo-labeling operation 832 provides a mechanism by which the system may improve its ability to generalize and make more accurate fuel-type classifications for underrepresented fuel classes or in geographic regions where labeled data is sparse.

A synthetic data generation operation 834 may be performed to create artificial data points that expand the diversity of the training data. The synthetic data generation operation 834 may be a computer-implemented process configured to artificially create new data samples that mimic statistical properties of the original training dataset 828. This technique may be valuable for addressing class imbalance, where certain fuel types are underrepresented in ground-truth data, and for augmenting the dataset to improve generalization capabilities of a machine-learning model. By generating synthetic examples, the operation expands a diversity of training data, providing the model with a richer set of examples from which to learn underlying patterns that differentiate various fuel characteristics.

In some implementations, the synthetic data generation operation 834 may employ generative models, such as Conditional Generative Adversarial Networks (CTGAN) or variational autoencoders (VAEs). For example, a CTGAN may be trained on an existing feature set, including NDVI metrics, SAR-based metrics, elevation, and slope, conditioned on corresponding fuel type labels from the FIA plot data 810. Once trained, a generator component of the CTGAN may produce new, realistic feature vectors for specific, underrepresented fuel classes. This process provides a mechanism by which a model may be trained on a more balanced and comprehensive dataset, which may improve its predictive accuracy for minority classes.

The synthetic data produced by the synthetic data generation operation 834 may represent novel, plausible variations. For instance, the generative model may learn correlations between certain NDVI values and specific slope conditions for a particular vegetation type and then generate new samples that slightly vary these parameters within a realistic range. The output of this operation is a new dataset of synthetic samples that, when combined with the original training data and the pseudo-labeled data, contributes to a more robust and diverse aggregated dataset 836 for training the Gluon model.

The original training dataset 828, along with the outputs from the pseudo-labeling operation 832 and the synthetic data generation operation 834, may be combined to create an aggregated dataset 836, which may be used to train a machine learning model.

The model development stage 808 involves training and evaluating a machine-learning model to generate the final fuel map 842. A Gluon model training operation 838 may be performed, where a machine-learning model, such as one implemented within an automated machine-learning framework, is trained on the aggregated dataset 836. This operation may produce a trained model capable of classifying fuel types and characteristics based on the input features. The Gluon model training operation 838 leverages an automated machine learning (AutoML) framework to streamline development of a high-performing model for fuel type classification. AutoML automates tasks such as model selection, hyperparameter tuning, and ensembling. During this operation, the aggregated dataset 836, which includes original, pseudo-labeled, and synthetic data, is provided as input. The framework then systematically trains and evaluates a portfolio of machine-learning models, including, but not limited to, deep neural networks, gradient-boosted decision trees, and random forests, without requiring manual configuration for each model type.

A technical aspect of this operation is a multi-layer stacking ensemble methodology. Multiple models are trained and their predictions are combined through a stacking process. In a base layer, a variety of models are trained directly on the aggregated dataset 836. The predictions from these base models are then used as input features to train a higher-level “stacker” or meta-model. This hierarchical approach may provide a mechanism by which the system may capture a range of patterns and relationships within the data, which may result in a more robust and accurate final ensemble model than a single model.

The operation 838 is configured to handle the multimodal nature of the feature set, which includes spectral data from NDVI metrics, structural information from SAR-based metrics, and topographical features like elevation and slope. The framework automatically preprocesses these heterogeneous features and applies appropriate data transformations, providing a mechanism by which the different data types may be effectively utilized by the models within its training portfolio. The output of this operation is an optimized, trained ensemble model that is capable of classifying fuel types with high accuracy when provided with new, unseen remote sensing and topographical data.

Following the training, a model evaluation operation 840 is performed to assess the performance of the trained model. This evaluation may involve using the testing dataset 830 to measure the model's accuracy, precision, and other relevant performance metrics. Based on the validated and trained model, the fuel map 842 may be generated. The fuel map 842 may be a high-resolution characterization of the combustible materials within a geographic area, identifying various vegetation types and their corresponding fuel loads, which can then be used by other components of the fire risk management system.

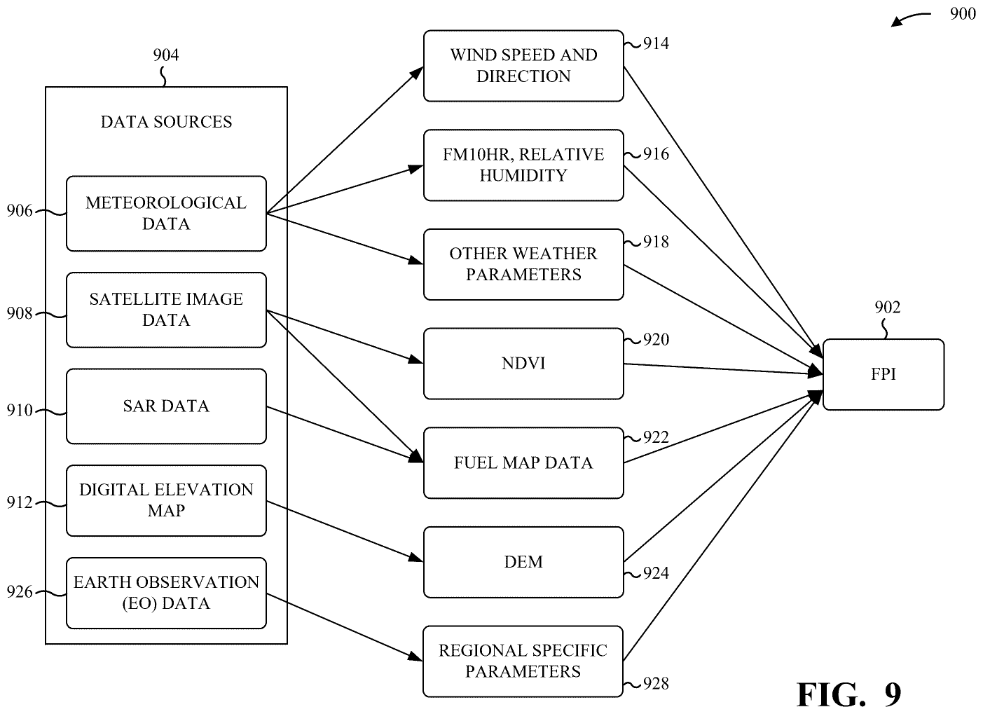

FIG. 9 is a schematic diagram 900 of an example associated with generating a fire prediction index 902. The diagram illustrates how a fire potential index 902 is derived by integrating inputs from multiple data sources 904. The data sources 904 include meteorological data 906, satellite image data 908, SAR data 910, and a digital elevation map 912. The raw data from these sources may be processed to extract a plurality of features, which are then synthesized to determine the fire potential index 902.

The fire potential index 902, as shown in the diagram, is a metric determined based on a synthesis of several key variables that influence fire behavior. The calculation of the fire potential index 902 may be performed by an FPI engine, such as the FPI engine 426 shown in FIG. 4. This index may be a numerical score or a categorized risk level, providing an indication of the likelihood and potential severity of a fire event. For example, the fire potential index 902 may be represented as a percentage or categorized into levels such as Low, Moderate, High, or Extreme. The determination of the fire potential index 902 may involve generating hourly predictions for a forecast horizon of at least 48 hours, providing a forward-looking assessment of fire risk.

The data sources 904 represent the heterogeneous, multimodal inputs that are ingested by the fire risk management system. These data sources 904 may be, be similar to, include, or be included in the data source 106 and the data source 108 shown in FIG. 1, or the data source 304 shown in FIG. 3. For example, the data sources 904 may include real-time feeds from meteorological agencies, public archives of satellite imagery from government organizations like NASA, or proprietary data from commercial providers. The variety of these data sources 904 underscores the multimodal nature of the system, which is configured to fuse data with different formats, resolutions, and update frequencies.

The meteorological data 906 is a component of the input data. The meteorological data 906 may be obtained from various real-time and forecast sources, such as a HRRR model. This data provides updated values for atmospheric parameters that influence fire ignition and spread. As shown in FIG. 9, the meteorological data 906 is used to derive features such as wind speed and direction 914, FM10HR, FM100HR, and relative humidity 916, and other weather parameters 918. These parameters provide a dynamic view of the weather conditions that affect fire behavior.

The satellite image data 908 represents another input from the data sources 904. This data may be multispectral imagery from satellites like Landsat 8. The satellite image data 908 may be used to assess vegetation health, density, and moisture content over large geographic areas. As shown in the diagram, the satellite image data 908 is a primary source for calculating an NDVI 920 and for generating fuel map data 922. The satellite image data 908 provides a spatial context for vegetation conditions, which is foundational for understanding a fuel landscape.

The SAR data 910 is a type of remote sensing data that provides information about surface structure and moisture content. The SAR data 910 may be obtained from satellites such as Sentinel-1 or a NISAR mission. Unlike optical satellite imagery, SAR may operate under various weather conditions, providing a reliable source of information. As shown in FIG. 9, the SAR data 910, in conjunction with the satellite image data 908, is used to generate the fuel map data 922. The SAR data 910 may be useful for estimating fuel moisture in different types of vegetation.

The digital elevation map 912 provides topographical information for the geographic region. This data may be obtained from sources such as an SRTM. The digital elevation map 912 is used to derive a DEM 924, which includes features like elevation and slope. Topography is a factor in fire behavior, as fires tend to spread more rapidly uphill. The digital elevation map 912 provides the terrain context for a fire risk assessment.

As shown in FIG. 9, a plurality of specific features are extracted from the raw data sources to serve as direct inputs for calculating the fire potential index 902. The wind speed and direction 914 are derived from the meteorological data 906 and are used for predicting the rate and direction of fire spread. Strong winds may accelerate fire propagation and carry embers over long distances. The FM100HR, FM10HR and relative humidity 916 are derived from the meteorological data 906 and provide measures of moisture content in dead fuels and the air, respectively. Low values for these parameters indicate dry conditions that are conducive to fire ignition and spread. Other weather parameters 918, such as temperature, may be derived from the meteorological data 906 and incorporated into the calculation of the fire potential index 902.

The NDVI 920 is a metric calculated from the satellite image data 908 that quantifies the health and density of vegetation. The NDVI 920 may be used to assess fuel conditions, as lower NDVI values may indicate stressed or dry vegetation that is more flammable. The fuel map data 922 is generated from a combination of the satellite image data 908 and the SAR data 910. The fuel map data 922 provides a detailed characterization of the combustible materials in the geographic area, including vegetation types and their corresponding fuel loads. The DEM 924 is derived from the digital elevation map 912 and provides topographical features such as elevation and slope, which influence fire behavior.

As further illustrated in FIG. 9, the data sources 904 additionally include Earth Observation (EO) data 926 and regional specific parameters 928. The EO data 926 may include satellite-based Earth observation datasets that provide optical and/or radar measurements of the geographic area, and may be used by the system to derive or refine region-adapted inputs. The regional specific parameters 928 may include localized inputs tailored to a particular geographic region (e.g., parameters informed by localized historical fire patterns and fuel conditions) that condition the generation of the fire potential index 902. The EO data 926 may be processed to generate, update, or calibrate the regional specific parameters 928. By integrating these diverse features, the system may determine a comprehensive and accurate fire potential index 902.

FIG. 10 is a block diagram of an example of an AI chat agent-based system for dynamic fire risk management from heterogeneous multimodal inputs. The AI chat agent-based system 1000 includes an AI chat agent 1002 and a client 1004. These components may be communicatively coupled to facilitate dynamic fire risk management and decision support through a conversational interface.

The AI chat agent-based system 1000 may represent an operating environment for an implementation of a fire risk management system focused on user interaction through natural language. The AI chat agent-based system 1000 may be configured to provide a comprehensive, interactive platform where users may query for fire risk information, receive analytical insights, and initiate complex tasks such as simulations. The AI chat agent-based system 1000 may be configured to encapsulate the components that provide a mechanism by which a user may engage in a dialogue with an advanced AI system to obtain actionable wildfire intelligence. The AI chat agent-based system 1000 may be, be similar to, include, or be included in the operating environment 100 shown in FIG. 1.

In some implementations, the AI chat agent-based system 1000 may be deployed in a cloud computing environment, where the AI chat agent 1002 resides on server infrastructure, and the client 1004 communicates with this infrastructure over a network. For example, the AI chat agent-based system 1000 may be hosted on a platform like Amazon Web Services (AWS) or Google Cloud Platform (GCP), leveraging scalable computing resources for processing and model execution. This configuration facilitates access for a plurality of concurrent users from various geographic locations.

In some implementations, components of the AI chat agent-based system 1000 may be distributed. For example, a portion of the AI chat agent 1002's logic may be executed on an edge computing device to reduce latency for certain tasks, while the processing and simulation remain centralized. The architecture of the AI chat agent-based system 1000 may be designed to be modular, providing a mechanism by which new tools, models, or data sources may be integrated without requiring a complete redesign of the system.

The AI chat agent 1002 may be configured to process user queries, orchestrate backend tasks, and generate responses. The AI chat agent 1002 may be implemented as a software system that integrates various AI technologies, including natural language processing, machine learning, and computer vision. The function of the AI chat agent 1002 may be to serve as an intelligent and automated intermediary between the user of the client 1004, and the analytical capabilities of the system. The AI chat agent 1002 may interact with the client 1004 to receive queries and send responses. The AI chat agent 1002 may be, be similar to, include, or be included in the AI component 122 shown in FIG. 1, the AI agent network 312 shown in FIG. 3, or the ML component 604 shown in FIG. 6.

The AI chat agent 1002 may be configured to function as a conversational AI component, which is configured to receive a natural language query from a user and generate a responsive textual briefing. For example, a user may ask, “What is the fire risk for Topanga State Park in the next 24 hours?” and the AI chat agent 1002 may process this query, retrieve the relevant FPI data, and synthesize a natural language response that includes a summary of the risk, contributing factors, and a corresponding map visualization. In some implementations, the AI chat agent 1002 is part of a multi-agent framework, and may orchestrate a plurality of specialized AI agents within the multi-agent framework to determine a fire potential index.

The AI chat agent 1002 may be configured to learn and adapt based on user interactions. For example, the AI chat agent 1002 may analyze the types of queries a user frequently makes to learn one or more user preferences. Based on these learned preferences, the AI chat agent 1002 may proactively generate a personalized alert that flags information related to the FPI or other risk factors relevant to the user's area of interest. This provides a mechanism by which the AI chat agent 1002 delivers more relevant and timely information over time.

In some implementations, the AI chat agent 1002 may provide an explainable AI mechanism configured to expose information about how an FPI or other determination was made. For instance, when providing a risk assessment, the AI chat agent 1002 may provide access to a traceable inference pathway or a structured agent communication log, providing a mechanism by which a user can understand the data and reasoning that led to the conclusion. This fosters trust and transparency in the system's outputs.

The client 1004 may be a software application that provides the user interface for interacting with the AI chat agent 1002. The client 1004 may be configured to run on a user's computing device, such as a desktop computer, tablet, or smartphone. The primary role of the client 1004 is to render the graphical user interface, including the chat interface, and to facilitate communication between the user and the AI chat agent 1002. The client 1004 may be communicatively coupled to the AI chat agent 1002. The client 1004 may be, be similar to, include, or be included in the client 124 shown in FIG. 1, the client 318 shown in FIG. 3, or the client application 610 shown in FIG. 6.

In some implementations, the client 1004 may be a web application accessed through a standard web browser. In this configuration, the client 1004 may be built using web technologies such as HTML5, CSS, and JavaScript frameworks, which provide an interactive user experience. The client 1004 may communicate with the AI chat agent 1002 using secure web protocols, such as HTTPS and WebSockets, to facilitate real-time, bidirectional communication for the chat interface.

The client 1004 may be configured to display a variety of information formats, including text, images, maps, and interactive charts. For example, when the AI chat agent 1002 generates a response that includes a map-based visualization of a recommended prescribed burn area, the client 1004 may render this map and provide tools for the user to pan, zoom, and query specific features on the map. The client 1004 may display a text-based rationale associated with the recommended prescribed burn area, providing a comprehensive response to the user's query.

In some implementations, the client 1004 may be a native mobile application designed for a specific operating system, such as iOS or Android. A native application may offer advantages such as improved performance, access to device hardware like GPS for location-based queries, and the ability to send push notifications for alerts generated by the AI chat agent 1002. The client 1004, whether web-based or native, serves as the primary gateway for users to access the analytical and predictive capabilities of the AI chat agent-based system 1000.

As shown in FIG. 10, the AI chat agent 1002 includes a data layer 1006, a processing layer 1008, a tool layer 1010, and a simulation engine 1012. In some implementations, two or more of the data layer 1006, the processing layer 1008, the tool layer 1010, and the simulation engine 1012 may be integrated into a single component. In some implementations, one or more of the data layer 1006, the processing layer 1008, the tool layer 1010, and the simulation engine 1012 may be implemented using any number of computing devices such as the computing device 200 shown in FIG. 2. For example, one or more of the data layer 1006, the processing layer 1008, the tool layer 1010, and the simulation engine 1012 may be distributed among a number of computing devices.

The data layer 1006 may be configured to manage the data and knowledge used by the AI chat agent 1002. The data layer 1006 may serve as the repository for both structured and unstructured information that the AI chat agent 1002 uses to understand queries and generate responses. The role of the data layer 1006 is to provide a persistent storage mechanism for the system's knowledge base. The data layer 1006 may provide data to the processing layer 1008. The data layer 1006 may be, be similar to, include, or be included in the data layer 116 shown in FIG. 1, the data layer 306 shown in FIG. 3, or the data layer 410 shown in FIG. 4.

In some implementations, the data layer 1006 may be built on a combination of different database technologies to handle the variety of data it stores. For example, it may use a graph database for a knowledge graph, a relational database for structured metadata, and a vector database for storing embeddings used in semantic search and retrieval-augmented generation. This hybrid architecture provides a mechanism by which the AI chat agent 1002 may efficiently access and reason over different types of information.

The data layer 1006 may be updated continually, periodically, or in response to a trigger event. For example, new research papers, field reports, or mitigation plans may be ingested and processed to keep the knowledge base current. This process may involve an information extraction pipeline that identifies entities and relationships from unstructured text and integrates them into the data layer 1006.

The processing layer 1008 may be configured to perform the reasoning and language processing tasks of the AI chat agent 1002. The processing layer 1008 may receive a user's natural language query and use its components to interpret the query, retrieve relevant information from the data layer 1006, and formulate a response. The function of the processing layer 1008 is to serve as the processing portion of the AI chat agent 1002, handling the AI operations. The processing layer 1008 receives input from the data layer 1006 and provides output to the tool layer 1010. The processing layer 1008 may be, be similar to, include, or be included in the processing layer 118 shown in FIG. 1 or the processing layer 308 shown in FIG. 3.

In some implementations, the processing layer 1008 may be configured to break down a user query into a series of sub-tasks. For example, a query like “Simulate a fire in the Santa Monica mountains with a 20 mph wind from the northeast and show me the impact on structures” may be decomposed into tasks such as: (1) identify the geographic coordinates for the Santa Monica mountains, (2) configure the simulation engine 1012 with the specified wind parameters, (3) execute the simulation, and (4) identify and visualize the impacted structures.

The processing layer 1008 may orchestrate the execution of these sub-tasks by interacting with the tool layer 1010.

The processing layer 1008 may be configured to provide a mechanism by which the system may maintain a conversational context. For example, the processing layer 1008 may use a short-term memory to remember previous turns in a conversation, which may facilitate users asking follow-up questions without having to repeat information. This facilitates a more efficient user interaction.

In some implementations, the processing layer 1008 is configured to generate the textual briefings provided to the user. After retrieving and synthesizing information, the processing layer 1008 may use a language generation model to compose a coherent, easy-to-understand response that directly addresses the user's query.

The tool layer 1010 may be configured to provide a set of specialized tools and functions that the processing layer 1008 can use to perform tasks and answer user queries. The tool layer 1010 may include components for data extraction, map generation, and computer vision analysis. The role of the tool layer 1010 is to provide the practical capabilities that the AI chat agent 1002 uses to interact with the underlying data and analytical engines. The tool layer 1010 receives input from the processing layer 1008. The tool layer 1010 may be, be similar to, include, or be included in the tool layer 120 shown in FIG. 1, the tool layer 310 shown in FIG. 3, or the tool layer 414 shown in FIG. 4.

The tool layer 1010 serves as an interface between the high-level reasoning of the processing layer 1008 and the specific data processing and analytical functions of the system. For example, when the processing layer 1008 is instructed to determine the current fire hazard for a location, it may call upon a tool within the tool layer 1010 to perform this calculation.

In some implementations, the tools within the tool layer 1010 may be exposed as a set of well-defined APIs that the processing layer 1008 can invoke. This modular design provides a mechanism by which new tools may be added to the system's capabilities without altering the logic of the processing layer 1008. For instance, a new tool for predicting post-fire debris flow could be added to the tool layer 1010 and become available for the AI chat agent 1002 to use.

The tool layer 1010 may handle interactions with external systems. For example, a tool could be configured to query an external weather service API for the latest forecast data or to access a public database of property records. This provides a mechanism by which the AI chat agent 1002 can incorporate up-to-the-minute, real-world information into its responses.

The simulation engine 1012 may be a specialized software component configured to execute a fire behavior simulation. The simulation engine 1012 may use various inputs, such as fuel map data, meteorological data, and topographical data, to predict the propagation characteristics of a fire. The role of the simulation engine 1012 is to provide a predictive modeling capability that may facilitate users exploring potential fire scenarios. The simulation engine 1012 may be communicatively coupled to the tool layer 1010 or the processing layer 1008, which may initiate simulations based on user requests. The simulation engine 1012 may be, be similar to, include, or be included in the simulation engine 430 shown in FIG. 4 or the simulation engine 514 shown in FIG. 5.

The simulation engine 1012 may be configured to predict at least one of a spread speed of an active wildfire or a spread direction of the active wildfire. For example, a user may ask the AI chat agent 1002 to simulate the spread of a fire from a specific ignition point. The processing layer 1008 may then instruct the simulation engine 1012 to run the simulation, and the results, such as a map showing the predicted fire perimeter over time, may be returned to the user via the client 1004. In some implementations, the AI chat agent 1002 may include a simulator coordination agent configured to facilitate the fire behavior simulation by managing the inputs and outputs for the simulation engine 1012.

In some implementations, the simulation engine 1012 may include different simulation models for different environments. For example, the simulation engine 1012 may use a Weather Research and Forecasting (WRF)-Fire model for wildland areas and a SWUIFT model for WUI areas. The SWUIFT model may be configured to simulate thermal radiation to quantify heat transfer effects on structures and to model fire spotting by simulating the generation, transport, and ignition of firebrands. This provides a more accurate prediction of fire behavior in complex urban environments.

The simulation engine 1012 may be implemented as a high-performance computing module, potentially leveraging GPUs to accelerate the calculations required for physics-based fire modeling. The simulation engine 1012 may be configured to run simulations faster than real-time, providing a mechanism by which stakeholders can quickly assess evolving fire situations and make timely decisions. The output of the simulation engine 1012 may be a time-series dataset representing the fire's progression, which can be visualized as an animation on the client 1004.

As shown in FIG. 10, the data layer 1006 includes a knowledge database 1014 and a solution database 1016. In some implementations, the knowledge database 1014 and the solution database 1016 may be integrated into a single component. For example, the knowledge database 1014 and the solution database 1016 may be part of a unified semantic data management system.

The knowledge database 1014 may be configured to store the structured and unstructured knowledge that the AI chat agent 1002 uses for reasoning. The knowledge database 1014 may be implemented as a knowledge graph, a relational database, or a combination of different storage technologies. The function of the knowledge database 1014 is to serve as the long-term memory of the system, containing factual information, relationships between entities, and learned insights. The knowledge database 1014 may be, be similar to, include, or be included in the knowledge graph 420 shown in FIG. 4 or the knowledge graph 708 shown in FIG. 7.

In some implementations, the knowledge database 1014 may be fine-tuned based on user feedback. For example, if a human expert corrects an assertion made by the AI chat agent 1002, this feedback may be used to update the corresponding information in the knowledge database 1014, providing a mechanism by which the system's accuracy improves over time. The knowledge database 1014 may be populated by processing a wide range of documents, including scientific papers, field manuals, and historical incident reports.

The solution database 1016 may be configured to store pre-computed solutions, templates for responses, or standardized procedures. The solution database 1016 may be used by the AI chat agent 1002 to quickly retrieve answers to common questions or to structure its responses in a consistent manner. For example, the solution database 1016 may contain templates for generating a daily fire risk briefing for a specific region. When a user requests such a briefing, the AI chat agent 1002 may retrieve the template from the solution database 1016 and populate it with the latest data.

In some implementations, the solution database 1016 may store the results of frequently run simulations or analyses. This caching mechanism may reduce the time it takes to respond to queries that involve computationally intensive tasks. For example, if multiple users ask for a fire spread simulation with the same parameters, the result may be retrieved from the solution database 1016 after the first execution, rather than re-running the simulation each time.

As shown in FIG. 10, the processing layer 1008 includes an MLLM 1018, a reasoning engine 1020, and an AI agent 1022. In some implementations, two or more of the MLLM 1018, the reasoning engine 1020, and the AI agent 1022 may be integrated into a single component. For example, the reasoning engine 1020 may be an integral part of the MLLM 1018.

The MLLM 1018 may be a multi-modal large language model that serves as a part of the processing layer 1008. The MLLM 1018 may be configured to understand and process information from multiple modalities, including text, images, and structured data. The role of the MLLM 1018 is to interpret the user's natural language query and to orchestrate the other components of the processing layer 1008 and the tool layer 1010 to generate a response. In some implementations, the MLLM 1018 may be used to orchestrate a plurality of specialized AI agents within a multi-agent framework. The MLLM 1018 may be based on a foundational model, such as Llama or a similar architecture, which has been fine-tuned for the specific domain of wildfire risk management.

The reasoning engine 1020 may be a component configured to perform logical inference and reasoning tasks. The reasoning engine 1020 may work in conjunction with the MLLM 1018 to analyze information, draw conclusions, and plan the steps needed to answer a user's query. For example, the reasoning engine 1020 may use information from the knowledge database 1014 to infer the potential impact of a predicted fire on infrastructure. In some implementations, the reasoning engine 1020 may be implemented using a combination of symbolic reasoning techniques and neural network-based approaches.

The AI agent 1022 may represent a specialized AI agent within the processing layer 1008. The AI agent 1022 may be configured to perform a specific task or a set of related tasks. For example, the AI agent 1022 could be a query planning agent that determines the sequence of tool calls used in the AI chat agent-based system 1000 to answer a query. In a multi-agent framework, the MLLM 1018 may coordinate the activities of multiple specialized AI agents like the AI agent 1022 to handle a user's request. The AI agent 1022 may be, be similar to, include, or be included in one of the specialized AI agents described in connection with the claims of the present disclosure.

As shown in FIG. 10, the tool layer 1010 includes a data extractor 1024, a fire hazard map engine 1026, and a computer vision backbone 1028. In some implementations, two or more of the data extractor 1024, the fire hazard map engine 1026, and the computer vision backbone 1028 may be integrated into a single component. For example, the fire hazard map engine 1026 may be part of a broader risk assessment module that includes other analytical tools.

The data extractor 1024 may be a tool configured to retrieve specific pieces of information from the data layer 1006 or external data sources. The data extractor 1024 may be called by the processing layer 1008 when it needs to access raw data to answer a query. For example, the data extractor 1024 may be used to retrieve the latest wind speed and direction data for a specific geographic location. In some implementations, the data extractor 1024 may be configured to parse different data formats and handle various data access protocols.

The fire hazard map engine 1026 may be a tool configured to generate a fire hazard map for a given geographic area. The fire hazard map engine 1026 may be a specialized implementation of an FPI engine, such as the FPI engine 426 shown in FIG. 4. The fire hazard map engine 1026 may combine fuel map data, meteorological data, and topographical data to create a map that visually represents the level of fire risk. The fire hazard map engine 1026 may be used to generate a map-based visualization of a recommended prescribed burn area in response to a user query. In some implementations, the output of the fire hazard map engine 1026 may be a color-coded risk map indicating a plurality of different levels associated with an FPI.

The computer vision backbone 1028 may be a foundational component that provides a set of computer vision capabilities used by other tools. The computer vision backbone 1028 may include pre-trained models and algorithms for tasks such as object detection, image segmentation, and feature extraction. The role of the computer vision backbone 1028 is to provide a shared, efficient platform for all image and video analysis tasks within the AI chat agent 1002.

As shown in FIG. 10, the computer vision backbone 1028 includes an infrastructure data extractor 1030, a super resolution engine 1032, and a scene classifier 1034. In some implementations, two or more of the infrastructure data extractor 1030, the super resolution engine 1032, and the scene classifier 1034 may be integrated into a single component. For example, the infrastructure data extractor 1030 and the scene classifier 1034 may be part of a unified scene understanding module.

The infrastructure data extractor 1030 may be a specialized computer vision tool configured to identify and extract information about infrastructure from imagery. For example, the infrastructure data extractor 1030 may be used to detect utility poles, power lines, and other infrastructure in street-level or aerial imagery. This information may be used to assess the vulnerability of infrastructure to a potential fire.

The super resolution engine 1032 may be a tool configured to enhance the resolution of images. The super resolution engine 1032 may use deep learning techniques to generate a high-resolution image from a lower-resolution input. This may be useful for analyzing satellite or aerial imagery where the original resolution is not sufficient to identify fine-scale features relevant to fire risk.

The scene classifier 1034 may be a tool configured to classify the overall context or scene of an image. For example, the scene classifier 1034 may be used to automatically determine whether an image depicts a dense urban area, a WUI region, or a remote wildland area. This classification may be used to select the appropriate fire models or analytical techniques for a given location.

FIGS. 11A-11H are examples of a graphical user interface (GUI) provided by an AI system for dynamic fire risk management from heterogeneous multimodal inputs. These figures illustrate various views and functionalities of a client application, such as the client 124 shown in FIG. 1 or the client 318 shown in FIG. 3, which may be configured to display output data indicative of a fire potential index and facilitate user interaction with a fire risk management system. The GUI may be rendered by a computing device, such as the user device 104, and may include interactive maps, data selection panels, report generation tools, and simulation controls.

FIG. 11A is an example of a GUI 1100 configured to present a dynamic fire prediction index forecast. The GUI 1100 includes a map display area 1102 for displaying a map 1104, a fire indices options panel 1106, a weather options panel 1108, an other options panel 1110, an infrastructure options panel 1112, a selection tool panel 1114, a search field 1116, and a chat interface button 1120. The GUI 1100 may be, be similar to, include, or be included in the UI 126 shown in FIG. 1.

The map display area of the GUI 1100 may be a central component of the GUI 1100 configured to display geospatial data, such as a map of a geographic region. The map display area 1102 may be configured to render various data layers, including a base map and one or more overlay layers that present fire risk information. The map display area 1102 may provide a visual representation of the fire potential index and other relevant data, providing a mechanism by which a user may understand the spatial distribution of fire risk. The map display area 1102 may receive data from a visualization engine, such as the visualization engine 314 shown in FIG. 3, which generates the visual data based on outputs from a processing layer, such as the processing layer 118 shown in FIG. 1.

In some implementations, the map display area 1102 may be an interactive component that supports user interactions such as panning, zooming, and selecting specific points or areas on the map. For example, a user may use a mouse or a touchscreen to navigate to a different part of the geographic region or to zoom in for a more detailed view. The map display area 1102 may be configured to request updated data from a server, such as the server 316 shown in FIG. 3, in response to these interactions, providing a mechanism by which the displayed information is dynamically updated based on the user's focus.

In the example shown in FIG. 11A, the map display area is displaying a color-coded risk map indicating a plurality of different levels associated with the fire potential index. The map shows fire potential index categories for a specific date and time, “20250106_0200,” indicating a snapshot of the fire risk at that moment. The colors on the map correspond to the categories defined in the map legend (shown in the lower right portion of the map), providing a quick and intuitive visual assessment of the risk levels across the displayed geographic region.

The map display area 1102 may be configured to display various other data layers selected by the user via the fire indices options panel 1106. For example, the map display area 1102 may overlay fuel map data, NDVI data, or the locations of utility infrastructure on top of the base map. This provides a mechanism by which a user may analyze the relationships between different factors that contribute to fire risk. The map display area 1102 may also be configured to render an animated visualization that displays a temporal sequence of a series of predictions across a forecast horizon, providing a dynamic view of how the fire potential index is expected to change over time.

The map legend may be a component of the GUI 1100 that provides an explanation of the symbols, colors, and patterns used in the map display area 1102. The map legend may be dynamically updated to reflect the data layer that is currently being displayed in the map display area 1102. As shown in FIG. 11A, the map legend explains the color coding for the fire potential index categories. The map legend indicates that different colors represent different risk levels, such as “Low (0-24%),” “Moderate (25-49%),” “High (50-74%),” and “Extreme (75-100%).” This provides a clear and standardized way for users to understand the severity of the fire risk depicted in the map display area 1102. The map legend may include a statistical summary of the risk distribution within the current map view, such as “Low: 0.9%, Moderate: 98.8%, High: 0.0%, Extreme: 0.0%.”

In some implementations, the map legend may be an interactive component. For example, a user may be able to click on a category in the map legend to highlight all areas on the map that fall within that category. In some implementations, the map legend may be configurable, providing a mechanism by which users may customize the color scheme or the threshold values for the different risk categories based on their specific operational needs or organizational standards. The map legend provides a mechanism by which the system may present complex data in a readily understandable format.

The fire indices options panel 1106 may be a component of the GUI 1100 that provides a set of controls for selecting different data layers and indices to be displayed in the map display area 1102. The fire indices options panel 1106 may be organized into different categories, such as “Fire Indices,” to facilitate navigation. The function of the fire indices options panel 1106 is to provide a mechanism by which a user may customize the information presented in the GUI 1100 to suit specific analytical needs. When a user selects an option in the fire indices options panel 1106, a request may be sent to a server, such as the server 316 shown in FIG. 3, to retrieve the corresponding data for display.

In the example shown in FIG. 11A, the fire indices options panel 1106 includes several selectable options under the “Fire Indices” category, such as “Fire Potential Index,” “Fuel Map,” “Dead Fuel Extinction,” “NDVI,” and “Relative Greenness.” Each of these options may correspond to a different data layer that can be overlaid on the map in the map display area 1102. For example, selecting the “Fuel Map” option may cause the system to display fuel map data generated by a fuel map engine, such as the fuel map engine 424 shown in FIG. 4.

In some implementations, the fire indices options panel 1106 may support the selection of multiple data layers simultaneously, providing a mechanism by which a user may visually compare different datasets. For example, a user could select both the “Fire Potential Index” and the “Utility Infrastructure” layers to see how high-risk fire zones align with the locations of infrastructure. The fire indices options panel 1106 may include controls for adjusting the transparency or visibility of each layer, giving the user fine-grained control over the map visualization. The fire indices options panel 1106 provides a mechanism by which the user may tailor the displayed information, which may facilitate a more focused and effective analysis of fire risk.

The weather options panel 1108 may be a sub-component of the options panel 1106 that provides controls specifically for selecting and displaying meteorological data. The weather options panel 1108 may include options for various weather parameters that are relevant to fire behavior. The role of the weather options panel 1108 is to provide a mechanism by which a user may investigate how different weather conditions are contributing to the overall fire risk. The data displayed when an option in the weather options panel 1108 is selected may be sourced from a meteorological data provider, such as the data source 108 shown in FIG. 1.

As shown in FIG. 11A, the weather options panel 1108 includes options for displaying “Wind Speed,” “Wind Direction,” “Relative Humidity,” and “Temperature.” Selecting one of these options may cause the map display area 1102 to show a spatial representation of that weather parameter. For example, selecting “Wind Speed” might overlay a color-coded layer indicating wind speeds across the geographic region, or it might display wind barbs showing both speed and direction, as illustrated in FIG. 11D.

In some implementations, the weather options panel 1108 may include controls for viewing forecast data. For example, a user might be able to use a time slider in conjunction with the weather options panel 1108 to see how wind speed and direction are predicted to change over the next 48 hours. This provides a mechanism by which a user may assess not only the current weather conditions but the anticipated changes that could impact fire behavior. The weather options panel 1108 provides a mechanism by which a user may explore the dynamic meteorological factors that influence the fire potential index.

The other options panel 1110 may be a sub-component of the options panel 1106 that provides access to additional, miscellaneous data layers that may be relevant for a comprehensive risk assessment. The other options panel 1110 may include datasets that are not directly related to fire indices or weather but may provide contextual information. The purpose of the other options panel 1110 is to provide a mechanism by which users may incorporate a broader range of environmental and geological factors into their analysis.

In the example shown in FIG. 11A, the other options panel 1110 includes options for “Fault Maps” and “Air Pollution Dataset.” Selecting “Fault Maps” could overlay geological fault lines on the map, which might be relevant for assessing secondary risks in the event of an earthquake or for understanding terrain features. Selecting “Air Pollution Dataset” could display data related to air quality, such as particulate matter concentrations, which could be used to monitor the public health impacts of smoke from a wildfire.

In some implementations, the other options panel 1110 may be extensible, providing a mechanism by which new and custom datasets can be added to the system. For example, a user organization could upload its own proprietary datasets, such as soil moisture sensor data or ecological survey data, and have them appear as selectable options in the other options panel 1110. This flexibility provides a mechanism by which the system may be adapted to the specific needs and data resources of different stakeholders, enhancing its utility as a comprehensive decision-support tool.

The infrastructure options panel 1112 may be a sub-component of the options panel 1106 that provides controls for displaying data related to human-built infrastructure. The infrastructure options panel 1112 may include options for various types of infrastructure that could be vulnerable to or play a role in wildfire events. The function of the infrastructure options panel 1112 is to provide a mechanism by which a user may assess the potential impact of a fire on assets and infrastructure. The data for these layers may be sourced from utility companies, government agencies, or generated by an infrastructure data extractor, such as the infrastructure data extractor 1030 shown in FIG. 10.

As shown in FIG. 11A, the infrastructure options panel 1112 includes options for “Roads,” “Utility Infrastructure,” and “Cables.” Selecting the “Roads” option may display the road network, which is relevant for planning evacuation routes and access for firefighting crews. Selecting “Utility Infrastructure” may display the locations of assets such as power lines, substations, and utility poles, providing a mechanism by which a utility company may identify assets that are in high-risk fire zones. Selecting “Cables” may provide a more detailed view of specific cable routes.

In some implementations, the infrastructure options panel 1112 may provide access to more detailed information about each infrastructure asset. For example, a user could click on a utility pole on the map to view its attributes, such as its material, age, and maintenance history. This detailed information may be used to perform a more granular assessment of structural vulnerability. The infrastructure options panel 1112 provides a mechanism by which the system may facilitate asset management and risk mitigation for utility companies and other infrastructure operators.

The selection tool panel 1114 may be a component of the GUI 1100 that provides tools for selecting specific points, areas, or features on the map. The selection tool panel 1114 may include various selection modes, such as a point selection tool, a polygon selection tool, or a freehand drawing tool. The role of the selection tool panel 1114 is to provide a mechanism by which a user may define a specific area of interest for more detailed analysis or for generating a report.

In the example shown in FIG. 11A, the selection tool panel 1114 includes several buttons for different selection modes. Once a user has made a selection, the system may perform a specific action, such as displaying detailed information for the selected area or generating a report, as shown in FIG. 11F and FIG. 11G. The selection made using the selection tool panel 1114 may be used to query the underlying data in the data layer, such as the data layer 116 shown in FIG. 1.

In some implementations, the selection tool panel 1114 may be integrated with other components of the GUI 1100. For example, after selecting a region with the selection tool panel 1114, a user could use the chat interface button 1120 to ask a natural language query specifically about that selected region. The selection tool panel 1114 provides a mechanism by which users may focus their analysis on specific areas for localized risk assessment and operational planning.

The search field 1116 may be a component of the GUI 1100 that provides a mechanism by which a user may search for specific locations or addresses. The search field 1116 may be a text input field where a user can type a place name, address, or geographic coordinates. The role of the search field 1116 is to provide a quick and easy way for users to navigate to a specific area of interest on the map. When a user enters a query in the search field 1116, a request may be sent to a geocoding service to find the corresponding location, and the map in the map display area may then be centered on that location.

In some implementations, the search field 1116 may support more advanced search queries. For example, a user could search for specific types of features, such as “all substations in San Bernardino County,” and the system could highlight these features on the map. The search field 1116 may be integrated with the knowledge graph, such as the knowledge graph 708 shown in FIG. 7, to facilitate semantic search capabilities.

In some implementations, the search field 1116 may provide an autocomplete feature, suggesting locations or features as the user types. This may improve the usability of the search functionality and help users to quickly find the information they are looking for. The search field 1116 provides a familiar and intuitive mechanism for map navigation and information retrieval, which may enhance the overall user experience of the GUI 1100.

The chat interface button 1120 may be a component of the GUI 1100 that provides access to a conversational AI component. When a user clicks on the chat interface button 1120, a chat window may open, furnishing a mechanism by which the user may interact with the fire risk management system using natural language. The role of the chat interface button 1120 is to provide a gateway to the advanced AI capabilities of the system, such as those provided by the AI chat agent 1002 shown in FIG. 10.

When the chat interface is active, a user may submit a natural language query, and the system may generate a responsive textual briefing. For example, a user could ask, “Generate a report on the vegetation hazard for the selected region,” and the system could provide a detailed summary of the vegetation types, fuel loads, and moisture levels in that area. This functionality may be facilitated by a multi-modal large language model, such as the MLLM 1018 shown in FIG. 10.

In some implementations, the conversational AI component may be able to perform actions on behalf of the user. For example, a user could ask the chat agent to “Show me all areas with an extreme fire potential index and high wind speeds,” and the system could automatically select the appropriate data layers and configure the map display to show this information. The chat interface button 1120 provides a flexible way for users to interact with the system, which may be useful for users who are not experts in GIS or data analysis.

FIG. 11B is an example of a GUI 1122 configured to present a dynamic fire prediction index forecast. In FIG. 11B, the map display area 1102 shows an updated fire potential index map 1124 for the same geographic region as in FIG. 11A, but at a later time, “20250107_0000.” The map legend now reflects a different distribution of risk, with a summary of “Low: 3.4%, Moderate: 79.4%, High: 14.0%, Extreme: 0.0%.” The updated map visualization shows a shift in the fire potential index, with some areas now categorized as “High.” The other components of the GUI 1122, such as the fire indices options panel 1106 and the weather options panel 1108, remain available for user interaction. This view illustrates the temporal nature of the fire risk assessment, as the fire potential index is updated to reflect changing conditions.

FIG. 11C is an example of a GUI 1126 configured to present a dynamic fire prediction index forecast. In FIG. 11C, the map display area 1102 shows a further updated fire potential index map 1128 for the time “20250107_0900.” The map legend indicates an increase in risk, with a summary of “Low: 0.0%, Moderate: 2.2%, High: 81.6%, Extreme: 12.1%.” The updated map visualization shows large portions of the geographic region now categorized as “High” or “Extreme.” This sequence of views from FIG. 11A to FIG. 11C demonstrates how the GUI can be used to monitor the evolution of fire risk over time. In some implementations, these sequential views could be presented as an animated visualization that displays a temporal sequence of a series of predictions across a forecast horizon.

FIG. 11D is an example of a GUI 1130 configured to present an infrastructure view for dynamic fire risk prediction and mitigation. In this view, the map display area 1102 is displaying a wind visualization 1132. This wind visualization 1132 uses wind barbs to show both the speed and direction of the wind across the geographic region. The wind barbs provide a detailed and intuitive representation of the wind patterns. This view may be activated when a user selects the “Wind Speed”or “Wind Direction”option in the weather options panel 1108.

FIG. 11E is an example of a GUI 1134 configured to present vegetation characteristic information for dynamic fire risk prediction and mitigation. FIG. 11F is an example of a GUI 1134 configured to present vegetation characteristic information for dynamic fire risk prediction and mitigation. In this view, the map display area 1102 is displaying a vegetation visualization 1136, specifically a map of the NDVI. A map legend provides a color scale for interpreting the NDVI values, which range from 0.0 to 1.0. This visualization provides a mechanism by which a user may assess the health and density of vegetation across the geographic region, which is a component of the fuel map data. This view may be activated when a user selects the “NDVI” option in the fire indices options panel.

FIG. 11F is an example of a GUI 1138 configured to facilitate selection of a region and presentation of a report associated with the selected region. In this view, a user has used a selection tool to define a region of interest 1142 on the map 1140 in a map display area 1102. A selected point detail panel displays the coordinates of the selected points. The user is then presented with “Show Report” and “Download Report” buttons, which furnish a mechanism by which a user may generate a detailed report for the selected region. This functionality provides a mechanism by which users may perform a more in-depth analysis of a specific area.

FIG. 11G is an example of a GUI 1144 configured to present a report associated with the selected region. In this view, a report 1146 of a selected region is displayed over the map display area. The report 1146 provides a detailed summary of the fire risk characteristics for the region selected in FIG. 11F. The report includes sections for “Vegetation Analysis,” “Weather Parameters,” “Location and Time,” and “Wind-driven risk.” The report includes a chart showing the temporal changes to the fire potential index for the next 48 hours. This report furnishes a comprehensive, multi-faceted view of the fire risk, synthesizing information from various data sources into an easily digestible format. The report may be generated in response to a user request, and the output data may be provided by the server 316 and rendered by the client 318.

FIG. 11H is an example of a GUI 1148 configured to present a fire simulation visualization. The GUI 1148 includes a map display area 1102 displaying a map 1150 with fire spread contours 1152 and an hourly forecast timeline 1154. The GUI 1148 furnishes a mechanism by which a user may configure and run a fire behavior simulation. The user can set parameters such as wind speed, wind direction, and fuel moisture. The map display area 1102 shows the output of the simulation as a series of concentric burn perimeters, representing the predicted spread of the fire over time. The hourly forecast timeline 1154 furnishes a mechanism by which a user may scrub through the simulation timeline to see the fire's progression at different time steps. This view furnishes a tool for scenario planning and for understanding the potential evolution of a fire event.

To further describe some implementations in greater detail, reference is next made to examples of techniques which may be performed by or using the AI systems for dynamic fire risk management from heterogeneous multimodal inputs as described herein.

FIG. 12 is a flowchart of an example of a technique 1200 associated with dynamic fire risk management based on heterogeneous multimodal inputs. The technique 1200 can be executed using computing devices, such as the systems, hardware, and software described with respect to FIGS. 1-11H. The technique 1200 can be performed, for example, by executing a machine-readable program or other computer-executable instructions, such as routines, instructions, programs, or other code. The steps, or operations, of the technique 1200, or another technique, method, process, or algorithm described in connection with the implementations disclosed herein can be implemented directly in hardware, firmware, software executed by hardware, circuitry, or a combination thereof. For simplicity of explanation, the technique 1200 is depicted and described herein as a series of steps or operations. However, the steps or operations of the technique 1200 can occur in various orders and/or concurrently. Additionally, other steps or operations not presented and described herein may be used. Furthermore, not all illustrated steps or operations may be required to implement a technique in accordance with the disclosed subject matter.

At 1202, the technique 1200 includes receiving multimodal input data associated with a geographic region, the multimodal input data comprising at least one of fuel map data, meteorological data, topographical data, and historical fire data. For example, a data integration pipeline, such as the data integration pipeline 114 shown in FIG. 1, may be configured to perform this operation. In some implementations, the receiving operation further includes obtaining a time-frame specification in addition to a geographic location. The time-frame specification may indicate (i) a historic window in which the system retrieves and processes archived datasets that are of a specified age (e.g., six months old or older) and/or (ii) a forecast window in which the system retrieves and processes predictive datasets for a specified future time period (e.g., at least the next forty-eight (48) hours). Forecast outputs may be generated at successive time intervals across the forecast horizon (e.g., hourly predictions for ≥48 hours), and may be visualized or reported via the GUI (e.g., charts showing the next 48 hours).

This receiving operation may involve processing the multimodal input data using a data fusion pipeline to facilitate integration between different data sources. The data fusion pipeline may be configured to perform at least one of temporal interpolation for satellite imagery data or spatiotemporal resolution adjustments for weather data.

In some implementations, the multimodal input data may include a variety of data types to facilitate comprehensive analysis. For example, the multimodal input data may include at least one of aerial imagery obtained from one or more aircraft, satellite-based remote sensing data, SAR data, or LiDAR data. The meteorological data may include one or more updated values corresponding to at least one of a wind speed, a wind direction, a temperature, or a relative humidity. In some implementations, the geographic region may be a WUI region, where developed areas intersect with wildlands.

The technique 1200 may also include obtaining real-time fire detection data. For example, a system may obtain real-time fire detection data, indicative of an active fire, from a high-resolution multispectral satellite imagery system, such as a FireSat system. This provides a mechanism by which the system may respond to active fire events in a timely manner.

At 1204, the technique 1200 includes determining, using an AI component and based on the multimodal input data, a fire potential index associated with the geographic region. For example, an AI component, such as the AI component 122 shown in FIG. 1, may be configured to perform this determination. This operation may involve generating the fuel map data by generating a fuel characterization map associated with the geographic region, where the fuel characterization map identifies a plurality of fuel types and corresponding fuel loads. Generating the fuel characterization map may involve processing remote sensing data, which may include satellite imagery data or SAR data.

The process of generating the fuel characterization map may include several pre-processing and machine-learning operations. For example, the system may generate pre-processed remote sensing data based on generating pre-processed satellite imagery data based on performing a cloud removal pre-processing operation on the satellite imagery data; calculating, based on the pre-processed satellite imagery data, at least one seasonal NDVI metric; calculating, based on the SAR data, at least one SAR-based metric; and extracting elevation data and slope data from a topographical data source. Based on this pre-processed data, a training dataset may be generated. The system may then generate synthetic data based on the training dataset, which may involve applying a pseudo-labeling process. An augmented training dataset may be created by combining the training dataset and the synthetic data, and at least one machine-learning model of the AI component may be trained using the augmented training dataset.

The resulting fuel characterization map may include a characterization of at least one of a vegetation type associated with the geographic region or a dead fuel extinction moisture associated with the geographic region. In implementations where the geographic region is a WUI region, the fuel map data may include a characterization of a structural vulnerability of at least one built structure within the WUI region. Furthermore, the AI component may be a VLM, and determining the fire potential index may involve processing the multimodal input data with the VLM to generate a semantic interpretation of the geographic region. The process may facilitate the generation of a fuel characterization map or an infrastructure map at a sub-five-meter resolution.

The determination of the fire potential index may also include calculating an uncertainty value associated with the fire potential index. In some implementations, calculating the uncertainty value may involve applying one or more Markov Chain Monte Carlo models developed based on historical fire data associated with the geographic region. In some implementations, determining the fire potential index may involve generating, for a plurality of successive time intervals, a corresponding plurality of fire potential index forecasts, each forecast covering a future time horizon, thereby creating a plurality of overlapping predictions for a future time point within the future time horizon; determining a variance across the plurality of overlapping predictions for the future time point, which may involve applying at least one of a moving standard deviation, a quantile band, or a bootstrapped interval analysis; and calculating, based on the variance, a confidence range indicative of an uncertainty associated with the fire potential index for the future time point.

To mitigate bias and improve reliability, the determination of the fire potential index may involve constraining a machine-learning model of the AI component using a retrieval-augmented pipeline that processes verifiable records from the multimodal input data, and applying one or more rule-based methods to an output of the machine-learning model to validate the fire potential index. This process may also involve calculating a confidence score associated with the fire potential index. Furthermore, the system may apply an anomaly-detection model tuned on historical burn scars to any received real-time fire detection data to generate processed real-time fire detection data while reducing a false positive rate, and may generate an alert based on the processed real-time fire detection data.

In some implementations, the AI component may be a multi-agent framework. In such cases, the technique may include orchestrating, using a multi-modal large language model, a plurality of specialized AI agents within the multi-agent framework to determine the fire potential index. This plurality of specialized AI agents may include at least one of a fuel map agent configured to generate and update the fuel map data; a fire potential index alert agent configured to generate an alert when the fire potential index exceeds a predetermined threshold; an uncertainty agent configured to calculate an uncertainty value associated with the fire potential index; or a simulator coordination agent configured to facilitate a fire behavior simulation.

The simulator coordination agent may facilitate a fire behavior simulation by modeling thermal radiation to quantify heat transfer effects on vegetation or built structures, and modeling fire spotting by simulating the generation, transport, or ignition of firebrands. This simulation may involve evaluating a structural vulnerability for a built structure based on at least one of a roofing type, a siding material, or a window configuration, and incorporating one or more uncertainties related to fire spotting behavior, an ignition threshold, or a structural ignition probability into the fire behavior simulation.

The plurality of specialized AI agents may also include at least one of a mitigation planning agent configured to generate fire mitigation plans; a prioritization agent configured to generate a prioritization recommendation associated with fire mitigation plans; or a return on investment agent configured to generate recommendations associated with fire mitigation plans based on return on investment modeling. The multi-agent framework may learn one or more user preferences based on an analysis of past user interactions and proactively generate a personalized alert. The multi-agent framework may also use at least one knowledge graph, and the technique may include receiving user feedback and updating a short-term memory or a long-term memory of the multi-agent framework to fine-tune the knowledge graph.

At 1206, the technique 1200 includes providing output data indicative of the fire potential index for display via a graphical user interface rendered by a computing device. For example, an interface component, such as the interface component 112 shown in FIG. 1, may be configured to perform this operation. The output data may be configured to cause the computing device to render an animated visualization that displays a temporal sequence of a series of predictions across a forecast horizon via the graphical user interface.

In some implementations, the graphical user interface may be a conversational artificial intelligence component configured to receive a natural language query from a user and generate a responsive textual briefing. The output data may also be a color-coded risk map indicating a plurality of different levels associated with the fire potential index. The confidence score calculated during the determination of the fire potential index may also be provided as part of the output data.

To foster trust and transparency, the output data may include an explainable AI mechanism configured to expose information about how the fire potential index was determined from the multimodal input data. This explainable AI mechanism may include at least one of a traceable inference pathway, a structured agent communication log, or a user-interpretable decision layer. This provides a mechanism by which a user may validate and understand the reasoning behind the system's outputs.

FIG. 13 is a flowchart of an example of a technique 1300 associated with dynamic fire risk management based on heterogeneous multimodal inputs. The technique 1300 can be executed using computing devices, such as the systems, hardware, and software described with respect to FIGS. 1-12. The technique 1300 can be performed, for example, by executing a machine-readable program or other computer-executable instructions, such as routines, instructions, programs, or other code. The steps, or operations, of the technique 1300, or another technique, method, process, or algorithm described in connection with the implementations disclosed herein can be implemented directly in hardware, firmware, software executed by hardware, circuitry, or a combination thereof. For simplicity of explanation, the technique 1300 is depicted and described herein as a series of steps or operations. However, the steps or operations of the technique 1300 can occur in various orders and/or concurrently. Additionally, other steps or operations not presented and described herein may be used. Furthermore, not all illustrated steps or operations may be required to implement a technique in accordance with the disclosed subject matter.

At 1302, the technique 1300 includes receiving a plurality of remote sensing datasets corresponding to a geographic area. For example, a data integration pipeline, such as the data integration pipeline 114 shown in FIG. 1, may be configured to perform this operation. The plurality of remote sensing datasets may include at least one of SAR data or electro-optical (EO) sensor data. This step may also include preprocessing the plurality of remote sensing datasets prior to generating the fuel map, wherein preprocessing the plurality of remote sensing datasets may involve performing at least one of a geometric correction operation, a radiometric calibration operation, or a data fusion operation.

At 1304, the technique 1300 includes generating, using at least one machine-learning model, a fuel map of the geographic area based on the plurality of remote sensing datasets. For example, a fuel map engine, such as the fuel map engine 424 shown in FIG. 4, which may be part of an AI component like the AI component 122 shown in FIG. 1, may be configured to perform this operation. In some implementations, the at least one machine-learning model may be a mixture of experts (MoE) model. The process may further include augmenting a training dataset for the MoE model using synthetic data generation prior to generating the fuel map.

At 1306, the technique 1300 includes creating a fire hazard map by combining the fuel map with meteorological data corresponding to the geographic area. For example, an FPI engine, such as the FPI engine 426 shown in FIG. 4, may be configured to perform this operation. In some implementations, creating the fire hazard map may involve combining the fuel map and the meteorological data with at least one of a DEM or a vegetation index map.

At 1308, the technique 1300 includes receiving, via a user interface, a natural language query associated with identifying a potential prescribed burn location within the geographic area. For example, an interface component, such as the interface component 112 shown in FIG. 1, may be configured to receive this query from a client application, such as the client 124, that is rendering a graphical user interface.

At 1310, the technique 1300 includes generating, using a v VLM and based on the potential prescribed burn location and the fire hazard map, a response to the natural language query, the response comprising a map-based visualization of a recommended prescribed burn area. For example, an AI component, such as the AI component 122 shown in FIG. 1, which may be a VLM, may be configured to perform this operation. In some implementations, the VLM may be based on an underlying large language model (LLM). The VLM may also be part of a unified foundation model trained across multiple remote sensing data modalities using a unified instruction tuning operation.

In some implementations, the response may include a text-based rationale associated with the recommended prescribed burn area. The text-based rationale may be based on a fire danger score associated with the recommended prescribed burn area and one or more criteria specified in the natural language query. This provides a mechanism by which a user may not only see a recommendation but also understand the factors that contributed to it.

FIG. 14 is a flowchart of an example of a technique 1400 associated with dynamic fire risk management based on heterogeneous multimodal inputs. The technique 1400 can be executed using computing devices, such as the systems, hardware, and software described with respect to FIGS. 1-13. The technique 1400 can be performed, for example, by executing a machine-readable program or other computer-executable instructions, such as routines, instructions, programs, or other code. The steps, or operations, of the technique 1400, or another technique, method, process, or algorithm described in connection with the implementations disclosed herein can be implemented directly in hardware, firmware, software executed by hardware, circuitry, or a combination thereof. For simplicity of explanation, the technique 1400 is depicted and described herein as a series of steps or operations. However, the steps or operations of the technique 1400 can occur in various orders and/or concurrently. Additionally, other steps or operations not presented and described herein may be used. Furthermore, not all illustrated steps or operations may be required to implement a technique in accordance with the disclosed subject matter.

At 1402, the technique 1400 includes obtaining a plurality of multimodal data inputs, the plurality of multimodal data inputs comprising at least one of satellite-based Earth observation data, meteorological forecast data, or vegetation fuel map data. For example, a data integration pipeline, such as the data integration pipeline 114 shown in FIG. 1, may be configured to perform this operation. In some implementations, the plurality of multimodal data inputs includes at least one of real-time sensor data, historical fire records, or topography data. The meteorological forecast data may be obtained from a HRRR model.

At 1404, the technique 1400 includes generating a fused multimodal dataset based on fusing the plurality of multimodal data inputs using a multi-agent AI component. For example, an AI component, such as the AI component 122 shown in FIG. 1, or a data fusion component, such as the data fusion component 716 shown in FIG. 7, may be configured to perform this operation. In some implementations, generating the fused multimodal dataset includes harmonizing the plurality of multimodal data inputs by performing at least one of temporal interpolation or spatiotemporal resolution adjustments. The multi-agent AI component may include one or more AI models fine-tuned with regional data.

At 1406, the technique 1400 includes generating a regionally-adapted FPI based on the fused multimodal data inputs and localized historical fire patterns for a geographic region. For example, a processing layer, such as the processing layer 118 shown in FIG. 1, or an FPI engine, such as the FPI engine 508 shown in FIG. 5, may be configured to perform this operation. The technique 1400 may further include predicting, using a fire simulation tool and based on the regionally-adapted FPI and the vegetation fuel map data, at least one of a spread speed of an active wildfire or a spread direction of the active wildfire.

At 1408, the technique 1400 includes outputting a high-resolution map illustrating the regionally-adapted FPI. For example, an interface component, such as the interface component 112 shown in FIG. 1, may be configured to perform this operation. In some implementations, outputting the high-resolution map includes outputting periodic indications of operational risk assessments. The high-resolution map may illustrate the regionally-adapted FPI using a plurality of categorized risk levels. The outputting may also include facilitating a display of the high-resolution map within an interactive web application that includes a natural language chat interface and one or more geographic information system (GIS) dashboards. The technique 1400 may include receiving, via a web-based user interface, a natural language query related to the regionally-adapted FPI, and generating a tailored briefing in response to the natural language query using a large vision-language model (LVLM).

FIG. 15 is a flowchart of an example of a technique 1500 associated with dynamic fire risk management based on heterogeneous multimodal inputs. The technique 1500 can be executed using computing devices, such as the systems, hardware, and software described with respect to FIGS. 1-14. The technique 1500 can be performed, for example, by executing a machine-readable program or other computer-executable instructions, such as routines, instructions, programs, or other code. The steps, or operations, of the technique 1500, or another technique, method, process, or algorithm described in connection with the implementations disclosed herein can be implemented directly in hardware, firmware, software executed by hardware, circuitry, or a combination thereof. For simplicity of explanation, the technique 1500 is depicted and described herein as a series of steps or operations. However, the steps or operations of the technique 1500 can occur in various orders and/or concurrently. Additionally, other steps or operations not presented and described herein may be used. Furthermore, not all illustrated steps or operations may be required to implement a technique in accordance with the disclosed subject matter.

At 1502, the technique 1500 includes creating a high-resolution fuel map for a geographic area based on satellite imagery, the high-resolution fuel map indicating at least one of a dead fuel moisture level or a vegetation type. For example, a fuel map engine, such as the fuel map engine 424 shown in FIG. 4, may be configured to perform this operation. In some implementations, creating the high-resolution fuel map comprises processing the satellite imagery using a machine learning model. The satellite imagery may comprise data from at least one of an Earth observation satellite comprising an operational land imager and a thermal infrared sensor, a multi-satellite constellation comprising radar instrumentation configured to provide a continual supply of Earth surface imagery, or a phased array type L-band synthetic aperture radar satellite. In some implementations, the high-resolution fuel map is based on digital elevation model data obtained via a shuttle radar topography mission.

At 1504, the technique 1500 includes obtaining real-time meteorological data associated with the geographic area. For example, a data integration pipeline, such as the data integration pipeline 114 shown in FIG. 1, may be configured to perform this operation. In some implementations, the real-time meteorological data is obtained from an HRRR model. The real-time meteorological data may comprise at least one of wind speed, wind direction, temperature, or relative humidity.

At 1506, the technique 1500 includes predicting, using a fire simulation tool and based on the high-resolution fuel map and the real-time meteorological data, at least one of a spread speed of an active wildfire or a spread direction of the active wildfire. For example, a simulation engine, such as the simulation engine 430 shown in FIG. 4, may be configured to perform this prediction.

At 1508, the technique 1500 includes providing output data for display by a computing device, the output data indicative of the at least one of the spread speed or the spread direction. For example, an interface component, such as the interface component 112 shown in FIG. 1, may be configured to perform this operation. In some implementations, the output data comprises a fire forecast for a period of at least approximately 48 hours. In some implementations, providing the output data comprises transmitting the output data for display in an interactive web application. The interactive web application may comprise one or more geographic information system (GIS) dashboards for scenario planning.

Some implementations include a method, comprising: receiving, by a processor set, multimodal input data associated with a geographic region, the multimodal input data comprising at least one of fuel map data, meteorological data, topographical data, and historical fire data; determining, by the processor set and based on an AI component and the multimodal input data, a fire potential index associated with the geographic region; and providing, by the processor set, output data indicative of the fire potential index for display via a graphical user interface rendered by a computing device.

In some implementations, the method comprises: generating, by the processor set, the fuel map data based on generating a fuel characterization map associated with the geographic region, the fuel characterization map identifying a plurality of fuel types and corresponding fuel loads.

In some implementations, generating the fuel characterization map comprises: processing, by the processor set using the AI component to process remote sensing data, the remote sensing data comprising at least one of satellite imagery data or SAR data.

In some implementations, processing the remote sensing data comprises generating pre-processed remote sensing data based on: generating pre-processed satellite imagery data based on performing a cloud removal pre-processing operation on the satellite imagery data; calculating, based on the pre-processed satellite imagery data, at least one seasonal NDVI metric; calculating, based on the SAR data, at least one SAR-based metric; and extracting elevation data and slope data from a topographical data source.

In some implementations, the method comprises: generating a training dataset based on the pre-processed remote sensing data; generating synthetic data based on the training dataset; creating an augmented training dataset by combining the training dataset and the synthetic data; and training at least one machine-learning model of the AI component using the augmented training dataset.

In some implementations, generating the synthetic data comprises applying a pseudo-labeling process to the training dataset.

In some implementations, the fuel characterization map comprises a characterization of at least one of a vegetation type associated with the geographic region or a dead fuel extinction moisture associated with the geographic region.

In some implementations, the geographic region comprises a WUI region.

In some implementations, the fuel map data comprises a characterization of a structural vulnerability of at least one built structure within the WUI region.

In some implementations, the meteorological data comprises one or more updated values corresponding to at least one of a wind speed, a wind direction, a temperature, or a relative humidity.

In some implementations, the output data is configured to cause the computing device to render an animated visualization that displays a temporal sequence of a series of predictions across a forecast horizon via the graphical user interface.

In some implementations, the method comprises: calculating an uncertainty value associated with the fire potential index.

In some implementations, calculating the uncertainty value comprises applying one or more Markov Chain Monte Carlo models developed based on historical fire data associated with the geographic region.

In some implementations, determining the fire potential index comprises: generating, for a plurality of successive time intervals, a corresponding plurality of fire potential index forecasts, each forecast covering a future time horizon, thereby creating a plurality of overlapping predictions for a future time point within the future time horizon; determining a variance across the plurality of overlapping predictions for the future time point; and calculating, based on the variance, a confidence range indicative of an uncertainty associated with the fire potential index for the future time point, wherein the output data is indicative of the confidence range.

In some implementations, determining the variance across the plurality of overlapping predictions comprises applying at least one of a moving standard deviation, a quantile band, or a bootstrapped interval analysis.

In some implementations, the graphical user interface comprises a conversational artificial intelligence component configured to receive a natural language query from a user and generate a responsive textual briefing.

In some implementations, the output data comprises a color-coded risk map indicating a plurality of different levels associated with the fire potential index.

In some implementations, the output data comprises an explainable AI mechanism configured to expose information about how the fire potential index was determined from the multimodal input data.

In some implementations, the explainable AI mechanism comprises at least one of a traceable inference pathway, a structured agent communication log, or a user-interpretable decision layer.

In some implementations, determining the fire potential index comprises: constraining a machine-learning model of the AI component using a retrieval-augmented pipeline that processes verifiable records from the multimodal input data; and applying one or more rule-based methods to an output of the machine-learning model to validate the fire potential index.

In some implementations, determining the fire potential index comprises: calculating a confidence score associated with the fire potential index, wherein the output data is indicative of the confidence score.

In some implementations, the AI component comprises a multi-agent framework, the method comprising: orchestrating, using a multi-modal large language model, a plurality of specialized AI agents within the multi-agent framework to determine the fire potential index.

In some implementations, the plurality of specialized AI agents comprises at least one of: a fuel map agent configured to generate and update the fuel map data; a fire potential index alert agent configured to generate an alert when the fire potential index exceeds a predetermined threshold; an uncertainty agent configured to calculate an uncertainty value associated with the fire potential index; or a simulator coordination agent configured to facilitate a fire behavior simulation.

In some implementations, the method comprises: simulating, by the simulator coordination agent using one or more physics-based principles, thermal radiation to quantify heat transfer effects on at least one of vegetation within the geographic region or a built structure within the geographic region; and modeling, by the simulator coordination agent, fire spotting by simulating at least one of: a generation of a firebrand originating from the at least one of the vegetation or the built structure, a transport of the firebrand, or an ignition of a fire from the firebrand.

In some implementations, the method comprises: evaluating, based on a function of the simulator coordination agent, a structural vulnerability for the at least one built structure based on at least one of a roofing type, a siding material, or a window configuration; and incorporating, into the fire behavior simulation and based on the structural vulnerability, one or more uncertainties related to at least one of a fire spotting behavior, an ignition threshold, or a structural ignition probability.

In some implementations, the plurality of specialized AI agents comprises at least one of: a mitigation planning agent configured to generate fire mitigation plans; a prioritization agent configured to generate a prioritization recommendation associated with fire mitigation plans; or a return on investment agent configured to generate recommendations associated with fire mitigation plans based on return on investment modeling associated with at least one of an economic dimension, a social dimension, or an environmental dimension.

In some implementations, the method comprises: learning, by at least one of the plurality of specialized AI agents, one or more user preferences based on an analysis of past user interactions; and proactively generating, by the at least one specialized AI agent based on the one or more user preferences, a personalized alert that flags information related to the fire potential index.

In some implementations, the multi-agent framework comprises at least one knowledge graph, the method comprising: receiving user feedback associated with an output generated by the multi-agent framework; and updating, based on the user feedback, at least one of a short-term memory or a long-term memory of the multi-agent framework to fine-tune the knowledge graph.

In some implementations, receiving the multimodal input data comprises: processing the multimodal input data using a data integration pipeline to facilitate integration between different data sources, the data integration pipeline configured to perform at least one of: temporal interpolation for satellite imagery data; or spatiotemporal resolution adjustments for weather data.

In some implementations, the AI component comprises a VLM, and wherein determining the fire potential index comprises processing the multimodal input data with the VLM to generate a semantic interpretation of the geographic region.

In some implementations, the multimodal input data comprises at least one of aerial imagery obtained from one or more aircraft, satellite-based remote sensing data, SAR data, or LiDAR data.

In some implementations, determining the fire potential index comprises generating, at a sub-five-meter resolution, at least one of a fuel characterization map or an infrastructure map.

In some implementations, the method comprises: obtaining real-time fire detection data, indicative of an active fire, from a high-resolution multispectral satellite imagery system; applying an anomaly-detection model tuned on historical burn scars to the real-time fire detection data to generate processed real-time fire detection data while reducing a false positive rate; and generating an alert based on the processed real-time fire detection data.

Some implementations include a system, comprising: a memory storing instructions; and a processor set communicatively coupled to the memory and configured to execute the instructions to cause the system to: receive multimodal input data associated with a geographic area, the multimodal input data comprising at least one of fuel map data, meteorological data, topographical data, and historical fire data; determine, using an AI component and based on the multimodal input data, a fire potential index associated with the geographic area; and provide output data indicative of the fire potential index for display via a graphical user interface rendered by a computing device.

Some implementations include one or more computer-readable media comprising instructions configured to be executed by a processor set to cause the processor set to perform operations comprising: receiving multimodal input data associated with a geographic area, the multimodal input data comprising at least one of fuel map data, meteorological data, topographical data, and historical fire data; determining, using an AI component and based on the multimodal input data, a fire potential index associated with the geographic area; and providing output data indicative of the fire potential index for display via a graphical user interface rendered by a computing device.

Some implementations include a method, comprising: receiving, by a processor set, a plurality of remote sensing datasets corresponding to a geographic area; generating, by the processor set using at least one machine-learning model, a fuel map of the geographic area based on the plurality of remote sensing datasets; creating, by the processor set, a fire hazard map by combining the fuel map with meteorological data corresponding to the geographic area; receiving, by the processor set via a user interface, a natural language query associated with identifying a potential prescribed burn location within the geographic area; and generating, by the processor set using a VLM and based on the potential prescribed burn location and the fire hazard map, a response to the natural language query, the response comprising a map-based visualization of a recommended prescribed burn area.

In some implementations, the response comprises a text-based rationale associated with the recommended prescribed burn area.

In some implementations, the text-based rationale is based on a fire danger score associated with the recommended prescribed burn area and one or more criteria specified in the natural language query.

In some implementations, the plurality of remote sensing datasets includes at least one of SAR data or electro-optical (EO) sensor data.

In some implementations, the at least one machine-learning model comprises a mixture of experts (MoE) model.

In some implementations, the method comprises: augmenting a training dataset for the MoE model using synthetic data generation prior to generating the fuel map.

In some implementations, the method comprises: preprocessing the plurality of remote sensing datasets prior to generating the fuel map, wherein preprocessing the plurality of remote sensing datasets comprises performing at least one of a geometric correction operation, a radiometric calibration operation, or a data fusion operation.

In some implementations, creating the fire hazard map comprises: combining the fuel map and the meteorological data with at least one of a DEM or a vegetation index map.

In some implementations, the VLM is based on an underlying large language model (LLM).

In some implementations, the VLM is part of a unified foundation model trained across multiple remote sensing data modalities using a unified instruction tuning operation.

Some implementations include a system, comprising: a memory storing instructions; and a processor set communicatively coupled to the memory and configured to execute the instructions to cause the system to: receive a plurality of remote sensing datasets corresponding to a geographic area; generate, using at least one machine-learning model, a fuel map of the geographic area based on the plurality of remote sensing datasets; create a fire hazard map by combining the fuel map with meteorological data corresponding to the geographic area; receive, via a user interface, a natural language query associated with identifying a potential prescribed burn location within the geographic area; and generate, using a VLM and based on the potential prescribed burn location and the fire hazard map, a response to the natural language query, the response comprising a map-based visualization of a recommended prescribed burn area.

Some implementations include one or more computer-readable media comprising instructions configured to be executed by a processor set to cause the processor set to perform operations comprising: receiving a plurality of remote sensing datasets corresponding to a geographic area; generating, using at least one machine-learning model, a fuel map of the geographic area based on the plurality of remote sensing datasets; creating a fire hazard map by combining the fuel map with meteorological data corresponding to the geographic area; receiving, via a user interface, a natural language query associated with identifying a potential prescribed burn location within the geographic area; and generating, using a VLM and based on the potential prescribed burn location and the fire hazard map, a response to the natural language query, the response comprising a map-based visualization of a recommended prescribed burn area.

Some implementations include a method, comprising: obtaining, by a processor set, a plurality of multimodal data inputs, the plurality of multimodal data inputs comprising at least one of satellite-based Earth observation data, meteorological forecast data, or vegetation fuel map data; generating, by the processor set, a fused multimodal dataset based on fusing the plurality of multimodal data inputs using a multi-agent AI component; generating, by the processor set, a regionally-adapted FPI based on the fused multimodal data inputs and localized historical fire patterns for a geographic region; and outputting, by the processor set, a high-resolution map illustrating the regionally-adapted FPI.

In some implementations, the plurality of multimodal data inputs comprises at least one of real-time sensor data, historical fire records, or topography data.

In some implementations, the meteorological forecast data is obtained from HRRR model.

In some implementations, generating the fused multimodal dataset comprises: harmonizing the plurality of multimodal data inputs by performing at least one of temporal interpolation or spatiotemporal resolution adjustments.

In some implementations, the multi-agent AI component comprises one or more AI models fine-tuned with regional data.

In some implementations, outputting the high-resolution map comprises: outputting periodic indications of operational risk assessments.

In some implementations, the method comprises: receiving, via a web-based user interface, a natural language query related to the regionally-adapted FPI; and generating a tailored briefing in response to the natural language query using a large vision-language model (LVLM).

In some implementations, the method comprises: predicting, using a fire simulation tool and based on the regionally-adapted FPI and the vegetation fuel map data, at least one of a spread speed of an active wildfire or a spread direction of the active wildfire.

In some implementations, outputting the high-resolution map comprises: facilitating a display of the high-resolution map within an interactive web application that includes a natural language chat interface and one or more geographic information system (GIS) dashboards.

In some implementations, the high-resolution map illustrates the regionally-adapted FPI using a plurality of categorized risk levels.

Some implementations include a system, comprising: a memory storing instructions; and a processor set communicatively coupled to the memory and configured to execute the instructions to cause the system to: obtain a plurality of multimodal data inputs, the plurality of multimodal data inputs comprising at least one of satellite-based Earth observation data, meteorological forecast data, or vegetation fuel map data; generate a fused multimodal dataset based on fusing the plurality of multimodal data inputs using a multi-agent AI component; generate a regionally-adapted FPI based on the fused multimodal data inputs and localized historical fire patterns for a geographic region; and output a high-resolution map illustrating the regionally-adapted FPI.

Some implementations include one or more computer-readable media comprising instructions configured to be executed by a processor set to cause the processor set to perform operations comprising: obtaining a plurality of multimodal data inputs, the plurality of multimodal data inputs comprising at least one of satellite-based Earth observation data, meteorological forecast data, or vegetation fuel map data; generating a fused multimodal dataset based on fusing the plurality of multimodal data inputs using a multi-agent AI component; generating a regionally-adapted FPI based on the fused multimodal data inputs and localized historical fire patterns for a geographic region; and outputting a high-resolution map illustrating the regionally-adapted FPI.

Some implementations include a method, comprising: creating, by a processor set, a high-resolution fuel map for a geographic area based on satellite imagery, the high-resolution fuel map indicating at least one of a dead fuel moisture level or a vegetation type; obtaining, by the processor set, real-time meteorological data associated with the geographic area; predicting, by the processor set using a fire simulation tool and based on the high-resolution fuel map and the real-time meteorological data, at least one of a spread speed of an active wildfire or a spread direction of the active wildfire; and providing, by the processor set, output data for display by a computing device, the output data indicative of the at least one of the spread speed or the spread direction.

In some implementations, the satellite imagery comprises data from at least one of an Earth observation satellite comprising an operational land imager and a thermal infrared sensor, a multi-satellite constellation comprising radar instrumentation configured to provide a continual supply of Earth surface imagery, or a phased array type L-band synthetic aperture radar satellite.

In some implementations, the high-resolution fuel map is based on digital elevation model data obtained via a shuttle radar topography mission.

In some implementations, creating the high-resolution fuel map comprises: processing the satellite imagery using a machine learning model.

In some implementations, the real-time meteorological data is obtained from an HRRR model. In some implementations, the real-time meteorological data comprises at least one of wind speed, wind direction, temperature, or relative humidity.

In some implementations, the output data comprises a fire forecast for a period of at least approximately 48 hours.

In some implementations, providing the output data comprises transmitting the output data for display in an interactive web application.

In some implementations, the interactive web application comprises one or more geographic information system (GIS) dashboards for scenario planning.

Some implementations include a system, comprising: a memory storing instructions; and a processor set communicatively coupled to the memory and configured to execute the instructions to cause the system to: create a high-resolution fuel map for a geographic area based on satellite imagery, the high-resolution fuel map indicating at least one of a dead fuel moisture level or a vegetation type; obtain real-time meteorological data associated with the geographic area; predict, using a fire simulation tool and based on the high-resolution fuel map and the real-time meteorological data, at least one of a spread speed of an active wildfire or a spread direction of the active wildfire; and provide output data for display by a computing device, the output data indicative of the at least one of the spread speed or the spread direction.

Some implementations include one or more computer-readable media comprising instructions configured to be executed by a processor set to cause the processor set to perform operations comprising: creating a high-resolution fuel map for a geographic area based on satellite imagery, the high-resolution fuel map indicating at least one of a dead fuel moisture level or a vegetation type; obtaining real-time meteorological data associated with the geographic area; predicting, using a fire simulation tool and based on the high-resolution fuel map and the real-time meteorological data, at least one of a spread speed of an active wildfire or a spread direction of the active wildfire; and providing output data for display by a computing device, the output data indicative of the at least one of the spread speed or the spread direction.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The adjectives “first,” “second,” “third,” and so on are used for contextual distinction between two or more of the modified nouns in connection with a discussion and are not meant to be absolute modifiers that apply only to a certain respective node throughout the entire document. For example, a component may be referred to as a “first component” in connection with one discussion and may be referred to as a “second component” in connection with another discussion, or vice versa. Reference to a component, a computing device, a server, a client, an application, an apparatus, a device, a system, a computing system, or the like may include disclosure of the computing device, server, client, application, apparatus, device, system, computing system, or the like, respectively, being a node. For example, disclosure that a computing device is configured to receive information from a server also discloses that a first node is configured to receive information from a second node. Consistent with this disclosure, once a specific example is broadened in accordance with this disclosure (e.g., a computing device is configured to receive information from a server also discloses that a first node is configured to receive information from a second node), the broader example of the narrower example may be interpreted in the reverse, but in a broad open-ended way. In the example above where a computing device being configured to receive information from a server also discloses a first node being configured to receive information from a second node, “first node” may refer to a first computing device, a first server, a first client, a first application, a first apparatus, a first device, a first system, a first computing system, or the like, configured to receive the information from a second node; and “second node” may refer to a second computing device, a second server, a second client, a second application, a second apparatus, a second device, a second system, a second computing system, or the like.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

1. A method, comprising:
receiving, by a processor set, multimodal input data associated with a geographic region, the multimodal input data comprising at least one of fuel map data, meteorological data, topographical data, and historical fire data;
determining, by the processor set and based on an artificial intelligence (AI) component and the multimodal input data, a fire potential index associated with the geographic region; and
providing, by the processor set, output data indicative of the fire potential index for display via a graphical user interface rendered by a computing device.

2. The method of claim 1, comprising:
generating, by the processor set, the fuel map data based on generating a fuel characterization map associated with the geographic region, the fuel characterization map identifying a plurality of fuel types and corresponding fuel loads; and
updating the fuel map data based on a change in at least one of a fuel type associated with the geographic region or a fuel load associated with the geographic region.

3. The method of claim 2, wherein generating the fuel characterization map comprises:
processing, by the processor set using the AI component to process remote sensing data, the remote sensing data comprising at least one of multispectral satellite imagery data or synthetic aperture radar (SAR) data.

4. The method of claim 3, wherein processing the remote sensing data comprises generating pre-processed remote sensing data based on:
generating pre-processed satellite imagery data based on performing a cloud removal pre-processing operation on the satellite imagery data;
calculating, based on the pre-processed satellite imagery data, at least one seasonal normalized difference vegetation index (NDVI) metric;
calculating, based on the SAR data, at least one SAR-based metric; and
extracting elevation data and slope data from a topographical data source.

5. The method of claim 4, comprising:
generating a training dataset based on the pre-processed remote sensing data;
generating synthetic data based on the training dataset;
creating an augmented training dataset by combining the training dataset and the synthetic data; and
training at least one machine-learning model of the AI component using the augmented training dataset.

6. The method of claim 1, wherein the geographic region comprises a wildland-urban interface (WUI) region, and wherein the output data indicates an output of a regional specific risk model corresponding to the WUI region and based on at least one of a WUI fuel type, a structure vulnerability index, weather data, topography data, or historical burn records.

7. The method of claim 1, wherein the meteorological data comprises one or more updated values corresponding to at least one of a wind speed, a wind direction, a temperature, or a relative humidity.

8. The method of claim 1, wherein the output data is configured to cause the computing device to render an animated and interactive visualization that displays a temporal sequence of a series of predictions across a forecast horizon via the graphical user interface.

9. The method of claim 1, comprising:
calculating an uncertainty value associated with the fire potential index.

10. The method of claim 9, wherein calculating the uncertainty value comprises applying one or more Markov Chain Monte Carlo models developed based on historical fire data associated with the geographic region.

11. The method of claim 1, wherein determining the fire potential index comprises:
generating, for a plurality of successive time intervals, a corresponding plurality of fire potential index forecasts, each forecast covering a future time horizon, thereby creating a plurality of overlapping predictions for a future time point within the future time horizon;
determining a variance across the plurality of overlapping predictions for the future time point; and
calculating, based on the variance, a confidence range indicative of an uncertainty associated with the fire potential index for the future time point, wherein the output data is indicative of the confidence range.

12. The method of claim 11, wherein determining the variance across the plurality of overlapping predictions comprises applying at least one of a moving standard deviation, a quantile band, or a bootstrapped interval analysis.

13. The method of claim 1, wherein the graphical user interface comprises a conversational artificial intelligence component configured to receive a natural language query from a user and generate a responsive textual briefing.

14. The method of claim 1, wherein the output data comprises a color-coded risk map indicating a plurality of different levels associated with the fire potential index.

15. The method of claim 1, wherein the output data comprises an explainable AI mechanism configured to expose information about how the fire potential index was determined from the multimodal input data, wherein the explainable AI mechanism comprises at least one of a traceable inference pathway, a structured agent communication log, or a user-interpretable decision layer.

16. A system, comprising:
a memory storing instructions; and
a processor set communicatively coupled to the memory and configured to execute the instructions to cause the system to:
receive multimodal input data associated with a geographic area, the multimodal input data comprising at least one of fuel map data, meteorological data, topographical data, and historical fire data;
determine, using an artificial intelligence (AI) component and at least one vision language model and based on the multimodal input data, a fire potential index associated with the geographic area; and
provide output data indicative of the fire potential index for display via a graphical user interface rendered by a computing device.

17. The system of claim 16, wherein, to determine the fire potential index, the processor set is configured to execute the instructions to cause the system to:
constrain a machine-learning model of the AI component using a retrieval-augmented pipeline that processes verifiable records from the multimodal input data; and
apply one or more rule-based methods to an output of the machine-learning model to validate the fire potential index.

18. The system of claim 16, wherein the AI component comprises a multi-agent framework, and wherein the processor set is configured to execute the instructions to cause the system to:
orchestrate, using a multi-modal large language model, a plurality of specialized AI agents within the multi-agent framework to determine the fire potential index.

19. One or more computer-readable media comprising instructions configured to be executed by a processor set to cause the processor set to perform operations comprising:
receiving multimodal input data associated with a geographic area, the multimodal input data comprising at least one of fuel map data, meteorological data, topographical data, and historical fire data;
determining, using an artificial intelligence (AI) component and based on the multimodal input data, a fire potential index associated with the geographic area; and
providing output data indicative of the fire potential index for display via a graphical user interface rendered by a computing device.

20. The one or more computer-readable media of claim 19, the operations comprising:
obtaining real-time fire detection data, indicative of an active fire, from a high-resolution multispectral satellite imagery system;
applying an anomaly-detection model tuned on historical burn scars to the real-time fire detection data to generate processed real-time fire detection data while reducing a false positive rate; and
generating an alert based on the processed real-time fire detection data.
